(19) United States
(12) Patent Application Publication
(10) Pub. No.: US 2016/0378912 A1
(43) Pub. Date: Dec. 29, 2016

(54) STRUCTURE-BASED MODELING AND TARGET-SELECTIVITY PREDICTION

(71) Applicant: EPIGENETX, LLC, St. Louis, MO (US)

(72) Inventors: Rino RAGNO, Roma (IT); Garland R. MARSHALL, Clayton, MO (US); Flavio BALLANTE, Fiumicino (Roma) (IT)

(21) Appl. No.: 14/901,924

(22) PCT Filed: Jun. 30, 2014
(86) PCT No.: PCT/US14/44805

§ 371 Date: Dec. 29, 2015

Related U.S. Application Data
(60) Provisional application No. 61/842,191, filed on Jul. 2, 2013.

(51) Int. Cl. G06F 19/16; G06F 19/00; C40B 30/02

(52) U.S. Cl. CPC G06F 19/16; C40B 30/02; G06F 19/704; G06F 19/706

(57) ABSTRACT

The present invention provides, inter alia, methods, models, and systems for selecting an effector having specificity for a target molecule. The methods and systems of the present invention involve several steps, including compiling a database containing structural data for a library of molecules and a population of ligands and activity data, establishing structure-based equivalence of sequence elements in the library of molecules, determining likely spatial orientations of population ligands in library molecules, calculating interaction energies for each ligand-molecule pair, generating statistical models that are predictive of sequence elements likely to contribute to a differential effect of ligands on molecules, selecting an effector that is likely to have a desired specificity for the target molecule, experimentally determining activity data for effector-library molecule pairs, and at least once repeating the steps listed above wherein the effector is a member of the population of ligands.

### FIELD OF THE INVENTION

The present invention is generally directed to a predictive tool for selectivity prediction to enhance target selectivity and, in certain embodiments, a predictive tool for isoform-selective anti-histone deacetylase activity.

### BACKGROUND OF THE INVENTION

Optimization of specificity is a fundamental problem in chemistry that is particularly acute in the development of therapeutics. The complexity of molecular recognition in biological systems severely limits the ability to hit a single therapeutic target, for example. Routinely, one has a potential drug that shows some adverse side effects due to off-target interactions. Alternatively, some drugs attempt to target molecules that undergo rapid mutation, necessitating the design of drugs that retain their efficacy against multiple mutant forms of the target. Thus, there exists an unmet need for methods that allow the researcher to select ligands with enhanced specificity for the target(s) while minimizing the affinity for off-target interactions.

### SUMMARY OF THE INVENTION

Among the various aspects of the present invention is a predictive system and a methodology whereby available structural and activity information is integrated into joint, predictive three-dimensional-quantitative structure-activity relationship (3D-QSAR) models for target(s) and off-targets to allow iterative optimization of specificity for the target(s) and minimization of interaction with the off-targets.

Briefly, therefore, in one embodiment the present invention is directed to a computational method for selecting an effector having specificity for a target molecule. The method comprises compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set. The computational method further comprises determining spatial orientations of the ligand population members in the ligand-molecule pairs for which the database comprises activity data. Equivalence of the sequence elements may then be based on the determined spatial orientations of the ligand population members in the ligand-molecule pairs for which the data comprises activity data and the sequence elements of different molecule library members may then be labeled to reflect said equivalence. The computational method further comprises calculating, for the ligand-molecule pairs for which the database comprises activity data, interaction energies of the ligand population member with proximal sequence elements of the molecule library member of the respective ligand-molecule pairs when the ligand population member is in a determined likely spatial orientation. The computational method further comprises generating at least one statistical model that is predictive of those sequence elements of the molecule library members that may contribute to a differential effect of the ligand population members on the molecule library members using the calculated interaction energies and the activity data corresponding to the ligand-molecule pairs for which the database contains activity data. An effector that is predicted, based upon the generated statistical model(s), to have a specificity for the target molecule that differs from the specificity of the effector for other molecule library member(s) may then be selected and activity data quantifying an effect of the selected effector upon the activity of one or more of the molecule library members may then be experimentally determined. Preferably, the sequence of steps are repeated wherein an effector selected in an earlier iteration of the sequence of steps is considered a member of the population of ligands in a subsequent iteration of the sequence of steps.

In another embodiment, the present invention is directed to a computational method for selecting an effector having specificity for a target molecule. The method comprises compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members for a set of ligand-molecule pairs wherein the ligands of the ligand-molecule pairs are selected from the ligand population members, the molecules of the ligand-molecule pairs are selected from the molecule library members, and different ligand-molecule pairs in the set comprise a different ligand, a different molecule, or both a different ligand and a different molecule relative to other ligand-molecule pairs in the set, and wherein the activity data differs for different ligand-molecule pairs in the set. In one preferred embodiment, the other member molecules of the library are structurally related to the target molecule. The method further comprises establishing structure-based equivalence of the sequence elements and labeling the sequence elements of different molecule library members to reflect said equivalence and determining likely spatial orientations of the ligand population members in the ligand-molecule pairs for which the database comprises activity data. The method further comprises calculating, for the ligand-molecule pairs for which the database comprises activity data, interaction energies of the ligand population member with proximal sequence elements of the molecule library member of the respective ligand-molecule pairs when the ligand population member is in a determined likely spatial orientation and generating at least one statistical model that is predictive of those sequence elements of the molecule library members that are likely to contribute to the differential effect of ligand population members on molecule library members using the calculated interaction energies and the activity data corresponding to the ligand-molecule pairs for which the database contains activity data. An effector that is likely, based upon the generated statistical model(s), to have specificity for the target molecule that exceeds the specificity of the effector for other molecule library member(s) may then be selected and activity data quantifying an effect of the selected effector upon the activity of one or more molecule library members may then be experimentally determined. In a preferred embodiment, the sequence of steps are repeated at least wherein in a later iteration the effector selected in an earlier iteration of the steps is a member of the population of ligands in a later iteration of steps.

An additional embodiment of the present invention is a computational method for selecting an effector having specificity for a target molecule. The method comprises:
(a) compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set;
(b) determining likely spatial orientations of the ligand population members in the ligand-molecule pairs for which the database comprises activity data;
(c) establishing equivalence of the sequence elements based on determined likely spatial orientations of the ligand population members in the ligand-molecule pairs for which the data comprises activity data and labeling the sequence elements of different molecule library members to reflect said equivalence;
(d) calculating, for the ligand-molecule pairs for which the database comprises activity data, interaction energies of the ligand population member with proximal sequence elements of the molecule library member of the respective ligand-molecule pairs when the ligand population member is in a determined likely spatial orientation;
(e) generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data;
(f) selecting an effector that is likely, based upon the generated statistical model(s), to have specificity for the target molecule that exceeds the specificity of the effector for other molecule library member(s);
(g) experimentally determining activity data quantifying an effect of the selected effector upon the activity of one or more molecule library members; and,
(h) at least once, repeating steps (a) through (g) wherein in a later iteration of steps (a) through (g) the effector selected in step (f) of an earlier iteration of steps (a) through (g) is a member of the population of ligands.

An additional embodiment of the present invention is a system for selecting an effector having specificity for a target molecule. The system comprises: a processor for compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set, determining likely spatial orientations of the ligand population members in the ligand-molecule pairs for which the database comprises activity data, and establishing equivalence of the sequence elements based on determined likely spatial orientations of the ligand population members in the ligand-molecule pairs for which the data comprises activity data and labeling the sequence elements of different molecule library members to reflect said equivalence; a calculator for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; and a classifer for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data.

Another embodiment of the present invention is a system for selecting an effector having specificity for a target molecule. The system comprises: means for compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set; means for establishing structure-based equivalence of the sequence elements and labeling the sequence elements of different molecule library members to reflect said equivalence; means for determining likely spatial orientations of the ligand population members in the ligand-molecule pairs for which the database comprises activity data; means for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; means for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data; means for selecting an effector that is likely, based upon the generated statistical model(s), to have specificity for the target molecule that exceeds the specificity of the effector for other molecule library member(s); means for experimentally determining activity data quantifying an effect of the selected effector upon the activity of one or more molecule library members; and, means for at least once, repeating steps (a) and (c) through (g) wherein in a later iteration of steps (a) and (c) through (g) the effector selected in step (f) of an earlier iteration of steps (c) through (g) is a member of the population of ligands.

An additional embodiment of the present invention is a system for selecting an effector having specificity for a target molecule. The system comprises: a processor for compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set, establishing structure-based equivalence of the sequence elements and labeling the sequence elements of different molecule library members to reflect said equivalence, and determining likely spatial orientations of the ligand population members in the ligand-molecule pairs for which the database comprises activity data; a calculator for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; and, a classifier for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data.

An additional embodiment of the present invention is a system for selecting an effector having specificity for a target molecule. The system comprises: means for compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set; means for determining likely spatial orientations of the ligand population members in the ligand-molecule pairs for which the database comprises activity data; means for establishing equivalence of the sequence elements based on determined likely spatial orientations of the ligand population members in the ligand-molecule pairs for which the data comprises activity data and labeling the sequence elements of different molecule library members to reflect said equivalence; means for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; means for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data; means for selecting an effector that is likely, based upon the generated statistical model(s), to have specificity for the target molecule that exceeds the specificity of the effector for other molecule library member(s); means for experimentally determining activity data quantifying an effect of the selected effector upon the activity of one or more molecule library members; and, means for at least once, repeating steps (a) through (g) wherein in a later iteration of steps (a) through (g) the effector selected in step (f) of an earlier iteration of steps (a) through (g) is a member of the population of ligands.

Other objects and features will be in part apparent and in part pointed out hereinafter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flowchart of the methods of the present invention.

FIG. 2 is a block diagram showing the components of the system of the present invention.

FIG. 3A shows the fitting dot plot for the ELE+DRY model (Table 9). FIG. 3B shows the random-five-groups-leave-some-out (R5G-LSO) cross-validation dot plot for the ELE+DRY model (Table 9).

FIG. 4A shows a dot plot of R5G-LSO cross-validation predictions depicted by HDAC isoforms. FIG. 4B shows a dot plot of R5G-LSO cross-validation predictions depicted by inhibitor.

FIG. 5A shows a histogram of partial least squares (PLS) coefficients for the ELE+DRY DISCRIMINATE model. FIG. 5B shows a histogram of standard deviations for the ELE+DRY DISCRIMINATE model. FIG. 5C shows a histogram of PLS coefficients x standard deviations for the ELE+DRY DISCRIMINATE model. For FIGS. 5A-C, residues were selected using a PLS coefficient threshold value of 0.001. Residue numbers are color-coded according to Table 10. The residue numbers reported correspond to those in Supplemental File 5.

FIG. 6 shows a structural depiction of the four most import residues from the DISCRIMINATE model analysis. The labels and regions are color-coded: in red are the residues in the HDAC's rim region; in blue are those forming the central tube channel; and in black are those in the proximity of the catalytic Zn ion. The zinc binding region (blacking line box), the connection region (blue line box), and the CAP region (red line box) are also highlighted to recall the HDAC pharmacophore model depicted at the bottom. ZBG: Zn-binding group. HS: hydrophobic spacer. CAP: hydrophobic capping group.

FIGS. 7A and 7B show comparisons between the cross-validation predictions for the full model (blue squares) and with only the four most-important residues (MIRs). The coarse tuning of the relationships by the MIRs is indicated by the red squares in FIG. 7A. The differences between the red and blue squares indicate the importance of fine-tuning determined by relatively minor interactions. In FIG. 7B, the MIR predictions are reported classified by inhibitor type. For comparison purposed, only inhibitors for which isozyme profiles of inhibition data were available are shown.

FIG. 8 shows a histogram of ELE and DRY total-activity contributions. The constant (PLS intercept) of the DISCRIMINATOR equation takes the value of 6.68. The sum of ELE and DRY contributions is obtained by the algebraic sum of all per-residue contributions.

FIG. 9A shows a three-dimensional histogram of per-residue activity-contribution plots for the ELE fields. FIG. 9B shows a three-dimensional histogram of per-residue activity-contribution plots for the DRY fields.

FIG. 10 shows a histogram of DRY activity contributions for residue 401.

FIG. 11 shows a three-dimensional histogram of activity contributions of DRY selected most important residues 204, 205, 206, 253, 254, 262, 263, 294, 323 and 442, excluding 401.

FIG. 12 shows a histogram of DRY activity contributions for residue 263.

FIG. 13 shows a histogram of DRY activity contributions for residue 442.

FIG. 14 shows a histogram of DRY activity contributions for residue 254.

FIG. 15 shows a histogram of DRY activity contributions for residue 294.

FIG. 16 shows a histogram of DRY activity contributions for residue 204.

FIG. 17 shows a histogram of DRY activity contributions for residue 323.

FIGS. 18A and 18B show three-dimensional histograms of activity contributions for MS-275. FIGS. 18C-F show graphical representations of the data shown in FIGS. 18A and 18B. FIGS. 18A, 18C, and 18E account for the ELE field. The DRY field is depicted in FIGS. 18B, 18D, and 18F. Residue surfaces are color-coded: for ELE, blue-based surfaces indicate a positive contribution (light blue if the contribution is less than 50% of maximum contribution for a given residue; dark blue indicate areas with higher contributions); red-based surfaces indicate negative contributions (light red for absolute contribution less than 50% of the corresponding residue; dark red for higher percentage of negative contribution). For the DRY field, positive contributions are indicated in green (dark green: contribution higher than 50% of the maximum activity contribution; light green for less contribution); yellow colors are used to indicate negative DRY contributions (dark yellow: absolute contribution higher than 50% of the maximum activity contribution; light yellow for low negative contributions). Dark gray surfaces indicate zero contribution, while light gray are residues with PLS coefficients lower than 0.001. Only residues cited in the text are labeled.

FIGS. 19A and 19B show three-dimensional histograms of activity contributions for SCRIPTAID. FIGS. 19C-F show graphical representations of the data shown in FIGS. 19A and 19B. FIGS. 19A, 19C, and 19E account for the ELE field. The DRY field is depicted in FIGS. 19B, 19D, and 19F. Residue surfaces are color coded: for the ELE, blue-based surfaces indicate positive contributions (light blue if the contribution is less than 50% of maximum contribution for a given residue; dark blue indicate areas with higher contributions); red-based surfaces indicate negative contributions (light red for absolute contributions less than 50% of the corresponding residue; dark red for higher percentage of negative contributions). For the DRY field, positive contributions are indicated in green (dark green: contribution higher than 50% of the maximum activity contribution; light green for less contribution); yellow colors are used to indicate negative DRY contribution (dark yellow: absolute contribution higher than 50% of the maximum activity absolute contribution; light yellow for low negative contributions). Dark gray surfaces indicate zero contributions, while light gray are residues with PLS coefficients lower than 0.001. Activity contribution plots and associated graphicals for all the training set are reported in Supplemental File 4 and FIGS. 10-17, 21, and 33. Only residues cited in the text are labeled.

FIG. 20 is a dot plot showing experimental/predicted pIC₅₀ for the MTS.

FIG. 21 is a set of dot plots showing MTS predictions for single HDAC isoforms.

FIG. 22 is a dot plot showing experimental/predicted pIC₅₀ for the CTS.

FIG. 23 is a histogram showing LTS predictions at two PCs. The X-axis represents HDAC complexes with largazole and the Y-axis represents biological activity values measured as pIC₅₀.

FIG. 24 shows fitting and cross-validation dot plots (LOO, LSO5, and LSO2) recalculate/experimental and predicted/experimental pKᵢ for DISCRIMINATE models CM1 and CM4.

FIG. 25A shows a histogram depicting PLS coefficients for the DRY model CM1. FIG. 25B shows a histogram depicting PLS×SD values for the DRY model CM1. FIG. 25C shows a histogram depicting activity contributions for the DRY model CM1. For FIGS. 25A-C, only bars with values higher than 0.001 and lower than −0.001 are shown.

FIG. 26A shows a histogram depicting PLS coefficients for the DRY_STE model CM4. FIG. 26B shows a histogram depicting PLS×SD values for the DRY_STE model CM4. FIG. 26C shows a histogram depicting activity contributions for the DRY_STE model CM4. For FIGS. 26A-C, only bars with values higher than 0.001 and lower than −0.001 are shown.

FIG. 27 shows binding modes of (R)-MC2082 overlapped with etravirine and TMC278. On the left side are shown (R)-MC2082 in green, etravirine (3mec) in brown and TMC278 (2zd1) in light green, all bound to wild-type HIV-RT. On the right side are shown (R)-MC2082 (green) binding modes in K103N-mutated RT overlapped with etravirine (orange) that was co-crystallized with K103N HIV-RT, TMC278 (light blue) in the K103N-Y181C double mutant (3bgr) and in the L100I-K103 double mutant (purple, 2ze2).

FIGS. 28A-C show graphical depictions of efavirenz (left column) and nevirapine (right column) with the surrounding residue surfaces as in the experimental complexes. The surfaces are colored by activity contribution. A-C shows three orthogonal views of the complexes (rotated along the X axes by +/−90°).

FIG. 29 shows structures of racemic HIV-RT inhibitors resolved by Rotili et al. ( ) used to validate CM4.

FIG. 30 shows docking assessments comparing redocking by Vina and Autodock. In cyan are reported the experimental conformations in the 1vrt and 1fko complexes; in magenta are those redocked with Vina and in brown are those obtained with Autodock. In red is shown HIV-RT in the 1vrt (nevirapine) complex and in green, HIV-RT for 1fko (efavirenz).

FIG. 31 shows Vina-proposed binding modes for the MC1501 and MC2082 enantiomers in six different HIV-RT proteins. The molecular structures are shown with the C6-methyl group highlighted in red at the top of the figure.

FIG. 32 shows a three-dimensional activity-contribution histogram calculated for the test MC compounds. Only bars with values higher than 0.001 and lower than −0.001 are shown.

FIG. 33 shows a histogram depicting DRY activity contributions for residue 205.

### ABBREVIATIONS AND DEFINITIONS

The following definitions and methods are provided to better define the present invention and to guide those of ordinary skill in the art in the practice of the present invention. Unless otherwise noted, terms are to be understood according to conventional usage by those of ordinary skill in the relevant art.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

Activator: any chemical composition that increases the stability and/or activity of a target molecule or the expression of a gene or gene product. For example, classes of activators include, but are not limited to, allosteric activators and genetic activators. Allosteric activators bind to an alternative site on an enzyme, separate from the active site, and positively regulate the enzyme's activity. Allosteric activators typically elicit their effects by changing the conformation of the enzymes they bind to. This usually leads to changes in the active site of an enzyme, allowing for more efficient binding between an enzyme and its substrate. Enzyme activity typically increases as a result. Genetic activators interact with nucleic acids, typically deoxyribonucleic acid (DNA) or ribonucleic acid (RNA), to promote expression of a gene or gene product, respectively. A non-limiting example of genetic activators comprises transcription factors. Transcription factors typically bind to DNA sequences upstream of a gene to be expressed, thereafter recruiting various transcription-related proteins and inducing conformational changes in the DNA that promote gene expression. Transcription factors can bind to promoter regions proximal and upstream of the transcription start site of a gene, or to regions farther upstream of a gene, known as enhancer elements. In either case, transcription factors bind to specific DNA sequences, leaving open the possibility of engineering novel transcription factor-DNA sequence interactions by modifying either transcription factors themselves or a DNA sequence of interest.

Activity data: any measurable quantity that describes some effect of a ligand on a target molecule and/or some property of the ligand itself. Examples of activity data include, but are not limited to, pKₐ, Kᵢ, pKᵢ, IC₅₀, pIC₅₀, free energy, entropy and enthalpy of ligand-target molecule complex formation, log P, and the number of hydrogen bond donors/acceptors.

Acetylation enzyme/acetyl transferases: any enzyme that catalyzes the transfer of an acetyl group from one compound to another. Examples of acetyltransferases include, but are not limited to, histone acetyltransferases, choline acetyltransferases, chloramphenicol acetyltransferases, serotonin N-acetyltransferase, NatA acetyltransferases, and NatB acetyltransferases.

Amino acid: any naturally occurring or synthetic amino acids, as well as amino acid analogs and amino acid mimetics that function similarly to naturally occurring amino acids. Naturally occurring amino acids are those encoded by the genetic code, as well as those amino acids that are later modified, e.g., hydroxyproline, gamma-carboxyglutamate, and O-phosphoserine. Amino acid analogs refers to compounds that have the same basic chemical structure as a naturally occurring amino acid, e.g., a carbon that is bound to a hydrogen, a carboxyl group, an amino group, and an R group, e.g., homoserine, norleucine, methionine sulfoxide, methionine methyl sulfonium. Such analogs may have modified R groups (e.g., norleucine) or modified peptide backbones, but retain the same basic chemical structure as a naturally occurring amino acid. Amino acid mimetics refers to chemical compounds that have a structure that is different from the general chemical structure of an amino acid, but that functions similarly to a naturally occurring amino acid.

Antibody: encompasses naturally occurring immunoglobulins (e.g. IgM, IgG, IgD, IgA, IgE, etc.) as well as non-naturally occurring immunoglobulins, including, for example, single chain antibodies, chimeric antibodies (e.g., humanized murine antibodies) and heteroconjugate antibodies (e.g., bispecific antibodies), as well as antigen-binding fragments thereof, (e.g., Fab′, F(ab′)₂, Fab, Fv, and rIgG). See also, e.g., Pierce Catalog and Handbook, 1994-1995 (Pierce Chemical Co., Rockford, Ill.); Kuby, J., Immunology, 3rd Ed., W.H. Freeman & Co., New York (1998). The term antibody also includes bivalent, trivalent, tetravalent, bispecific, and trispecific molecules, including but not limited to diabodies, triabodies, and tetrabodies. Bivalent and bispecific molecules are described in, e.g., Kostelny et al. (1992) J Immunol 148:1547, Pack and Pluckthun (1992) Biochemistry 31:1579, Hollinger et al., 1993, supra, Gruber et al. (1994) J Immunol: 5368, Zhu et al. (1997) Protein Sci 6:781, Hu et al. (1996) Cancer Res. 56:3055, Adams et al. (1993) Cancer Res. 53:4026, and McCartney, et al. (1995) Protein Eng. 8:301. Non-naturally occurring antibodies can be constructed using solid phase peptide synthesis, can be produced recombinantly, or can be obtained, for example, by screening combinatorial libraries consisting of variable heavy chains and variable light chains as described by Huse et al., Science 246:1275-1281 (1989), which is incorporated herein by reference. These and other methods of making, for example, chimeric, humanized, CDR-grafted, single chain, and bifunctional antibodies, are well known to those skilled in the art (Winter and Harris, Immunol. Today 14:243-246 (1993); Ward et al., Nature 341:544-546 (1989); Harlow and Lane, supra, 1988; Hilyard et al., Protein Engineering: A practical approach (IRL Press 1992); Borrabeck, Antibody Engineering, 2d ed. (Oxford University Press 1995); each of which is incorporated herein by reference).

Deacetylation enzyme/deacetylases: any enzyme that catalyzes the removal of an acetyl group from a substrate molecule. Deacetylases include, but are not limited to, zinc-based and nicotinamide adenine dinucleotide (NAD)-based deacetylases.

Effector: any compound that potentially regulates the biological activity of a target molecule. Effectors include, but are not limited to, inhibitors and activators. In a preferred embodiment, effectors are small organic molecules.

Epigenetic modifications: often closely linked and act in a self-reinforcing manner in the regulation of different cellular processes. DNA methylation and histone acetylation are major epigenetic modifications that are dynamically linked in the epigenetic control of gene expression and their deregulation plays an important role in tumorigenesis. See Feinberg, et al., Nat. Rev. Genet. 7:21-33 (2006); Jones & Baylin, Nat. Rev. Genet. 3:415-428 (2002). Recent studies suggested that an intimate communication and mutual dependence exists between histone acetylation and DNA methylation in the process of gene silencing. Communication between histone acetylation and cytosine methylation may proceed in both directions. In one scenario, DNA methylation may be the primary mark for gene silencing that triggers events leading to non-permissive chromatin state. In another scenario, the loss of histone acetylation may serve as the initial event of gene silencing, which is followed by DNA methylase targeting and induction of local DNA hypermethylation. See Vaissiere, et al., Mut. Res. 659:40-48 (2008).

Target molecule: as described herein can be a molecule of any size that binds, complexes, or otherwise associates with ligands to generate a desired effect. In some embodiments, the macromolecules are proteins or nucleic acids.

Inhibitor: any chemical composition that decreases the stability and/or activity of a target molecule. Inhibitors are typically divided into two classes: reversible and irreversible, based on the nature of their interaction with a target molecule. Irreversible inhibitors tend to interact with a target through covalent bonding, thereby fundamentally changing the chemical nature of the target. Reversible inhibitors, on the other hand, interact with a target via non-covalent interactions such as ionic or hydrogen bonds and hydrophobic interactions. Reversible inhibitors are further divided into four classes, including competitive, noncompetitive, uncompetitive, and mixed inhibitors. For enzymes, the term “competitive inhibition” is used to refer to competitive inhibition in accord with the Michaelis-Menton model of enzyme kinetics. Competitive inhibition is recognized experimentally because the percent inhibition at a fixed inhibitor concentration is decreased by increasing the substrate concentration. At sufficiently high substrate concentration, Vₘₐₓ can essentially be restored even in the presence of the inhibitor. Conversely, “non-competitive inhibition” refers to inhibition that is not reversed by increasing the substrate concentration. “Uncompetitive inhibition” refers to inhibition in which an inhibitor only binds to the enzyme-substrate complex whereas “mixed inhibition” refers to inhibition in which the inhibitor can bind to an enzyme whether the enzyme is in complex with its substrate or not, though its affinity will vary depending on the binding state of the enzyme.

Histone deacetylases (HDACs): a family of protein modifying-enzymes found in bacteria, fungi, plants and animals. In the human, 18 different isoforms have been identified and divided into 4 classes according to size, cellular localization, number of active sites and homology with yeast deacetylases (Mai, A., et al., 2005). Class I, that includes HDAC-1, -2, -3 and -8, is related to yeast RPD3, shares nuclear localization with the exception of HDAC3, and has ubiquitous expression. Instead, class II shows domains with similarity to yeast Hda1 and can be further divided into class IIa, which includes HDAC-4, -5, -7 and -9, and class IIb (HDAC-6 and -10) that contain two catalytic sites. HDAC3 and members of class II have been shown to shuttle between the cytoplasm and nucleus, and have tissue-specific expression. HDAC11 is the only member of class IV. HDAC classes I, II and IV are zinc-dependent proteases; unlike those of class III, called sirtuins, which require NAD+ as cofactor. HDACs play a key role in epigenetics—controlling gene expression involved in all aspects of biology—cell proliferation, chromosome remodeling, gene silencing, and gene transcription (Hu, E., et al., 2003). They regulate the acetylated state of histone proteins removing the acetyl moiety from the ε-amino group of lysine residues on the N-terminal extension of the core histones, this leads to changes in the structure of histones and therefore modifies the accessibility of transcription enzymes with gene-promoter regions. In addition, HDACs dynamically modify the activity of diverse types of non-histone proteins (Choudhary, C., et al., 2009). These include transcription factors, signal-transduction mediators, microtubules and a molecular chaperone. In particular, distinct HDACs class I and II are overexpressed in several types of cancer.

HDAC inhibitors (HDACIs): classified according to their chemical structure as, for example, short-chain fatty acids, hydroxamic acids, benzamides, ketones and cyclic peptides with a pendant functional group. Because of the overexpression of some HDACs in cancer, HDACIs have been developed and approved for the treatment of cutaneous T-cell lymphoma: for example, Merck's Zolinza (suberoylanilide hydroxamic acid, SAHA) and Celgene's Istodax (Romidepsin, FK228) (Zain, J., et al., 2010). More recently, HDACIs have emerged as potential therapeutics for the stimulation of viral expression from infected cells in the hope of eradication of HIV infection (Savarino, A., et al., 2009, Choudhary, S. K., et al., 2011, Matalon, S., et al., 2011, Ortiz, A. R., et al., 1997, Ortiz, A. R., et al., 1995, Perez, C., et al., 1998, Lozano, J. J., et al., 2000, Ballante, F., et al., 2012). Many HDACIs show variability in their ability to inhibit particular isoforms. Unfortunately, as for SAHA and trichostatin A (TSA), the majority of HDACIs inhibit many HDAC isoforms nonspecifically. Others, such as MS-275, a benzamide, are more selective for class I, but still not isoform specific.

Interaction energy: the total energy of interaction between two entities. In the context of the present invention, interaction energies may be calculated according to the interaction between a given ligand and a sequence element, for example, an amino acid of a target protein. In a preferred embodiment of the invention, interaction energies are broken down into their component parts for a particular interaction between a ligand and a sequence element, i.e. electrostatic interaction energy, van der Waals interaction energy, desolvation energy, surface complementarity (polar vs. non-polar), volume of cavity occupied, etc.

Nucleic acids: Nucleic acid” or “oligonucleotide” or “polynucleotide” used herein mean at least two nucleotides covalently linked together. Many variants of a nucleic acid may be used for the same purpose as a given nucleic acid. Thus, a nucleic acid also encompasses substantially identical nucleic acids and complements thereof. Nucleic acids may be single stranded or double stranded, or may contain portions of both double stranded and single stranded sequences. The nucleic acid may be DNA, both genomic and cDNA, RNA, or a hybrid, where the nucleic acid may contain combinations of deoxyribo- and ribo-nucleotides, and combinations of bases including uracil, adenine, thymine, cytosine, guanine, inosine, xanthine hypoxanthine, isocytosine and isoguanine. Nucleic acids may be synthesized as a single stranded molecule or expressed in a cell (in vitro or in vivo) using a synthetic gene. Nucleic acids may be obtained by chemical synthesis methods or by recombinant methods. The nucleic acid may also be a RNA such as a mRNA, tRNA, short hairpin RNA (shRNA), short interfering RNA (sRNA), double-stranded RNA (dsRNA), transcriptional gene silencing RNA (ptgsRNA), Piwi-interacting RNA, pri-miRNA, pre-miRNA, micro-RNA (miRNA), or anti-miRNA, as described, e.g., in U.S. patent application Ser. Nos. 11/429,720, 11/384,049, 11/418,870, and 11/429,720 and Published International Application Nos. WO 2005/116250 and WO 2006/126040. sRNA gene-targeting may be carried out by transient sRNA transfer into cells, achieved by such classic methods as lipid-mediated transfection (such as encapsulation in liposome, complexing with cationic lipids, cholesterol, and/or condensing polymers, electroporation, or microinjection). sRNA gene-targeting may also be carried out by administration of sRNA conjugated with antibodies or sRNA complexed with a fusion protein comprising a cell-penetrating peptide conjugated to a double-stranded (ds) RNA-binding domain (DRBD) that binds to the sRNA (see, e.g., U.S. Patent Application Publication No. 2009/0093026). An shRNA molecule has two sequence regions that are reversely complementary to one another and can form a double strand with one another in an intramolecular manner. shRNA gene-targeting may be carried out by using a vector introduced into cells, such as viral vectors (lentiviral vectors, adenoviral vectors, or adeno-associated viral vectors for example). The design and synthesis of siRNA and shRNA molecules are known in the art, and may be commercially purchased from, e.g., Gene Link (Hawthorne, N.Y.), Invitrogen Corp. (Carlsbad, Calif.), Thermo Fisher Scientific, and Dharmacon Products (Lafayette, Colo.). The nucleic acid may also be an aptamer, an intramer, or a spiegelmer. The term “aptamer” refers to a nucleic acid or oligonucleotide molecule that binds to a specific molecular target. Aptamers are derived from an in vitro evolutionary process (e.g., SELEX (Systematic Evolution of Ligands by EXponential Enrichment), disclosed in U.S. Pat. No. 5,270,163), which selects for target-specific aptamer sequences from large combinatorial libraries. Aptamer compositions may be double-stranded or single-stranded, and may include deoxyribonucleotides, ribonucleotides, nucleotide derivatives, or other nucleotide-like molecules. The nucleotide components of an aptamer may have modified sugar groups (e.g., the 2′—OH group of a ribonucleotide may be replaced by 2′-F or 2′-NH₂), which may improve a desired property, e.g., resistance to nucleases or longer lifetime in blood. Aptamers may be conjugated to other molecules, e.g., a high molecular weight carrier to slow clearance of the aptamer from the circulatory system. Aptamers may be specifically cross-linked to their cognate ligands, e.g., by photo-activation of a cross-linker (Brody, E. N. and L. Gold (2000) J. Biotechnol. 74:5-13). The term “intramer” refers to an aptamer which is expressed in vivo. For example, a vaccinia virus-based RNA expression system has been used to express specific RNA aptamers at high levels in the cytoplasm of leukocytes (Blind, M. et al. (1999) Proc. Natl. Acad. Sci. USA 96:3606-3610). The term “spiegelmer” refers to an aptamer which includes L-DNA, L-RNA, or other left-handed nucleotide derivatives or nucleotide-like molecules. Aptamers containing left-handed nucleotides are resistant to degradation by naturally occurring enzymes, which normally act on substrates containing right-handed nucleotides. A nucleic acid will generally contain phosphodiester bonds, although nucleic acid analogs may be included that may have at least one different linkage, e.g., phosphoramidate, phosphorothioate, phosphorodithioate, or O-methylphosphoroamidite linkages and peptide nucleic acid backbones and linkages. Other analog nucleic acids include those with positive backbones; non-ionic backbones, and non-ribose backbones, including those disclosed in U.S. Pat. Nos. 5,235,033 and 5,034,506. Nucleic acids containing one or more non-naturally occurring or modified nucleotides are also included within the definition of nucleic acid. The modified nucleotide analog may be located for example at the 5′-end and/or the 3′-end of the nucleic acid molecule. Representative examples of nucleotide analogs may be selected from sugar- or backbone-modified ribonucleotides.

It should be noted, however, that also nucleobase-modified ribonucleotides, i.e. ribonucleotides, containing a non-naturally occurring nucleobase instead of a naturally occurring nucleobase such as uridines or cytidines modified at the 5-position, e.g. 5-(2-amino)propyl uridine, 5-bromo uridine; adenosines and guanosines modified at the 8-position, e.g. 8-bromo guanosine; deaza nucleotides, e.g. 7-deaza-adenosine; 0- and N-alkylated nucleotides, e.g. N6-methyl adenosine are suitable. The 2′-OH-group may be replaced by a group selected from H, OR, R, halo, SH, SR, NH₂, NHR, NR₂ or CN, wherein R is C₁-C₆ alkyl, alkenyl or alkynyl and halo is F, Cl, Br or I. Modified nucleotides also include nucleotides conjugated with cholesterol through, e.g., a hydroxyprolinol linkage as disclosed in Krutzfeldt et al., Nature (Oct. 30, 2005), Soutschek et al., Nature 432:173-178 (2004), and U.S. Patent Application Publication No. 20050107325. Modified nucleotides and nucleic acids may also include locked nucleic acids (LNA), as disclosed in U.S. Patent Application Publication No. 20020115080. Additional modified nucleotides and nucleic acids are disclosed in U.S. Patent Application Publication No. 20050182005. Modifications of the ribose-phosphate backbone may be done for a variety of reasons, e.g., to increase the stability and half-life of such molecules in physiological environments, to enhance diffusion across cell membranes, or as probes on a biochip. Mixtures of naturally occurring nucleic acids and analogs may be made; alternatively, mixtures of different nucleic acid analogs, and mixtures of naturally occurring nucleic acids and analogs may be made.

Protein/peptide/polypeptide: The terms “peptide,” “polypeptide,” and “protein” are used interchangeably herein. In the present invention, these terms mean a linked sequence of amino acids, which may be natural, synthetic, or a modification, or combination of natural and synthetic. The term includes antibodies, antibody mimetics, domain antibodies, lipocalins, targeted proteases, and polypeptide mimetics. The term also includes vaccines containing a peptide or peptide fragment intended to raise antibodies against the peptide or peptide fragment.

Proximal sequence elements: includes, but is not limited to, the component parts of a sequence of linked chemical substances. For example, the sequence elements of a nucleotide sequence are nucleic acids, such as, for example, adenine, cytosine, guanine, and thymine in DNA or uracil in RNA. For proteins, the sequence elements are amino acids, including, but not limited to, naturally occurring and synthetic amino acids. The term “proximal” in the context of sequence elements refers to those sequence elements of a target molecule that are within a given distance of a complexed ligand. In some embodiments of the present invention, the distance is a variable usually measured from the ligand-binding site on the target molecule that encompasses those residues of the target with a significant contribution to discriminate relative affinities of ligands.

Specificity: refers to a binding reaction between molecules that produces activity data at least two times the background and more typically more than 10 to 100 times background molecular associations under physiological conditions. In the context of the present invention, the desired specificity may be for a particular ligand to interact favorably with one library member (sometimes referred to herein as a target molecule) relative to other molecules (sometimes referred to herein as off-target molecules) from a library of molecules containing the molecule (e.g. a single HDAC isoform out of a library of several HDAC isoforms) or for a particular ligand to interact most favorably with two or more library members (e.g. multiple mutant forms of human immunodeficiency virus-1 reverse transcriptase (HIV-1 RT).

Small molecule: includes any relatively small chemical or other moiety that can act to affect biological processes. Small molecules can include any number of therapeutic agents presently known and used, or can be synthesized in a library of such molecules for the purpose of screening for biological function(s). Small molecules are distinguished from macromolecules by size. The small molecules of this invention usually have a molecular weight less than about 5,000 daltons (Da), preferably less than about 2,500 Da, more preferably less than 1,000 Da, most preferably less than about 500 Da. “Organic compound” refers to any carbon-based compound other than biologics such as nucleic acids, polypeptides, and polysaccharides. In addition to carbon, organic compounds may contain calcium, chlorine, fluorine, copper, hydrogen, iron, potassium, nitrogen, oxygen, sulfur and other elements. An organic compound may be in an aromatic or aliphatic form. Non-limiting examples of organic compounds include acetones, alcohols, anilines, carbohydrates, mono-saccharides, di-saccharides, amino acids, nucleosides, nucleotides, lipids, retinoids, steroids, proteoglycans, ketones, aldehydes, saturated, unsaturated and polyunsaturated fats, oils and waxes, alkenes, esters, ethers, thiols, sulfides, cyclic compounds, heterocyclic compounds, imidizoles, and phenols. Organic compounds also include nitrated organic compounds and halogenated (e.g., chlorinated) organic compounds. Collections of small molecules, and small molecules identified according to the invention are characterized by techniques such as accelerator mass spectrometry (AMS; see Turteltaub et al., Curr Pharm Des 2000 6:991-1007, Bioanalytical applications of accelerator mass spectrometry for pharmaceutical research; and Enjalbal et al., Mass Spectrom Rev 2000 19:139-61, Mass spectrometry in combinatorial chemistry.) Preferred small molecules are relatively easier and less expensively manufactured, formulated or otherwise prepared. Preferred small molecules are stable under a variety of storage conditions. Preferred small molecules may be placed in tight association with macromolecules to form molecules that are biologically active and that have improved pharmaceutical properties. Improved pharmaceutical properties include changes in circulation time, distribution, metabolism, modification, excretion, secretion, elimination, and stability that are favorable to the desired biological activity. Improved pharmaceutical properties include changes in the toxicological and efficacy characteristics of the chemical entity.

Structurally related: refers to the target molecules in the library of molecules used in the methods, models, and systems of the present invention. Structurally related molecules may show some degree of similarity in sequence or three-dimensional structural homology in their respective structures. “Structural homology” refers to the degree of coincidence in space between two or more protein backbones. Protein backbones that adopt the same protein structure, fold and show similarity upon three-dimensional structural superposition in space can be considered structurally homologous. Structural homology is not based on sequence homology, but rather on three-dimensional homology. Two amino acids in two different proteins said to be homologous based on structural homology between those proteins, do not necessarily need to be in sequence-based homologous regions. For example, protein backbones that have a root mean squared (RMS) deviation of less than 3.5, 3.0, 2.5, 2.0, 1.7 or 1.5 angstroms at a given space position or defined region between each other can be considered to be structurally homologous in that region. It is contemplated herein that substantially equivalent amino acid positions that are located on two or more different protein sequences that share a certain degree of structural homology will have comparable functional tasks. These two amino acids then can be said to have structure-based equivalence with each other, even if their precise primary linear positions on the amino acid sequences, when these sequences are aligned, do not match with each other. Amino acids that are exhibit structure-based equivalence can be far away from each other in the primary protein sequences when these sequences are aligned following the rules of classical sequence homology.

### EMBODIMENTS

The present invention provides methods, models, and systems for selecting an effector having a desired specificity for a target molecule. The methods, models, and systems of the present invention, sometimes arbitrarily referred to herein as the DISCRIMINATE method, model, or system, or merely DISCRIMINATE, are computer-implemented approaches to utilizing the abundance of available data from diverse sources of structure-activity studies to select existing molecules or design new molecules optimized for a desired effect. Drug discovery efforts are greatly enhanced by the inclusion of computer-based, predictive methods due to the practically infinite number of compounds theoretically available for testing. Moreover, determining the various effects of a compound of interest is a rigorous, time-consuming, labor-intensive, and expensive process. Hence, there is a continuing need for improved computational methods used in the development of accurate, predictive models for drug discovery applications.

For clarity of discussion, molecules for which an effector is sought will be referred to as “targets” or “target molecules” whereas those other molecule library members for which an effector is not sought will be referred to as “off-targets” or “off-target molecules.” In some embodiments of the present invention, effectors will be selected for exhibiting specificity for a target or a set of targets that exceeds the specificity for an off-target or a set of off-targets.

The methods, models, and systems of the present invention can be applied to practically any problem in which ligand activity specific for a target or a subset of targets is desired. For example, targets may include, but are not limited to, peptides, nucleic acids, carbohydrates, lipids, and combinations thereof. In some embodiments of the present invention, the peptides are, for example, receptors, enzymes, and ribosomal peptides. Receptors may include G-protein-coupled receptors, for example. Enzymes may include, but are not limited to, proteolytic enzymes, such as, for example, HIV protease, kinases, such as, for example, tyrosine kinases, HIV reverse transcriptase, and enzymes that catalyze epigenetic modifications, such as, for example methyl transferases (methylases), demethylases, acetyl transferases (acetylases), and deacetylases. Enzymes that catalyze epigenetic modifications can act on multiple types of substrates, including, for example, nucleic acid, such as DNA, and peptides, such as histones. In some embodiments of the present invention, the acetyl transferases are lysine acetyl transferases (KATs). In some embodiments of the present invention, the deacetylases are zinc-based lysine deacetylases (KDACs). Zinc-based lysine deacetylases include, but are not limited to, histone deacetylases (HDACs). In some embodiments of the present invention, the deacetylases are NAD-based lysine deacetylases. In additional embodiments of the present invention, ribosomal peptides include any peptide that comprises a ribosome. In some embodiments of the present invention, the nucleic acids are ribonucleic acids, such as, for example, ribozymes, siRNAs, and shRNAs. In additional embodiments of the present invention, the nucleic acids are deoxyribonucleic acids. The deoxyribonucleic acids of the present invention may comprise protein binding sites, such as, for example, promoters, transcription factor binding sites, and enhancer binding sites.

The effectors of the present invention may produce, for example, a measurable change in activity for the target molecules of the present invention. In some embodiments of the present invention, the effectors are inhibitors of the target molecule. In some embodiments of the present invention, the effectors are activators of the target molecule. In some embodiments of the present invention, the effectors may produce no measurable change in the activity of the target molecule. It is to be understood that effectors of the present invention are selected based on predictive models produced by the methods and systems of the present invention. Effectors predicted to, for example, inhibit or activate a target molecule, may prove not to exhibit the predicted effect when tested experimentally. Thus, it is to be understood that effectors of the present invention need not produce the predicted effect in the target molecule. However, these experimental determinations are still useful in generating a new iterative model with improved predictive power.

In some embodiments of the present invention, the effector is selected to have a specificity for a target molecule. In some embodiments of the invention, an effector's specificity for a target molecule may produce a change in activity of the target molecule (compared to an untreated target molecule or control treated target molecule) that is at least 2 to 100 times the change measured in off-targets (compared to untreated or control off-targets). For example, an effector's specificity for a target molecule may produce a change in activity of the target molecule that is at least 5, 10, 15, 20, 25, 30, 35, 40, 45, 50, 60, 70, 80, or 90 times the change measured in off-targets. In some embodiments of the present invention, one may wish to select an effector having lesser specificity, such as, for example, an effector that produces a change in the activity of the target molecule that is equal to or less than 1.01 to 10 times the change measured in off-targets. In this example, the effector's specificity for a target molecule may produce a change in activity of the target molecule that is equal to or less than 1.02, 1.03, 1.04, 1.05, 1.1, 1.2, 1.3, 1.4, 1.5, 1.75, 2, 3, 4, 5, 6, 7, 8, or 9 times the change measured in off-targets. This type of approach may be useful in designing a drug that would be insensitive to potential mutations in its target. An ideal target for such a drug may be, for example, HIV-1 RT, discussed in greater detail below.

Other approaches exist for the prediction of drug binding affinities, most notably, comparative binding energy analysis (COMBINE). (Ortiz, A., et al., 1995, Ortiz, A., et al., 1997, Perez, C., et al., 1998, Lozano, J. J., et al., 2000, Murcia, M. et al., 2006, Henrich, S. et al., 2009). The present invention improves on these approaches in several substantive ways. First, the models, methods and systems of the present invention comprise an iterative method that improves its predictive ability by the inclusion of experimental data gathered from experimentally testing the effect of a selected effector on the target molecule and off-targets. For example, experimental data can be generated, both from target molecules and off-targets, after experimentally evaluating the activity of a compound predicted by the models, methods and systems of the present invention to have a desired specificity. Additionally, newly published data as well as data profiling of known compounds against both targets and off-targets can also be used in iterative refinements of the methods, models, and systems of the present invention as such data becomes available. Other approaches to building predictive binding models are not iterative in nature and, as such, said models cannot be further improved by the addition of new data.

The iterative nature of the models, methods and systems of the present invention provides a user with a greater degree of flexibility when choosing ligand-target molecule and ligand-off-target molecule pairs because activity data for each and every possible permutation of ligands with the targets and off-targets is not required. The models, methods and systems of the present invention can generate predictive models based on any initial database size, regardless of the absence of data for any given ligand-target or ligand-off-target molecule combination, which can then be used to select and experimentally determine the activity of a ligand predicted to have a desired specificity for the target(s). Once obtained, this activity data may be added to the database, effectively improving the predictability of the models, methods and systems of the present invention in subsequent iterations. In one embodiment, for example, the method is repeated at least twice for two selected ligands. By way of further example, in one embodiment, the method is repeated at least three times for at least three different selected ligands. By way of further example, in one embodiment, the method is repeated at least five times for at least five different selected ligands.

Furthermore, the models, methods, and systems of the present invention improve on a number of other deficiencies inherent to previous methods that are understood by one of skill in the art to introduce noise to the parameters calculated for generation of predictive 3D-QSAR models. Examples of such deficiencies include, but are not limited to, inadequate sampling of alternative ligand-binding poses when computationally determining a likely spatial orientation of a ligand-target molecule or ligand-off-target molecule pair, inaccuracies in scoring functions during docking, and limitations of force fields regarding electrostatics (e.g. monopole force fields lacking polarizability). The models, methods, and systems of the present invention address these limitations by implementing systematic search approaches in docking (SKATE) and atomic multipole optimized energetics for biomolecular applications) (AMOEBA) force fields instead of the more primitive monopole force field methods used previously. Additionally, numerous heuristic approaches to generating 3D-QSARs are compatible within the models, methods, and systems of the present invention, including, but not limited to, partial least squares of latent variables (PLS) (reviewed in Haenlein, M, et al., 2004, which is incorporated herein by reference), neural networks (reviewed in Cheng, B., et al., 1994 and Khosravi, A., et al., 2011, which are incorporated herein by reference), and support vector machines (reviewed in Naul, B, 2009, which is incorporated herein by reference). The methodology chosen to generate the heuristic 3D-QSAR models in the methods and systems of the present invention can be varied to optimize the predictability of the models generated depending on the size and quality of the datasets. In the examples given below, PLS is the methodology used.

In some embodiments of the present invention, a database is compiled. In the context of the present invention, the database may include, for example, a list of ligand-target and ligand-off-target pairs along with a number of other types of associated data, including, but not limited to, three-dimensional structural data for the targets and off-targets (i.e., members of the library of molecules), structural data for the ligands, and activity data relating the effect of a particular ligand on a molecule (target or off-target) it is in complex with. It is to be understood, as discussed above, that the database need not be complete, meaning, for example, that for a given list of ligand-target and ligand-off-target pairs, activity data for each pair is not required for the methods and systems of the invention to function. Activity data may be determined in a later iteration of the methods of the present invention and subsequently added to the database or additional ligand-target and ligand-off-target pairs may be added to the database as activity data for said pairs becomes available.

In some embodiments of present invention, the three-dimensional structural data can be gathered from a number of broadly defined sources including, but not limited to, experimentally determined three-dimensional structural data and computationally determined three-dimensional structural data. Experimentally determined three-dimensional structural data is produced as the result of a number of techniques, including, but not limited to, X-ray crystallography (reviewed in Stryer, L., 1968, Matthews, B. W., 1976, and Russo Krauss, I., et al., 2013, each of which is incorporated herein by reference) nuclear magnetic resonance spectroscopy (reviewed in Allerhand, A., et al., 1970, Dyson, H. J., et al., 1996, and Otting, G., et al., 2010, each of which is incorporated herein by reference), and cryo-electron microscopy (reviewed in van Heel, et al., 2000, Frank, J., 2002, Milne, J. L, et al., 2012, each of which is incorporated herein by reference). All of these techniques yield some representation, of varying resolution, of the three-dimensional structure of a protein/nucleic acid or protein/nucleic acid-ligand complex. Computationally determined three-dimensional structural data can be generated using a number of techniques including, but not limited to, homology modeling and protein threading. Homology modeling is discussed in Krieger, E., et al., 2003, which is incorporated herein by reference. Protein threading is discussed in Xu, J., et al., 2008, which is incorporated herein by reference. Additionally, the ability to predict lower resolution 3D structures is becoming an increasing reality that is also contemplated for use in the present invention.

In some embodiments of the present invention, the library of molecules includes two or more molecules that may exhibit disparate activity data when exposed to various ligands. In some embodiments, the library of molecules includes targets and off-targets. In some embodiments of the present invention, the library of molecules includes three or more, four or more, five or more, six or more, seven or more, eight or more, nine or more, or ten or more molecules. It is to be understood that the present invention has no upward limit on the number of molecules that the library of molecules may comprise. Additionally, in some embodiments of the present invention, the library of molecules constitutes, for example, a set of similar related molecules for which one would like to determine specific effectors for each or a subset of the molecules. Similar molecules include, but are not limited to, homologous molecules, isoforms, structurally related molecules, and mutant molecules. For example, a library of molecules may constitute molecules of high sequence or structural identity for which a ligand of particular specificity is required. In this example, one may wish to decipher the individual roles of a collection of various protein isoforms when suitable isoform-specific inhibitors may not yet exist. Such is the case with HDACIs. Selective HDACIs, which would affect either a single HDAC isoform or only a few isoforms within a single class, would be ideal molecular scalpels to help elucidate the individual functions of each HDAC isoform in the complexity of epigenetics. In some embodiments of the present invention, the library of molecules may constitute, for example, a target molecule and other molecules bearing little to no structural (i.e. are not structurally related) or functional relationship with the target molecule. In these embodiments, likely spatial orientations of ligands in targets can be determined before establishing equivalence of residues on targets and off-targets. Equivalence, in this example, may be established by using the docked ligand as the frame of reference. In this example, “equivalent” residues will be those residues in each complex that interact with the docked ligand. This type of approach may be used, for example, if one wishes to enhance specificity of a ligand for the target molecule versus a completely different class of molecule to, for example, eliminate off-target side effects.

In some embodiments of the present invention, the chemical sequences of the targets and off-targets are known. In some embodiments of the present invention, the chemical sequences comprise sequence elements. For example, in the case of DNA or RNA molecules, the sequence elements comprise nucleotides. In another example, the chemical sequences of peptides comprise amino acids. In another example, the chemical sequence of carbohydrates comprise sugars.

In some embodiments of the present invention, the population of ligands includes two or more ligands that, when in complex with individual members of the library of molecules, may produce a measurable change in activity of the library molecules (compared an uncomplexed library molecule control, for example). In some embodiments of the present invention, the population of ligands includes three or more, four or more, five or more, six or more, seven or more, eight or more, nine or more, or ten or more ligands. It is to be understood that the present invention has no upward limit on the number of ligands that the population of ligands may comprise. In some embodiments, the population of ligands can include, but is not limited to, small molecules, lipids, steroids, peptides, biogenic amines, carbohydrates, nucleic acids, such as, for example, small interfering RNAs (siRNAs), short hairpin RNAs (shRNAs), and DNA aptamers, lipids, and proteins, such as, for example, transcription factors and antibodies.

In some embodiments of the present invention, structural data for the population of ligands may include, for example, three-dimensional structural data as discussed above (for proteins, nucleic acids, and carbohydrates). For small molecules, two-dimensional chemical structures are sufficient for the methods and systems of the present invention to function, but will require further additional preparation to generate 3D conformer libraries.

In certain embodiments of the present invention, activity data includes, but is not limited to, measurements of Kₐ, pKₐ, Kᵢ, pKᵢ, IC₅₀, pIC₅₀, free energy, entropy, and enthalpy of ligand-target and ligand-off-target complex formation, log P, and the number of hydrogen bond donors/acceptors of each member in a given complex.

In some embodiments of the present invention, structure-based equivalence data is gathered by aligning sequence elements based on their functional roles. For example, in the context of peptides, amino acid sequences are typically aligned based on sequence homology to determine which amino acids can be considered crucial to the respective functions of the molecules. In theory, amino acids conserved over multiple peptides may play some important evolutionary role or be critical for some shared function of the peptides. However, because certain amino acids have redundant functionality with each other, some peptides may share some functionality while exhibiting lower levels of sequence homology. In this situation, experimental or computational methods can be used to align sequence elements based on their function rather than sequence identity. Such experimental methods include, but are not limited to, X-ray crystallography, NMR spectroscopy, and cryo-electron microscopy and such computational methods include, for example, homology modeling. Homology modeling is usually performed computationally, by programs such as Modeller. An example of how one may establish structure-based equivalence may include two amino acid sequences sharing low levels of homology, but, from the experimental or computational methods discussed above, both sequences may be predicted to form an alpha helix in a particular region of protein. These sequences would thus be functionally aligned and be structurally equivalent, which may or may not result in a different amino acid numbering system than that brought about from a simple amino acid sequence alignment. In some embodiments of the present invention, labeling the sequence elements of the targets and off-targets may be performed to reflect the structural and functional equivalence of their respective sequence elements during molecular recognition of the ligand. In some embodiments of the present invention, establishing structure-based equivalence of residues on different targets would identify residues that are, for example, within 2 angstroms root mean square deviation (rmsd).

In some embodiments of the present invention, the likely spatial orientations of the ligand population members in the ligand-target and ligand-off-target pairs may be determined experimentally or computationally. X-crystallography experiments, for example, may yield three-dimensional structural data for targets and off-targets in complex with various ligand population members. The experimentally determined spatial orientation of the ligand in, for example, an enzyme active site, is typically an accurate representation of a ligand's native spatial orientation when in complex with the enzyme. Other methods for experimentally determining the likely spatial orientations of the ligands in the ligand-target or ligand-off-target pairs include, but are not limited to, NMR spectroscopy and cryo-electron microscopy. In some embodiments of the invention, molecular docking simulations can be used to computationally determine a likely spatial orientation. However, due to inaccuracies in computational docking or in the experimental determination of the bound conformation of a ligand in complex with a target or off-target, refinement by energy minimization can improve the geometry of the complex. For example, molecular interactions can be quantified by atomic-based force fields. Assuming that the force field chosen is sufficiently accurate, then the minimal energy complex of the ligand-target or ligand-off-target pairs generally is the correct, most likely, spatial orientation.

Computationally derived likely spatial orientations are typically determined using molecular docking software. Generally, molecular docking software can determine the preferred binding orientation (or “pose”) of a ligand when in complex with a molecule such as, for example, a peptide. Suitable molecular docking software includes, but is not limited to, AutoDock (http://autodock.scripps.edu), PatchDock (http://bioinfo3d.cs.tau.ac.il/PatchDock), ClusPro (http://cluspro.bu.edu, http://nrc.bu.edu/cluster), DockingServer (http://www.dockingserver.com), DOCK (http://dock.compbio.ucsf.edu), 3DLigandSite (http://www.sbabio.ic.ac.uk/˜3dligandsite), ATOME (http://atome.cbs.cnrs.fr/AT2/meta.html), AutoDock Vina (http://vina.scripps.edu), BSP-SLIM (http://zhanglab.ccmb.med.umich.edu/BSP-SLIM), FiberDock (http://bioinfo3d.cs.tau.ac.il/FiberDock), GEMDOCK (http://gemdock.life.nctu.edu.tw/dock), Hex (http://hex.loria.fr), idTarget http://idtarget.rcas.sinica.edu.tw), iGEMDOCK (http://gemdock.life.nctu.edu.tw/dock/igemdock.php), iScreen (http://iscreen.cmu.edu.tw), ParDOCK (http://www.scfbio-iitd.res.in/dock/pardock.isp), Quantum.Ligand.Dock (http://87.116.85.141/LigandDock.html), Surflex-Dock (http://www.tripos.com/index.php?family=modules,SimplePage . . . &page=Surflex_Dock), ADAM (http://www.immd.co.jp/en/product_2.html), ADDock (http://www.biodelight.com.tw/English/addock_index.html), AuPosSOM (https://www.biomedicale.univ-paris5.fr/aupossom), BetaDock (http://voronoi.hanyang.ac.kr/software.htm), DOCK Blaster (http://blaster.docking.org), DockIt (http://www.metaphorics.com/products/dockit.html), DockVision (http://dockvision.com), eHiTS (http://www.simbiosys.ca/ehits), FITTED (http://fitted.ca/index.php?option=com_content&task=view&id=50&Itemid=40), Fleksy (http://www.cmbisu.nl/software/fleksy), FlexX (http://www.biosolveit.de/flexx), FLIPDock (http://flipdock.scripps.edu/what-is-flipdock), FRED (http://www.eyesopen.com/docs/oedocking/current/html/fred.html), GlamDock (http://www.chil2.de/Glamdock.html), GOLD (http://www.ccdc.cam.ac.uk/products/life_sciences/gold), GPCRautomodel (http://genome.jouy.inra.fr/GPCRautomdl/cgi-bin/welcome.pl), GRAMM-X (http://vakser.bioinformatics.ku.edu/resources/gramm/grammx), HADDOCK (http://www.nmr.chem.uu.nl/haddock), HomDock (http://www.chil2.de/HomDock.html), HYBRID (http://www.eyesopen.com/docs/oedocking/current/html/hybrid.html#hybrid), ICM-Docking (http://www.molsoft.com/docking.html), kinDOCK (http://abcis.cbs.cnrs.fr/LIGBASE_SERV_WEB/PHP/kindock.php), Lead Finder (http://www.moltech.ru), Magnet (http://www.metaphorics.com/products/magnet), MEDock (http://medock.csie.ntu.edu.tw), MVD (http://www.molegro.com/mvd-product.php), ParaDocks (http://www.paradocks.org), PLANTS (http://www.tcd.uni-konstanz.de/research/plants.php), POSIT (http://www.eyesopen.com/docs/posit/current/html/theory.html), Rosetta FlexPepDock (http://flexpepdock.furmanlab.cs.huji.ac.il/index.php), RosettaLigand (http://www.rosettacommons.org/software), SwissDock (http://swissdock.vital-it.ch), SymmDock (http://bioinfo3d.cs.tau.ac.il/SymmDock), TarFisDock (http://www.dddc.ac.cn/tarfisdock), VEGA ZZ (http://www.vepazz.net), VLifeDock (http://www.vlifesciences.com/products/VLifeMDS/VLifeDock.php). (Sravanthi Davuluri and Akhilesh Bajpai (Correspondence: Acharya K K, kshitish@ibab.ac.in), A list of resources for molecular docking; In: Startbioinfo; 23 Oct. 2012, http://www.shodhaka.com/cgi-bin/startbioinfo/prelimresources.pl?tn=Molecular docking), and SKATE.

In some embodiments, the interaction energies calculated by the methods and systems of the present invention are calculated computationally. A number of different programs can be used in this regard, including, for example, AutoGrid. AutoGrid is a program that pre-calculates energies for various atom types, such as aliphatic carbons, aromatic carbons, hydrogen bonding oxygens, and so on, with macromolecules such as, for example, peptides and nucleic acids. Total interaction energies of ligands in complex with targets or off-targets tend to show little correlation with associated activity data, however when component interaction energies (e.g. interaction energies due to electrostatic, van der Waals, and desolvation interactions) are calculated for each proximal sequence element, higher levels of correlation may be observed. In some embodiments of the present invention, when using, for example, PLS for statistical analysis, an r² value of 0.6 is considered substantially significant, though higher levels of correlation, such as, for example, r² values of 0.65, 0.70, 0.75, 0.80, 0.85, 0.90, 0.95, 1.0, and all ranges in between are possible and within the scope of the present disclosure. Component interaction energies are generally calculated using force fields that include parameters for various atomic species in a number of appropriate submolecular environments (e.g. functional groups). Force fields that are applicable to the methods of the present invention include, but are not limited to, MARTINI, VAMM, ReaxFF, EVB, RWFF, COSMOS-NMR, GEM, NEMO, ORIENT, AMOEBA, SIBFA, CHARMM, AMBER, CPE, PFF, PIPF, DRF90, CFF/ind, ENZYMIX, X-Pol, QVBMM, MM2, MM3, MM4, MMFF, CFF, UFF, QCFF/PI, ECEPP/2, OPLS, GROMOS, GROMACS, and CVFF.

In some embodiments of the present invention, proximal sequence elements are determined computationally. Typically, the distance of a sequence element from a complexed ligand is a variable usually measured from the ligand-binding site on the target or off-target that encompasses those residues of the target with a significant contribution to discriminate relative affinities of ligands.

In some embodiments of the present invention, the statistical models generated by the methods and systems of the present invention are products of heuristic-based multivariate analysis, for example, PLS, neural networks, and support vector machines.

In some embodiments, the statistical models produced by the methods and systems of the present invention may be predictive of those sequence elements of the targets and off-targets most likely to contribute to any differences that exist in the activity data. As discussed above, an r² value of 0.6 is typically considered substantially significant, though higher levels of correlation, such as, for example, r² values of 0.65, 0.70, 0.75, 0.80, 0.85, 0.90, 0.95, 1.0, and all ranges in between are possible and within the scope of the present disclosure. In some embodiments of the present invention, those ligand-target and ligand-off-target pairs listed in the database may show variability in activity data between them. Then, for example, the predictive methods, models and systems of the present invention may suggest, on a residue-by-residue basis, if a functionally-aligned sequence element is more or less likely to contribute to the variability seen in the activity data.

Thus, in accordance with some embodiments, one of skill in the art would be enabled to select or rationally design an effector molecule that would be predicted, by the methods, models, and systems of the present invention, to have a desired specificity for a target molecule. As discussed above, in some embodiments, the desired specificity may be that seen for a highly specific ligand or it may be that seen for a non-specific ligand (i.e. one with substantially equal specificity for multiple targets). In the former example, one may select or design a ligand that would maximize interactions with those sequence elements predicted to be associated with the desired (i.e. high) level of activity in the target molecule(s) and/or the desired (i.e. low) level of activity in the off-target molecules. Likewise, interactions associated with, for example, low activity in the target molecule and high activity in the off-targets would be minimized. Thus, in some embodiments, an effector would be selected that is likely, based upon the generated statistical model(s), to have specificity for the target molecule that exceeds the specificity of the effector for off-target molecules In the latter example, one may select or design a ligand that would maximize interactions with those sequence elements predicted to not be associated with significant differences in activity data and/or minimize interactions with those sequence elements predicted to be associated with significant differences in activity data. In some embodiments of the present invention, this type of approach may result in effectors selected or designed to have specificity for multiple target molecules. Thus, in some embodiments, an effector would be selected that is likely, based upon the generated statistical model(s), to have specificity for the target molecule that does not exceed the specificity of the effector for off-targets.

In some embodiments, the methods and systems of the present invention may involve experimentally determining the activity data associated with the selected effector in complex with targets and off-targets. Experimental protocols for determining various forms of activity data are extensive and include, but are not limited to, in vitro binding assays executed by any of a number of techniques (including, but not limited to, enzyme inhibition, isothermal titration calorimetry, fluorescence polarization, and radioisotope-labeled binding), in vitro cell-based assays, isolated tissue bioassays (i.e. electrophysiological assays and tissue contractility assays, for example), and whole animal measurements (blood pressure, respiration, heart rate, metabolism, behavioral measurements, and nocioceptive measurements, for example).

In some embodiments, the methods and systems of the present invention may be used iteratively. Experimentally determined activity data from the selected effector in complex with targets and off-targets may be incorporated into the database and the steps of the method repeated. It is not essential that the step concerning establishing structure-based equivalence of the sequence elements be repeated unless new (i.e. not in the database in the previous iteration) targets or off-targets are added to the database in subsequent iterations of the methods. In the event that new targets or off-targets are added to the database, structure-based equivalence may need to be reestablished. Theoretically, with each iteration of the methods of the present invention, the predictive power of the models of the present invention may improve. Thus, the iterative nature of the invention may allow for higher quality predictions as the database becomes larger (i.e. with the addition of new targets and off-targets) and more complete (i.e. with less gaps in the activity data for various complexes). In some embodiments of the present invention, new targets/off-targets and new ligands may be added to the database in subsequent iterations, along with any corresponding activity data. In some embodiments of the present invention, the iterative nature of the methods allows for the use of incomplete databases. For example, if one were attempting to determine a specific inhibitor of HDAC-1 over other HDACs, the database would not need to initially include data for each population ligand in complex with each HDAC. With each iteration of the methods of the present invention, blanks in the ligand-target and ligand-off-target database may be filled in. As previously noted, in one embodiment, the method of the present invention comprises at least two, at least three, at least five, at least ten or even more iterations.

In some embodiments of the present invention, the target molecules constitute enzymes that are known therapeutic targets. An exemplary enzyme useful in the implementation of the present invention is HIV-1 RT. HIV-1 RT continues to be of therapeutic interest in the ongoing effort to provide HIV/AIDS therapeutics that have improved efficacy against drug-resistant mutants of the HIV virus that continue to evolve post-infection.

In some embodiments of the present invention, the target molecules constitute G-protein coupled receptors (GPCRs). GPCRs are one of the most common means of cellular signal transduction and a historically important class of therapeutic targets (Lundstrom, K., et al., 2009). In particular, multiple subtypes of GPCRs are common targets for therapeutics and selectivity of ligands for a given subtype is a common priority (such as, for example, the multiple members of the opioid GPCR family).

In some embodiments of the present invention, the target molecules constitute tyrosine kinases. Over 500 different tyrosine kinases are expressed as another dominant means of cellular signal transduction associated with disease. In this example, once again, discrimination of a ligand for a particular kind or kinds of tyrosine kinase is an important objective.

In some embodiments of the present invention, the target molecules constitute ribosomes. Many classes of antibiotics target ribosomes of microbial pathogens. Unfortunately, many of the most potent show toxic side effects due to their affinity for the ribosomes of eukaryotes. Enhanced selectivity of structurally modified antibiotics for the ribosomes of microbial pathogens versus human ribosomes may provide novel therapeutics against drug-resistant microbes, such as Methicillin-resistant Staphylococcus aureus (MRSA).

In some embodiments, the methods, models, and systems of the present invention can also be used to design transcription factor sequences for recognition of specific DNA initiation sites. Control of gene expression is an emerging therapeutics area. The ability to selectively target a particular initiation site and either stimulate or eliminate gene expression is a desirable therapeutic objective that may be achieved through the use of the present invention.

In some embodiments of the present invention, the ligands constitute antibodies and the target molecules are antigens. For example, humanized antibodies are currently one of the most effective therapeutics in the clinic due to their ability to target diseased cells. Given an antigenic target on a cell such as, for example, epidermal growth factor receptor 2 (EGFR2), one would be able to modify the antibody sequence to enhance the affinity and selectivity for EGFR2, which is overexpressed in many breast cancers.

In some embodiments of the present invention, the ligands constitute DNA aptamers. While random selection of DNA sequences to generate selective aptamers for a given application is effective, the use of the methods, models, and systems of the present invention to further iteratively refine the selectivity for a particular molecular target is envisaged.

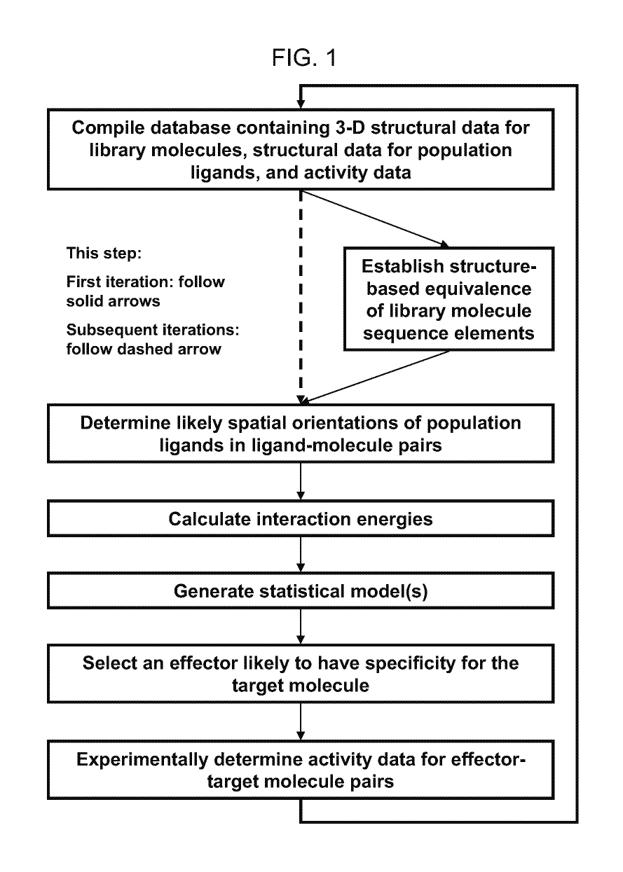

It is to be understood that there is no basis for a limitation of the methods, models, and systems of the present invention to a particular class of targets, such as proteins or nucleic acids. This focus only reflects the large amount of structural information available on these therapeutic targets at the time the invention was reduced to practice. Thus, FIG. 1 shows a flowchart depicting the general steps of the methods of the present invention.

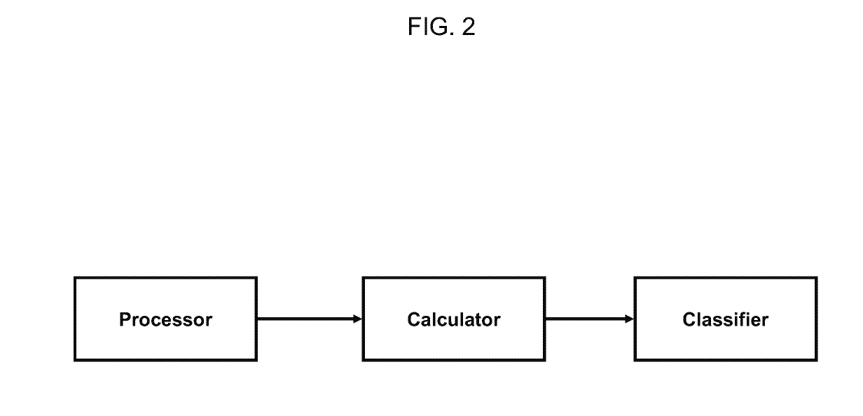

In some embodiments, the methods of the present invention are performed on the system depicted in FIG. 2.

In some embodiments, the methods of the present invention are as described in one or more of the following enumerated embodiments.

### Embodiment 1

A computational method for selecting an effector having specificity for a target molecule, the method comprising:
a. compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set;
b. establishing structure-based equivalence of the sequence elements and labeling the sequence elements of different molecule library members to reflect said equivalence;
c. determining likely spatial orientations of the ligand population members in the ligand-molecule pairs for which the database comprises activity data;
d. calculating, for the ligand-molecule pairs for which the database comprises activity data, interaction energies of the ligand population member with proximal sequence elements of the molecule library member of the respective ligand-molecule pairs when the ligand population member is in a determined likely spatial orientation;
e. generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data;
f. selecting an effector that is likely, based upon the generated statistical model(s), to have specificity for the target molecule that exceeds the specificity of the effector for other molecule library member(s);
g. experimentally determining activity data quantifying an effect of the selected effector upon the activity of one or more molecule library members; and,
h. at least once, repeating steps (a) and (c) through (g) wherein in a later iteration of steps (a) and (c) through (g) the effector selected in step (f) of an earlier iteration of steps (c) through (g) is a member of the population of ligands.

### Embodiment 2

The method of claim 1, wherein the effector is an inhibitor of the target molecule.

### Embodiment 3

The method of embodiment 1, wherein the effector is an activator of the target molecule.

### Embodiment 4

The method of embodiment 1, wherein the target molecule is a peptide.

### Embodiment 5

The method of embodiment 4, wherein the peptide is a ribosomal peptide.

### Embodiment 6

The method of embodiment 4, wherein the peptide is an enzyme.

### Embodiment 7

The method of embodiment 6, wherein the enzyme is a HIV reverse transcriptase.

### Embodiment 8

The method of embodiment 6, wherein the enzyme catalyzes epigenetic modifications.

### Embodiment 9

The method of embodiment 8, wherein the enzyme that catalyzes epigenetic modifications is a DNA methylation enzyme.

### Embodiment 10

The method of embodiment 8, wherein the enzyme that catalyzes epigenetic modifications is a DNA demethylation enzyme.

### Embodiment 11

The method of embodiment 8, wherein the enzyme that catalyzes epigenetic modifications is a protein methylation enzyme.

### Embodiment 12

The method of embodiment 8, wherein the enzyme that catalyzes epigenetic modifications is a protein demethylation enzyme.

### Embodiment 13

The method of embodiment 8, wherein the enzyme that catalyzes epigenetic modifications is an acetyl transferase.

### Embodiment 14

The method of embodiment 13, wherein the acetyl transferase is a lysine acetyl transferase (KAT).

### Embodiment 15

The method of embodiment 8, wherein the enzyme that catalyzes epigenetic modifications is a deacetylase.

### Embodiment 16

The method of embodiment 15, wherein the deacetylase is a zinc-based lysine deacetylase (KDAC).

### Embodiment 17

The method of embodiment 16, wherein the zinc-based lysine deacetylase is a histone deacetylase (HDAC).

### Embodiment 18

The method of embodiment 15, wherein the deacetylase is a NAD-based lysine deacetylase.

### Embodiment 19

The method of embodiment 1, wherein the target molecule is a nucleic acid.

### Embodiment 20

The method of embodiment 19, wherein the nucleic acid is a ribonucleic acid.

### Embodiment 21

The method of embodiment 20, wherein the ribonucleic acid is a ribozyme.

### Embodiment 22

The method of embodiment 19, wherein the nucleic acid is a deoxyribonucleic acid.

### Embodiment 23

The method of embodiment 22, wherein the deoxyribonucleic acid comprises a protein binding site.

### Embodiment 24

The method of embodiment 23, wherein the protein binding site comprises a promoter.

### Embodiment 25

The method of embodiment 23, wherein the protein binding site comprises a transcription factor binding site.

### Embodiment 26

The method of embodiment 23, wherein the protein binding site is an enhancer binding site.

### Embodiment 27

The method of embodiment 22, wherein the deoxyribonucleic acid comprises an aptamer.

### Embodiment 28

The method of embodiment 1, wherein the population of ligands comprises antibodies.

### Embodiment 29

The method of embodiment 4, wherein the peptide is a G-protein coupled receptor.

### Embodiment 30

The method of embodiment 4, wherein the peptide is a tyrosine kinase.

### Embodiment 31

The method of embodiment 1, wherein the database does not contain activity data for all ligand-molecule pairs.

### Embodiment 32

The method of embodiment 1, wherein structure-based equivalence is established using X-ray crystallography data.

### Embodiment 33

The method of embodiment 1, wherein structure-based equivalence is established using nuclear magnetic resonance spectroscopy data.

### Embodiment 34

The method of embodiment 1, wherein structure-based equivalence is established using cryo-electron microscopy data.

### Embodiment 35

The method of embodiment 1, wherein structure-based equivalence is established using homology modeling.

### Embodiment 36

The method of embodiment 1, wherein likely spatial orientations of the ligand population members in the ligand-molecule pairs for which the database comprises activity data are determined computationally.

### Embodiment 37

The method of embodiment 1, wherein likely spatial orientations of the ligand population members in the ligand-molecule pairs for which the database comprises activity data are determined experimentally.

### Embodiment 38

The method of embodiment 1, wherein the at least one statistical model is generated from a partial least squares analysis.

### Embodiment 39

The method of embodiment 1, wherein the at least one statistical model is generated from a neural network.

### Embodiment 40

The method of embodiment 1, wherein the at least one statistical model is generated from a support vector machine.

### Embodiment 41

The method of embodiment 1, wherein an effector is selected that is likely, based upon the generated statistical model(s), to have specificity for the target molecule that does not exceed the specificity of the effector for other molecule library member(s).

### Embodiment 42

A method as in any one of the preceding embodiments, wherein the effector is selected to have specificity for multiple target molecules.

### Embodiment 43

A system for selecting an effector having specificity for a target molecule, comprising: means for compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set; means for establishing structure-based equivalence of the sequence elements and labeling the sequence elements of different molecule library members to reflect said equivalence; means for determining likely spatial orientations of the ligand population members in the ligand-molecule pairs for which the database comprises activity data; means for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; means for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data; means for selecting an effector that is likely, based upon the generated statistical model(s), to have specificity for the target molecule that exceeds the specificity of the effector for other molecule library member(s); means for experimentally determining activity data quantifying an effect of the selected effector upon the activity of one or more molecule library members; and, means for at least once, repeating steps (a) and (c) through (g) wherein in a later iteration of steps (a) and (c) through (g) the effector selected in step (f) of an earlier iteration of steps (c) through (g) is a member of the population of ligands.

### Embodiment 44

The system of embodiment 43, wherein the effector is an inhibitor of the target molecule.

### Embodiment 45

The system of embodiment 43, wherein the effector is an activator of the target molecule.

### Embodiment 46

The system of embodiment 43, wherein the target molecule is a peptide.

### Embodiment 47

The system of embodiment 46, wherein the peptide is a ribosomal peptide.

### Embodiment 48

The system of embodiment 46, wherein the peptide is an enzyme.

### Embodiment 49

The system of embodiment 48, wherein the enzyme is a HIV reverse transcriptase.

### Embodiment 50

The system of embodiment 48, wherein the enzyme catalyzes epigenetic modifications.

### Embodiment 51

The system of embodiment 50, wherein the enzyme that catalyzes epigenetic modifications is a DNA methylation enzyme.

### Embodiment 52

The system of embodiment 50, wherein the enzyme that catalyzes epigenetic modifications is a DNA demethylation enzyme.

### Embodiment 53

The system of embodiment 50, wherein the enzyme that catalyzes epigenetic modifications is a protein methylation enzyme.

### Embodiment 54

The system of embodiment 50, wherein the enzyme that catalyzes epigenetic modifications is a protein demethylation enzyme.

### Embodiment 55

The system of embodiment 50, wherein the enzyme that catalyzes epigenetic modifications is an acetyl transferase.

### Embodiment 56

The system of embodiment 55, wherein the acetyl transferase is a lysine acetyl transferase (KAT).

### Embodiment 57

The system of embodiment 50, wherein the enzyme that catalyzes epigenetic modifications is a deacetylase.

### Embodiment 58

The system of embodiment 57, wherein the deacetylase is a zinc-based lysine deacetylase (KDAC).

### Embodiment 59

The system of embodiment 58, wherein the zinc-based lysine deacetylase is a histone deacetylase (HDAC).

### Embodiment 60

The system of embodiment 57, wherein the deacetylase is a NAD-based lysine deacetylase.

### Embodiment 61

The system of embodiment 43, wherein the target molecule is a nucleic acid.

### Embodiment 62

The system of embodiment 61, wherein the nucleic acid is a ribonucleic acid.

### Embodiment 63

The system of embodiment 62, wherein the ribonucleic acid is a ribozyme.

### Embodiment 64

The system of embodiment 61, wherein the nucleic acid is a deoxyribonucleic acid.

### Embodiment 65

The system of embodiment 64, wherein the deoxyribonucleic acid comprises a protein binding site.

### Embodiment 66

The system of embodiment 65, wherein the protein binding site comprises a promoter.

### Embodiment 67

The system of embodiment 65, wherein the protein binding site comprises a transcription factor binding site.

### Embodiment 68

The system of embodiment 65, wherein the protein binding site is an enhancer binding site.

### Embodiment 69

The system of embodiment 64, wherein the deoxyribonucleic acid comprises an aptamer.

### Embodiment 70

The system of embodiment 43, wherein the population of ligands comprises antibodies.

### Embodiment 71

The system of embodiment 46, wherein the peptide is a G-protein coupled receptor.

### Embodiment 72

The system of embodiment 46, wherein the peptide is a tyrosine kinase.

### Embodiment 73

The system of embodiment 43, wherein the database does not contain activity data for all ligand-molecule pairs.

### Embodiment 74

The system of embodiment 43, wherein structure-based equivalence is established using X-ray crystallography data.

### Embodiment 75

The system of embodiment 43, wherein structure-based equivalence is established using nuclear magnetic resonance spectroscopy data.

### Embodiment 76

The system of embodiment 43, wherein structure-based equivalence is established using cryo-electron microscopy data.

### Embodiment 77

The system of embodiment 43, wherein structure-based equivalence is established using homology modeling.

### Embodiment 78

The system of embodiment 43, wherein likely spatial orientations of the ligand population members in the ligand-molecule pairs for which the database comprises activity data are determined computationally.

### Embodiment 79

The system of embodiment 43, wherein likely spatial orientations of the ligand population members in the ligand-molecule pairs for which the database comprises activity data are determined experimentally.

### Embodiment 80

The system of embodiment 43, wherein the at least one statistical model is generated from a partial least squares analysis.

### Embodiment 81

The system of embodiment 43, wherein the at least one statistical model is generated from a neural network.

### Embodiment 82

The system of embodiment 43, wherein the at least one statistical model is generated from a support vector machine.

### Embodiment 83

The system of embodiment 43, wherein an effector is selected that is likely, based upon the generated statistical model(s), to have specificity for the target molecule that does not exceed the specificity of the effector for other molecule library member(s).

### Embodiment 84

The system as in one of embodiments 43-83, wherein the effector is selected to have specificity for multiple target molecules.

### Embodiment 85

A system for selecting an effector having specificity for a target molecule, comprising: a processor for compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set, establishing structure-based equivalence of the sequence elements and labeling the sequence elements of different molecule library members to reflect said equivalence, and determining likely spatial orientations of the ligand population members in the ligand-molecule pairs for which the database comprises activity data; a calculator for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; and, a classifier for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data.

### Embodiment 86

The system of embodiment 85, wherein the effector is an inhibitor of the target molecule.

### Embodiment 87

The system of embodiment 85, wherein the effector is an activator of the target molecule.

### Embodiment 88

The system of embodiment 85, wherein the target molecule is a peptide.

### Embodiment 89

The system of embodiment 88, wherein the peptide is a ribosomal peptide.

### Embodiment 90

The system of embodiment 88, wherein the peptide is an enzyme.

### Embodiment 91

The system of embodiment 90, wherein the enzyme is a HIV reverse transcriptase.

### Embodiment 92

The system of embodiment 90, wherein the enzyme catalyzes epigenetic modifications.

### Embodiment 93

The system of embodiment 92, wherein the enzyme that catalyzes epigenetic modifications is a DNA methylation enzyme.

### Embodiment 94

The system of embodiment 92, wherein the enzyme that catalyzes epigenetic modifications is a DNA demethylation enzyme.

### Embodiment 95

The system of embodiment 92, wherein the enzyme that catalyzes epigenetic modifications is a protein methylation enzyme.

### Embodiment 96

The system of embodiment 92, wherein the enzyme that catalyzes epigenetic modifications is a protein demethylation enzyme.

### Embodiment 97

The system of embodiment 92, wherein the enzyme that catalyzes epigenetic modifications is an acetyl transferase.

### Embodiment 98

The system of embodiment 97, wherein the acetyl transferase is a lysine acetyl transferase (KAT).

### Embodiment 99

The system of embodiment 92, wherein the enzyme that catalyzes epigenetic modifications is a deacetylase.

### Embodiment 100

The system of embodiment 99, wherein the deacetylase is a zinc-based lysine deacetylase (KDAC).

### Embodiment 101

The system of embodiment 100, wherein the zinc-based lysine deacetylase is a histone deacetylase (HDAC).

### Embodiment 102

The system of embodiment 99, wherein the deacetylase is a NAD-based lysine deacetylase.

### Embodiment 103

The system of embodiment 85, wherein the target molecule is a nucleic acid.

### Embodiment 104

The system of embodiment 103, wherein the nucleic acid is a ribonucleic acid.

### Embodiment 105

The system of embodiment 104, wherein the ribonucleic acid is a ribozyme.

### Embodiment 106

The system of embodiment 103, wherein the nucleic acid is a deoxyribonucleic acid.

### Embodiment 107

The system of embodiment 106, wherein the deoxyribonucleic acid comprises a protein binding site.

### Embodiment 108

The system of embodiment 107, wherein the protein binding site comprises a promoter.

### Embodiment 109

The system of embodiment 107, wherein the protein binding site comprises a transcription factor binding site.

### Embodiment 110

The system of embodiment 107, wherein the protein binding site is an enhancer binding site.

### Embodiment 111

The system of embodiment 106, wherein the deoxyribonucleic acid comprises an aptamer.

### Embodiment 112

The system of embodiment 85, wherein the population of ligands comprises antibodies.

### Embodiment 113

The system of embodiment 88, wherein the peptide is a G-protein coupled receptor.

### Embodiment 114

The system of embodiment 88, wherein the peptide is a tyrosine kinase.

### Embodiment 115

The system of embodiment 85, wherein the database does not contain activity data for all ligand-molecule pairs.

### Embodiment 116

The system of embodiment 85, wherein structure-based equivalence is established using X-ray crystallography data.

### Embodiment 117

The system of embodiment 85, wherein structure-based equivalence is established using nuclear magnetic resonance spectroscopy data.

### Embodiment 118

The system of embodiment 85, wherein structure-based equivalence is established using cryo-electron microscopy data.

### Embodiment 119

The system of embodiment 85, wherein structure-based equivalence is established using homology modeling.

### Embodiment 120

The system of embodiment 85, wherein likely spatial orientations of the ligand population members in the ligand-molecule pairs for which the database comprises activity data are determined computationally.

### Embodiment 121

The system of embodiment 85, wherein likely spatial orientations of the ligand population members in the ligand-molecule pairs for which the database comprises activity data are determined experimentally.

### Embodiment 122

The system of embodiment 85, wherein the at least one statistical model is generated from a partial least squares analysis.

### Embodiment 123

The system of embodiment 85, wherein the at least one statistical model is generated from a neural network.

### Embodiment 124

The system of embodiment 85, wherein the at least one statistical model is generated from a support vector machine.

### Embodiment 125

The system of embodiment 85, wherein an effector is selected that is likely, based upon the generated statistical model(s), to have specificity for the target molecule that does not exceed the specificity of the effector for other molecule library member(s).

### Embodiment 126

The system as in one of embodiments 85-125, wherein the effector is selected to have specificity for multiple target molecules.

### Embodiment 127

A computational method for selecting an effector having specificity for a target molecule, the method comprising:
a. compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set;
b. determining likely spatial orientations of the ligand population members in the ligand-molecule pairs for which the database comprises activity data;
c. establishing equivalence of the sequence elements based on determined likely spatial orientations of the ligand population members in the ligand-molecule pairs for which the data comprises activity data and labeling the sequence elements of different molecule library members to reflect said equivalence;
d. calculating, for the ligand-molecule pairs for which the database comprises activity data, interaction energies of the ligand population member with proximal sequence elements of the molecule library member of the respective ligand-molecule pairs when the ligand population member is in a determined likely spatial orientation;
e. generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data;
f. selecting an effector that is likely, based upon the generated statistical model(s), to have specificity for the target molecule that exceeds the specificity of the effector for other molecule library member(s);
g. experimentally determining activity data quantifying an effect of the selected effector upon the activity of one or more molecule library members; and,
h. at least once, repeating steps (a) through (g) wherein in a later iteration of steps (a) through (g) the effector selected in step (f) of an earlier iteration of steps (a) through (g) is a member of the population of ligands.

### Embodiment 128

The method of embodiment 127, wherein the effector is an inhibitor of the target molecule.

### Embodiment 129

The method of embodiment 127, wherein the effector is an activator of the target molecule.

### Embodiment 130

The method of embodiment 127, wherein the target molecule is a peptide.

### Embodiment 131

The method of embodiment 130, wherein the peptide is a ribosomal peptide.

### Embodiment 132

The method of embodiment 130, wherein the peptide is an enzyme.

### Embodiment 133

The method of embodiment 132, wherein the enzyme is a HIV reverse transcriptase.

### Embodiment 134

The method of embodiment 132, wherein the enzyme catalyzes epigenetic modifications.

### Embodiment 135

The method of embodiment 134, wherein the enzyme that catalyzes epigenetic modifications is a DNA methylation enzyme.

### Embodiment 136

The method of embodiment 134, wherein the enzyme that catalyzes epigenetic modifications is a DNA demethylation enzyme.

### Embodiment 137

The method of embodiment 134, wherein the enzyme that catalyzes epigenetic modifications is a protein methylation enzyme.

### Embodiment 138

The method of embodiment 134, wherein the enzyme that catalyzes epigenetic modifications is a protein demethylation enzyme.

### Embodiment 139

The method of embodiment 134, wherein the enzyme that catalyzes epigenetic modifications is an acetyl transferase.

### Embodiment 140

The method of embodiment 139, wherein the acetyl transferase is a lysine acetyl transferase (KAT).

### Embodiment 141

The method of embodiment 134, wherein the enzyme that catalyzes epigenetic modifications is a deacetylase.

### Embodiment 142

The method of embodiment 141, wherein the deacetylase is a zinc-based lysine deacetylase (KDAC).

### Embodiment 143

The method of embodiment 142, wherein the zinc-based lysine deacetylase is a histone deacetylase (HDAC).

### Embodiment 144

The method of embodiment 141, wherein the deacetylase is a NAD-based lysine deacetylase.

### Embodiment 145

The method of embodiment 127, wherein the target molecule is a nucleic acid.

### Embodiment 146

The method of embodiment 145, wherein the nucleic acid is a ribonucleic acid.

### Embodiment 147

The method of embodiment 146, wherein the ribonucleic acid is a ribozyme.

### Embodiment 148

The method of embodiment 145, wherein the nucleic acid is a deoxyribonucleic acid.

### Embodiment 149

The method of embodiment 148, wherein the deoxyribonucleic acid comprises a protein binding site.

### Embodiment 150

The method of embodiment 149, wherein the protein binding site comprises a promoter.

### Embodiment 151

The method of embodiment 149, wherein the protein binding site comprises a transcription factor binding site.

### Embodiment 152

The method of embodiment 149, wherein the protein binding site is an enhancer binding site.

### Embodiment 153

The method of embodiment 148, wherein the deoxyribonucleic acid comprises an aptamer.

### Embodiment 154

The method of embodiment 127, wherein the population of ligands comprises antibodies.

### Embodiment 155

The method of embodiment 130, wherein the peptide is a G-protein coupled receptor.

### Embodiment 156

The method of embodiment 130, wherein the peptide is a tyrosine kinase.

### Embodiment 157

The method of embodiment 127, wherein the database does not contain activity data for all ligand-molecule pairs.

### Embodiment 158

The method of embodiment 127, wherein structure-based equivalence is established using X-ray crystallography data.

### Embodiment 159

The method of embodiment 127, wherein structure-based equivalence is established using nuclear magnetic resonance spectroscopy data.

### Embodiment 160

The method of embodiment 127, wherein structure-based equivalence is established using cryo-electron microscopy data.

### Embodiment 161

The method of embodiment 127, wherein structure-based equivalence is established using homology modeling.

### Embodiment 162

The method of embodiment 127, wherein likely spatial orientations of the ligand population members in the ligand-molecule pairs for which the database comprises activity data are determined computationally.

### Embodiment 163

The method of embodiment 127, wherein likely spatial orientations of the ligand population members in the ligand-molecule pairs for which the database comprises activity data are determined experimentally.

### Embodiment 164

The method of embodiment 127, wherein the at least one statistical model is generated from a partial least squares analysis.

### Embodiment 165

The method of embodiment 127, wherein the at least one statistical model is generated from a neural network.

### Embodiment 166

The method of embodiment 127, wherein the at least one statistical model is generated from a support vector machine.

### Embodiment 167

The method of embodiment 127, wherein an effector is selected that is likely, based upon the generated statistical model(s), to have specificity for the target molecule that does not exceed the specificity of the effector for other molecule library member(s).

### Embodiment 168

A method as in one of embodiments 127-167, wherein the effector is selected to have specificity for multiple target molecules.

### Embodiment 169

A system for selecting an effector having specificity for a target molecule, comprising: means for compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set; means for determining likely spatial orientations of the ligand population members in the ligand-molecule pairs for which the database comprises activity data; means for establishing equivalence of the sequence elements based on determined likely spatial orientations of the ligand population members in the ligand-molecule pairs for which the data comprises activity data and labeling the sequence elements of different molecule library members to reflect said equivalence; means for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; means for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data; means for selecting an effector that is likely, based upon the generated statistical model(s), to have specificity for the target molecule that exceeds the specificity of the effector for other molecule library member(s); means for experimentally determining activity data quantifying an effect of the selected effector upon the activity of one or more molecule library members; and, means for at least once, repeating steps (a) through (g) wherein in a later iteration of steps (a) through (g) the effector selected in step (f) of an earlier iteration of steps (a) through (g) is a member of the population of ligands.

### Embodiment 170

The system of embodiment 169, wherein the effector is an inhibitor of the target molecule.

### Embodiment 171

The system of embodiment 169, wherein the effector is an activator of the target molecule.

### Embodiment 172

The system of embodiment 169, wherein the target molecule is a peptide.

### Embodiment 173

The system of embodiment 172, wherein the peptide is a ribosomal peptide.

### Embodiment 174

The system of embodiment 172, wherein the peptide is an enzyme.

### Embodiment 175

The system of embodiment 174, wherein the enzyme is a HIV reverse transcriptase.

### Embodiment 176

The system of embodiment 174, wherein the enzyme catalyzes epigenetic modifications.

### Embodiment 177

The system of embodiment 176, wherein the enzyme that catalyzes epigenetic modifications is a DNA methylation enzyme.

### Embodiment 178

The system of embodiment 176, wherein the enzyme that catalyzes epigenetic modifications is a DNA demethylation enzyme.

### Embodiment 179

The system of embodiment 176, wherein the enzyme that catalyzes epigenetic modifications is a protein methylation enzyme.

### Embodiment 180

The system of embodiment 176, wherein the enzyme that catalyzes epigenetic modifications is a protein demethylation enzyme.

### Embodiment 181

The system of embodiment 176, wherein the enzyme that catalyzes epigenetic modifications is an acetyl transferase.

### Embodiment 182

The system of embodiment 181, wherein the acetyl transferase is a lysine acetyl transferase (KAT).

### Embodiment 183

The system of embodiment 176, wherein the enzyme that catalyzes epigenetic modifications is a deacetylase.

### Embodiment 184

The system of embodiment 183, wherein the deacetylase is a zinc-based lysine deacetylase (KDAC).

### Embodiment 185

The system of embodiment 184, wherein the zinc-based lysine deacetylase is a histone deacetylase (HDAC).

### Embodiment 186

The system of embodiment 183, wherein the deacetylase is a NAD-based lysine deacetylase.

### Embodiment 187

The system of embodiment 169, wherein the target molecule is a nucleic acid.

### Embodiment 188

The system of embodiment 187, wherein the nucleic acid is a ribonucleic acid.

### Embodiment 189

The system of embodiment 188, wherein the ribonucleic acid is a ribozyme.

### Embodiment 190

The system of embodiment 187, wherein the nucleic acid is a deoxyribonucleic acid.

### Embodiment 191

The system of embodiment 190, wherein the deoxyribonucleic acid comprises a protein binding site.

### Embodiment 192

The system of embodiment 191, wherein the protein binding site comprises a promoter.

### Embodiment 193

The system of embodiment 191, wherein the protein binding site comprises a transcription factor binding site.

### Embodiment 194

The system of embodiment 191, wherein the protein binding site is an enhancer binding site.

### Embodiment 195

The system of embodiment 190, wherein the deoxyribonucleic acid comprises an aptamer.

### Embodiment 196

The system of embodiment 169, wherein the population of ligands comprises antibodies.

### Embodiment 197

The system of embodiment 172, wherein the peptide is a G-protein coupled receptor.

### Embodiment 198

The system of embodiment 172, wherein the peptide is a tyrosine kinase.

### Embodiment 199

The system of embodiment 169, wherein the database does not contain activity data for all ligand-molecule pairs.

### Embodiment 200

The system of embodiment 169, wherein structure-based equivalence is established using X-ray crystallography data.

### Embodiment 201

The system of embodiment 169, wherein structure-based equivalence is established using nuclear magnetic resonance spectroscopy data.

### Embodiment 202

The system of embodiment 169, wherein structure-based equivalence is established using cryo-electron microscopy data.

### Embodiment 203

The system of embodiment 169, wherein structure-based equivalence is established using homology modeling.

### Embodiment 204

The system of embodiment 169, wherein likely spatial orientations of the ligand population members in the ligand-molecule pairs for which the database comprises activity data are determined computationally.

### Embodiment 205

The system of embodiment 169, wherein likely spatial orientations of the ligand population members in the ligand-molecule pairs for which the database comprises activity data are determined experimentally.

### Embodiment 206

The system of embodiment 169, wherein the at least one statistical model is generated from a partial least squares analysis.

### Embodiment 207

The system of embodiment 169, wherein the at least one statistical model is generated from a neural network.

### Embodiment 208

The system of embodiment 169, wherein the at least one statistical model is generated from a support vector machine.

### Embodiment 209

The system of embodiment 169, wherein an effector is selected that is likely, based upon the generated statistical model(s), to have specificity for the target molecule that does not exceed the specificity of the effector for other molecule library member(s).

### Embodiment 210

A system as in one of embodiments 169-209, wherein the effector is selected to have specificity for multiple target molecules.

### Embodiment 211

A system for selecting an effector having specificity for a target molecule, comprising: a processor for compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set, determining likely spatial orientations of the ligand population members in the ligand-molecule pairs for which the database comprises activity data, and establishing equivalence of the sequence elements based on determined likely spatial orientations of the ligand population members in the ligand-molecule pairs for which the data comprises activity data and labeling the sequence elements of different molecule library members to reflect said equivalence; a calculator for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; and a classifer for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data.

### Embodiment 212

The system of embodiment 211, wherein the effector is an inhibitor of the target molecule.

### Embodiment 213

The system of embodiment 211, wherein the effector is an activator of the target molecule.

### Embodiment 214

The system of embodiment 211, wherein the target molecule is a peptide.

### Embodiment 215

The system of embodiment 214, wherein the peptide is a ribosomal peptide.

### Embodiment 216

The system of embodiment 214, wherein the peptide is an enzyme.

### Embodiment 217

The system of embodiment 216, wherein the enzyme is a HIV reverse transcriptase.

### Embodiment 218

The system of embodiment 216, wherein the enzyme catalyzes epigenetic modifications.

### Embodiment 219

The system of embodiment 218, wherein the enzyme that catalyzes epigenetic modifications is a DNA methylation enzyme.

### Embodiment 220

The system of embodiment 218, wherein the enzyme that catalyzes epigenetic modifications is a DNA demethylation enzyme.

### Embodiment 221

The system of embodiment 218, wherein the enzyme that catalyzes epigenetic modifications is a protein methylation enzyme.

### Embodiment 222

The system of embodiment 218, wherein the enzyme that catalyzes epigenetic modifications is a protein demethylation enzyme.

### Embodiment 223

The system of embodiment 218, wherein the enzyme that catalyzes epigenetic modifications is an acetyl transferase.

### Embodiment 224

The system of embodiment 223, wherein the acetyl transferase is a lysine acetyl transferase (KAT).

### Embodiment 225

The system of embodiment 218, wherein the enzyme that catalyzes epigenetic modifications is a deacetylase.

### Embodiment 226

The system of embodiment 225, wherein the deacetylase is a zinc-based lysine deacetylase (KDAC).

### Embodiment 227

The system of embodiment 226, wherein the zinc-based lysine deacetylase is a histone deacetylase (HDAC).

### Embodiment 228

The system of embodiment 225, wherein the deacetylase is a NAD-based lysine deacetylase.

### Embodiment 229

The system of embodiment 211, wherein the target molecule is a nucleic acid.

### Embodiment 230

The system of embodiment 229, wherein the nucleic acid is a ribonucleic acid.

### Embodiment 231

The system of embodiment 230, wherein the ribonucleic acid is a ribozyme.

### Embodiment 232

The system of embodiment 229, wherein the nucleic acid is a deoxyribonucleic acid.

### Embodiment 233

The system of embodiment 232, wherein the deoxyribonucleic acid comprises a protein binding site.

### Embodiment 234

The system of embodiment 233, wherein the protein binding site comprises a promoter.

### Embodiment 235

The system of embodiment 233, wherein the protein binding site comprises a transcription factor binding site.

### Embodiment 236

The system of embodiment 233, wherein the protein binding site is an enhancer binding site.

### Embodiment 237

The system of embodiment 232, wherein the deoxyribonucleic acid comprises an aptamer.

### Embodiment 238

The system of embodiment 211, wherein the population of ligands comprises antibodies.

### Embodiment 239

The system of embodiment 214, wherein the peptide is a G-protein coupled receptor.

### Embodiment 240

The system of embodiment 214, wherein the peptide is a tyrosine kinase.

### Embodiment 241

The system of embodiment 211, wherein the database does not contain activity data for all ligand-molecule pairs.

### Embodiment 242

The system of embodiment 211, wherein structure-based equivalence is established using X-ray crystallography data.

### Embodiment 243

The system of embodiment 211, wherein structure-based equivalence is established using nuclear magnetic resonance spectroscopy data.

### Embodiment 244

The system of embodiment 211, wherein structure-based equivalence is established using cryo-electron microscopy data.

### Embodiment 245

The system of embodiment 211, wherein structure-based equivalence is established using homology modeling.

### Embodiment 246

The system of embodiment 211, wherein likely spatial orientations of the ligand population members in the ligand-molecule pairs for which the database comprises activity data are determined computationally.

### Embodiment 247

The system of embodiment 211, wherein likely spatial orientations of the ligand population members in the ligand-molecule pairs for which the database comprises activity data are determined experimentally.

### Embodiment 248

The system of embodiment 211, wherein the at least one statistical model is generated from a partial least squares analysis.

### Embodiment 249

The system of embodiment 211, wherein the at least one statistical model is generated from a neural network.

### Embodiment 250

The system of embodiment 211, wherein the at least one statistical model is generated from a support vector machine.

### Embodiment 251

The system of embodiment 211, wherein an effector is selected that is likely, based upon the generated statistical model(s), to have specificity for the target molecule that does not exceed the specificity of the effector for other molecule library member(s).

### Embodiment 252

A system as in one of embodiments 211-251, wherein the effector is selected to have specificity for multiple target molecules.

The following examples are provided to further illustrate the methods and systems of the present invention. These examples are illustrative only and are not intended to limit the scope of the invention in any way.

### EXAMPLES

### Example 1

### Structure-Based Modeling and Isoform-Selectivity Prediction of Histone Deacetylase Inhibitors

### Materials and Methods

All molecular graphics images were produced using UCSF Chimera package (www.cgl.ucsf.edu/chimera/) from the Resource for Biocomputing, Visualization, and Informatics at the University of California, San Francisco on a 3 Ghz AMD CPU-equipped, IBM-compatible workstation using the Debian 5.0 version of the Linux operating system. For all calculations, a Beowulf cluster of 12 quadcore Xeon CPUs was used.

### Complex Preparation

Inhibitor Structures.

All ligands used were generated with Chemaxon Marvin molecular mechanics software (http://www.chemaxon.com/) and used without further optimization. The protonation and tautomer states were assigned considering a physiological pH and the more common tautomer according to basic organic chemistry and structural information reported in the corresponding ligand referenced papers.

HDAC Homology Models.

Those HDAC isoforms whose experimental structures were not available (HDAC-1, -3, -5, -6-1, -6-2, -9, -10 and -11), were built by homology modeling using 4 automated web servers:
CPHmodels-3.0 Server (Nielsen, M., et al., 2010) (http://www.cbs.dtu.dk/services/CPHmodels/),
M4T Server ver.3.0 (Fernandez-Fuentes, N., et al., 2007) (http://manaslu.aecom.yu.edu/M4T/),
SwissModel (Arnold, K., et al., 2006) (http://swissmodel.expasy.org/),
ModWeb Server (Eswar, N., et al., 2003) (http://modbase.compbio.ucsf.edu/ModWeb20-html/modweb.html).

Several protein conformations for each HDAC isoform were used to include some target flexibility in the subsequent training set and test set cross-docking runs. For each HDAC isoform, 4 homology models were generated. All inhibitors were modeled into each of the four-homology models and the resulting complexes energy minimized to supply four complexes for each inhibitor, leading to 220 complexes. The servers were used with their default parameters and in a totally automated way to avoid human intervention and to allow maximum reproducibility.

To compile the final training set of 94 complexes (see Training Set section below), one homology complex per inhibitor was chosen using the preliminary DISCRIMINATE models derived with only crystallized HDAC complexes. For each inhibitor, the HDAC/inhibitor complex whose predicted pIC₅₀s had the best fit to the experimental pIC₅₀s for that isoform was selected and utilized in the final training set (Table 1).

TABLE 1
Predicted pIC₅₀ for the modeled complexes inserted in the final training set.

| HDAC | Complex name | Homology server | pIC₅₀exp | pIC₅₀pred |
|---|---|---|---|---|
| HDAC1 | APHA8/HDAC1 | SwissModel | 5.432 | 6.13 |
| | MS-275/HDAC1 | M4T | 4.886 | 5.2 |
| | SAHA/HDAC1 | M4T | 7 | 6.69 |
| | SBHA/HDAC1 | CPH | 5.678 | 6.61 |
| | TSA/HDAC1 | CPH | 8.301 | 6.78 |
| | OXAMFLATIN/HDAC1 | ModWeb | 7.301 | 6.92 |
| | NABUT/HDAC1 | ModWeb | 3.496 | 3.7 |
| | VALPROICACID/HDAC1 | ModWeb | 3 | 3.2 |
| | SCRIPTAID/HDAC1 | ModWeb | 6.77 | 6.2 |
| HDAC3 | APHA8/HDAC3 | CPH | 6.377 | 6.8 |
| | MS-275/HDAC3 | CPH | 7.155 | 6.4 |
| | SAHA/HDAC3 | CPH | 7.699 | 6.92 |
| | SBHA/HDAC3 | SwissModel | 6.387 | 6.2 |
| | TSA/HDAC3 | SwissModel | 8.301 | 6.64 |
| | OXAMFLATIN/HDAC3 | SwissModel | 8 | 6.43 |
| | NABUT/HDAC3 | SwissModel | 4.648 | 4.34 |
| | VALPROICACID/HDAC3 | CPH | 3.646 | 3.2 |
| | SCRIPTAID/HDAC3 | SwissModel | 7.523 | 6.17 |
| HDAC5 | SAHA/HDAC5 | CPH | 6.423 | 6.6 |
| | TSA/HDAC5 | CPH | 7.796 | 6.97 |
| | NABUT/HDAC5 | ModWeb.2 | 2.699 | 4.19 |
| | VALPROICACID/HDAC5 | ModWeb.3 | 2.699 | 3.43 |
| HDAC6-1 | APHA8/HDAC6-1 | SwissModel | 7 | 6.65 |
| | MS-275/HDAC6-1 | ModWeb.1 | 4.678 | 5.32 |
| | SAHA/HDAC6-1 | SwissModel | 7.699 | 6.77 |
| | SBHA/HDAC6-1 | CPH | 7 | 6.25 |
| | TSA/HDAC6-1 | SwissModel | 8.301 | 7.62 |
| | OXAMFLATIN/HDAC6-1 | SwissModel | 7.046 | 7.68 |
| | NABUT/HDAC6-1 | M4T | 3 | 3.65 |
| | VALPROICACID/HDAC6-1 | CPH | 3 | 3.13 |
| | SCRIPTAID/HDAC6-1 | SwissModel | 8.398 | 7.63 |
| HDAC6-2 | APHA8/HDAC6-2 | CPH | 7 | 6.44 |
| | MS-275/HDAC6-2 | M4T | 4.678 | 5.68 |
| | SAHA/HDAC6-2 | CPH | 7.699 | 6.44 |
| | SBHA/HDAC6-2 | ModWeb.1 | 7 | 6.2 |
| | TSA/HDAC6-2 | M4T | 8.301 | 7.02 |
| | OXAMFLATIN/HDAC6-2 | CPH | 7.046 | 7.1 |
| | NABUT/HDAC6-2 | CPH | 3 | 4.7 |
| | VALPROICACID/HDAC6-2 | ModWeb.1 | 3 | 3.84 |
| | SCRIPTAID/HDAC6-2 | M4T | 8.398 | 7.13 |
| HDAC9 | SAHA/HDAC9 | ModWeb.1 | 6.5 | 6.7 |
| | TSA/HDAC9 | ModWeb.1 | 7.419 | 7 |
| | NABUT/HDAC9 | ModWeb.1 | 2.699 | 4.03 |
| | VALPROICACID.HDAC9 | CPH | 2.699 | 4.05 |
| HDAC10 | APHA8/HDAC10 | SwissModel | 5.377 | 6.24 |
| | MS-275/HDAC10 | ModWeb.1 | 4.939 | 5.67 |
| | SAHA/HDAC10 | ModWeb.1 | 7 | 6.96 |
| | SBHA/HDAC10 | M4T | 5.638 | 6.6 |
| | TSA/HDAC10 | CPH | 8.301 | 6.21 |
| | OXAMFLATIN/HDAC10 | CPH | 7.301 | 6.8 |
| | NABUT/HDAC10 | CPH | 3.535 | 4.1 |
| | VALPROICACID/HDAC10 | M4T | 3 | 4.25 |
| | SCRIPTAID/HDAC10 | ModWeb.2 | 6.77 | 6.23 |
| HDAC11 | SAHA/HDAC11 | ModWeb.3 | 6.441 | 6.21 |
| | TSA/HDAC11 | ModWeb.1 | 7.824 | 5.64 |

Complex Minimization.

Training set complexes were submitted to a single-point minimization using a protocol described previously. (Musmuca, I., et al., 2010) Briefly, the minimization protocol was applied as follows. (1) ANTECHAMBER with AM1-BCC charges was used to determine missing ligand parameters; (2) the tLeap module was used to solvate the complexes with water molecules in a octahedral box extending 10 \acute{Å} and to neutralize them with Na⁺ and Cl⁻ ions; (3) the structures were minimized with the Amber 2003 force field by energy minimization with the SANDER modules: 1000 steps of steepest-descent energy minimization followed by 4000 steps of conjugate-gradient energy minimization, with a non-bonded cutoff of 5 \acute{Å}. Trials for longer non-bonded cutoff values were done without substantial differences, therefore the 5 \acute{Å} was chosen for faster calculations. The Zn ion was treated as non-bonded, similarly as in several other applications where HDACs were reported.

### Discriminate

Ligand/Residues Interactions.

The calculation of the ligand/residue interactions was conducted similarly as previously reported. (Ballante, F., et al., 2012). The AutoGrid module of AutoDock was used with its default setting to compute the interaction energies between each amino-acid residue of the enzymes and an inhibitor. AutoGrid used the united-atom AMBER force field and returned an energy value combining Lennard-Jones (LJ) and hydrogen-bonding (HB) energies between a target and each atom type (probe). The electrostatic interactions were calculated using a distant-dependent Coulombic function and finally, a third score for hydrophobic interactions was also estimated. In its original use, AutoGrid calculated the interaction energies of a probe atom that was placed on a regularly spaced grid in which a molecular target (the protein) or a portion of it was buried. In this way AutoGrid returns what is called the molecular interaction field (MIF) of a given target, where at each grid point it estimates the interaction values for LJ and HB (STE), electrostatic (ELE) and desolvation (DRY), and saves them in three distinct map files. In the DISCRIMINATE approach, the target was the inhibitor in the complex and the STE, ELE and DRY interactions were calculated using a grid box centered, at each step, on each atom of the protein (the probe). To the grid is given a step size so that the whole complex was contained within it, and thus only one value was returned (the center) for each field. The interaction energy for each amino acid of the enzyme was simply obtained by summing all the values for all residue atoms. The calculations were performed in a box with dimensions of 70×128×74 \acute{Å}. This procedure allowed the decomposition of the enzyme/inhibitor interactions energies into three main contributions (fields) as follows: steric, electrostatic and hydrophobic. The default parameters for Zn in AutoGrid were used and no attempts to include intramolecular terms were done.

Statistical Analysis.

All statistical calculations were performed with R, a free software environment for statistical computing and graphics. For the final training set, seven different combinations of the fields previously calculated were tried: the single fields (STE, ELE and DRY) and the multi-field ELE+STE, ELE+DRY, STE+DRY and ELE+STE+DRY.

Partial Least Squares (PLS).

All the calculations were conducted using the PLS and cross-validation features of the PLS package described by Mevik. (Mevik, B.-H., et al., 2007). An in-house R script was compiled to import the data and carry out all calculations.

BUW.

Furthermore, in the case of multiple probes, a scaling procedure, called Block Unscaled Weights (BUW), was applied as data pretreatment. This procedure enforces the same importance to each interaction type within the model, normalizing the energy distribution of the X-variables as described by Kastenholz et al. (Kastenholz, M. A., et al., 2000). BUW coefficients are reported in Table 2.

TABLE 2
Block Unscale Weight (BUW) coefficients applied for multi probes
DISCRIMINATE models.

| | ELE BUW | STE BUW | DRY BUW |
|---|---|---|---|
| Field | coefficient | coefficient | coefficient |
| ELE + STE | 0.74 | 2.44 | — |
| ELE + DRY | 0.79 | — | 1.57 |
| STE + DRY | — | 1.38 | 0.83 |
| ELE + DRY + STE | 0.67 | 2.22 | 1.33 |

### Molecular Docking

AutoDock Settings. The AutoDockTools package was employed to generate the docking input files and to analyze the docking results. A grid box size of 57×44×53 with a spacing of 0.375 \acute{Å} between the grid points was implemented. A total of 100 runs were generated by using the genetic algorithm, while the remaining run parameters were maintained at their default setting. A cluster analysis was carried out using 2 \acute{Å} as the RMSD tolerance.

AutoDockVina Settings.

The same AutoDock grid box was used for its calculations. The docking simulations were carried out with an energy range of 10 kcal/mol and exhaustiveness of 100. The output comprised 20 different conformations for every receptor considered. Although Vina does not include any clustering of the output poses, the clustering feature of the AutoDock program was used to inspect the conformation families using a clustering tolerance set at 2 \acute{Å}.

### Computational Approach

The comparative binding energy (COMBINE) approach is a structure-based 3-D QSAR method that uses a series of receptor-ligand complexes to quantify interaction energies by molecular mechanics (Ortiz, A. R., et al., 1997, Ortiz, A. R., et al., 1995, Perez, C., et al., 1998, Lozano, J. J., et al., 2000). The fundamental idea of a COMBINE analysis is that a simple expression for the differences in binding affinity of a series of related ligand-receptor complexes can be derived by using multivariate statistics to correlate experimental data on binding affinities with per residue ligand-receptor interactions, computed from 3-D structures. The basis of the COMBINE method is the assumption that the protein-receptor binding free energy, ΔG, can be approximated by a weighted sum of n terms, ΔU, each describing the change in property u upon binding as described by the following equation:

$$Δ G = {\sum }_{i = 1}^{n} {w}_{i} Δ {u}_{i} + C$$

From this expression, biological activities may be derived by assuming that these quantities are linear functions of ΔG. The expression is derived by analyzing the interaction of a set of ligands with experimentally known binding affinities for a target receptor (Ortiz, A. R., et al., 1995).

In order to apply this approach to predict the selective inhibition of HDAC isozymes, a modified protocol, called DISCRIMINATE (Ballante, F., et al., 2012) (depicted generally in FIG. 1) used the AutoDock's AutoGrid engine to compute the components of the ligand-residues interaction energies for each ligand/enzyme complex. The PLS (Partial Least Squares for Latent Variables) paradigm, as implemented in the R (R-Development-Core-Team. The R Foundation for Statistical Computing. http://www.r-project.org) environment, was used to derive robust, predictive DISCRIMINATE models. Although the original COMBINE (gCOMBINE) (Gil-Redondo, R., et al., 2010) was available, it was decided to develop DISCRIMINATE because it allows direct calculation of ligand/enzyme per residue interaction from docking results without further complex parameterization as required in the original COMBINE.

Training Set:

Nine experimental 3-D structures of HDAC-2, -4, -7 and -8 co-crystallized with different ligands were retrieved from the Protein Data Bank (Bernstein, F. C., et al., 1977) (Table 3). The remaining HDAC isoforms whose experimental structures were not experimentally available (HDAC-1, -3, -5, -6-1, -6-2, -9, -10 and -11) were built by homology modeling. In the case of HDAC-6, both the histone- and tubuline-catalytic domains were built (histones: HDAC-6-1 and tubulin: HDAC-6-2) with the same experimental inhibitory activities assigned to each complex.

TABLE 3
PDB codes, Ligand Names, Chemical Structures and HDAC Inhibitory Activities of Complexes Downloaded from
Protein Data Bank. IC₅₀s were all evaluated in similar way using a fluorescently labeled acetylated peptide as substrate.

| | HDAC | | | | IC₅₀ |
|---|---|---|---|---|---|
| PDB code | Class | Number | Ligand structure | IUPAC name | (μm) |
| 3MAX (Bressi,) J. C., et al., 2010) | I | 2 | 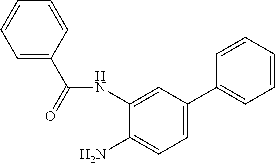 [SMILES: Nc1ccc(-c2ccccc2)cc1NC(=O)c1ccccc1] | N-(4-aminobiphenyl-3-yl) benzamide (LLX) | 0.9 (Bressi, J. C., et al., 2010) |
| 3F07 (Dowling, D. P., et al., 2008) | I | 8 | 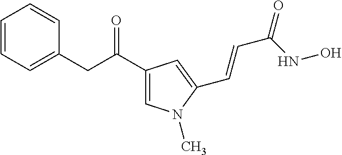 [SMILES: Cn1cc(C(=O)Cc2ccccc2)cc1/C=C/C(=O)NO] | (2E)-N-hydroxy-3-[1-methyl- 4-(phenylacetyl)-1H-pyrrol- 2-yl]prop-2-enamide (APHA8) | 2.8 (Blackwell, L., et al., 2008) |
| 1T64 (Somoza, J. R., et al., 2004) | I | 8 | 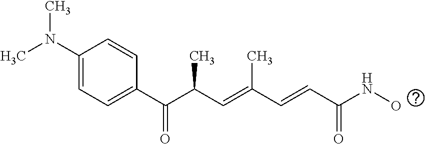 [SMILES: CC(/C=C/C(=O)NO)=C\[C@H](C)C(=O)c1ccc(N(C)C)cc1] | 7-(4-(Dimethylamino)phenyl)- N-hydroxy-4,6-dimethyl-7-oxo- 2,4-heptadienamide (TSA) | 1.1 (Blackwell, L., et al., 2008) |
| 1T67 (Somoza J. R., et al., 2004) | I | 8 | 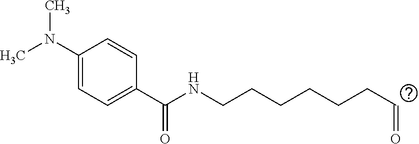 | 4-dimethylamino-n-(6- hydroxycarbamoyethyl) benzamide-n-hydroxy-7-(4- dimethylaminobenzoyl) aminoheptanamide (MS-344) | 0.249 (Ortore, G., et al., 2009) |
| 1T69 (Somoza, J. R., et al., 2004) | I | 8 | 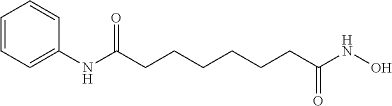 [SMILES: O=C(CCCCCCC(=O)Nc1ccccc1)NO] | octanedioic acid hydroxyamidephenylamide (SAHA) | 2.2 (Blackwell, L., et al., 2008) |
| 1W22 (Somoza, J. R., et al, 2004) | I | 8 | 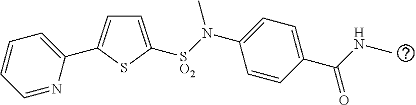 [SMILES: CNC(=O)c1ccc(N(C)S(=O)(=O)c2ccc(-c3ccccn3)s2)cc1] | N-hydroxy-4-{methyl[(5- pyridin-2-ylthiophen-2-yl) sulfonyl]amino}benzamide (NHB) | 0.175 (Vannini, A., et al., 2004) |
| 2VQM (Bottomley, M. J., et al., 2008) | II a | 4 | 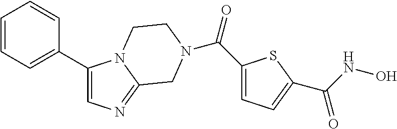 [SMILES: O=C(NO)c1ccc(C(=O)N2CCn3c(-c4ccccc4)cnc3C2)s1] | N-hydroxy-5-[(3-phenyl-5,6- dihydroimidazo[1,2-a]pyrazin- 7(8H)-yl)carbonyl]thiophene- 2-carboxamide (HA3) | 0.978 (Bottomley, M. J., et al., 2008) |
| 2VQJ (Bottomley, M. J., et al., 2008) | II a | 4 | 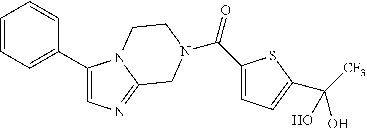 [SMILES: O=C(c1ccc(C(O)(O)C(F)(F)F)s1)N1CCn2c(-c3ccccc3)cnc2C1] | 2,2,2-trifluoro-1-{5-[(3-phenyl- 5,6-dihydroimidazo[1,2-a] pyrazin-7(8h)-yl)carbonyl] thiophen-2-yl}¹²ethane- 1,1- diol (TFMK) | 0.367 (Bottomley, M. J., et al., 2008) |
| 3C0Z (Schuetz, A., et al., 2008) | II a | 7 | 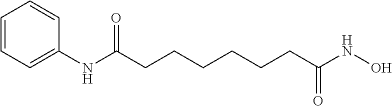 [SMILES: O=C(CCCCCCC(=O)Nc1ccccc1)NO] | octanedioic acid hydroxyamidephenylamide (SAHA) | 0.05 (Blackwell, L., et al., 2008) |
| 3C10 (Schuetz, A., et al., 2008) | II a | 7 | 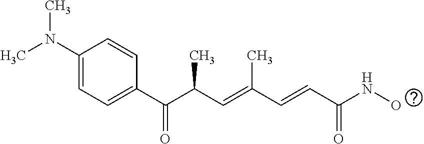 [SMILES: CC(/C=C/C(=O)NO)=C\[C@H](C)C(=O)c1ccc(N(C)C)cc1] | 7-(4-(Dimethylamino)phenyl)- N-hydroxy-4,6-dimethyl-7- oxo-2,4-heptadienamide (TSA) | 0.014 (Blackwell, L., et al., 2008) |

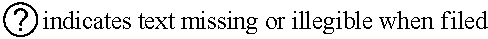

In addition to co-crystallized inhibitors, other compounds (Table 4) reported simultaneously from the same laboratory by Blackwell et al. (Blackwell, L., et al., 2008) were selected. The data set composed of 15 different inhibitors and 12 HDAC isoforms was reduced from the theoretical number of 180 to 94 due to a lack of complete isozyme-inhibitory data. Therefore, the final training set summarized in Table 5 comprised 39 complexes derived with crystallized structures, built according to structural similarity of modeled inhibitors with co-crystallized compounds and 55 complexes derived from homology models. The latter are generated according to the web-servers used for producing the homology models (see “HDAC Homology Models” section, above).

TABLE 4
Training set - chemical structures and HDACs inhibitory activities - IC₅₀s (expressed in μM) were all evaluated in similar way using a fluorescent-labeled acetylated peptide as substrate.

| | | HDAC | | | | | | | | | | |
|---|---|---|---|---|---|---|---|---|---|---|---|---|
| | | Class | | | | | | | | | | |
| | | I | | | | IIa | | | | IIb | | IV |
| | | Number | | | | | | | | | | |
| | | 1 | 2 | 3 | 8 | 4 | 5 | 7 | 9 | 6 | 10 | 11 |
| Chemical Structures and IDS | 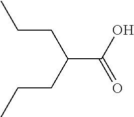 | 1000 | 1000 | 226.08 | 228.85 | — | 2000 (Fass, D. M., et al., 2011) | — | 2000 (Fass, D. M., et al., 2011) | 1000 | 1000 | — |
| | valproic acid (VALP) | | | | | | | | | | | |
| | 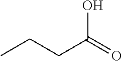 | 319 | 28.9 | 22.5 | 85.6 | 30 | 2000 (Fass, D. M., et al., 2011) | 30 | 2000 (Fass, D. M., et al., 2011) | 1000 | 292 | — |
| | Butyrate (NABUT) | | | | | | | | | | | |
| | 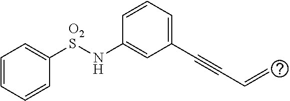 [SMILES: C=CC#Cc1cccc(NS(=O)(=O)c2ccccc2)c1] | 0.05 | 0.2 | 0.01 | 2.2 | 0.03 | — | 0.03 | — | 0.09 | 0.05 | — |
| | Oxamflatin (OXAM) | | | | | | | | | | | |
| | 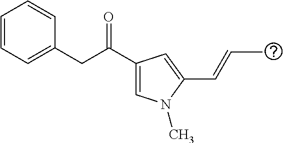 [SMILES: C/C=C/c1cc(C(=O)Cc2ccccc2)cn1C] | 3.7 | 7.4 | 0.42 | 2.8 | 3.1 | — | 3.1 | — | 0.1 | 4.2 | — |
| | APHA8 | | | | | | | | | | | |
| | 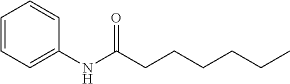 | 0.1 | 0.44 | 0.02 | 2.2 | 0.05 | 0.378 (Hanessian, S., et al, (2010) | 0.05 | 0.316 (Hanessian, S., et al, (2010) | 0.02 | 0.1 | 0.362 (Hanessian, S., et al, (2010) |
| | SAHA | | | | | | | | | | | |
| | 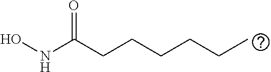 | 2.1 | 4.6 | 0.41 | 3.7 | 1.4 | — | 1.3 | — | 0.1 | 2.3 | — |
| | SBHA | | | | | | | | | | | |
| | 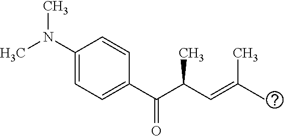 [SMILES: CC(C)=C[C@H](C)C(=O)c1ccc(N(C)C)cc1] | 0.005 | 0.021 | 0.005 | 1.1 | 0.014 | 0.0165 (Hanessian, S., et al, 2010) | 0.014 | 0.0381 (Hanessian, S., et al, 2010) | 0.005 | 0.005 | 0.0152 (Hanessian, S., et al, 2010) |
| | TSA | | | | | | | | | | | |
| | 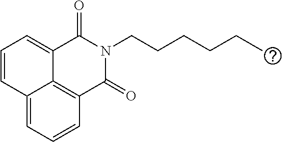 [SMILES: CCCCCCN1C(=O)c2cccc3cccc(c23)C1=O] | 0.17 | 0.64 | 0.03 | 2.3 | 0.2 | — | 0.16 | — | 0.004 | 0.17 | — |
| | SCRIPTAID (SCRIP) | | | | | | | | | | | |
| | 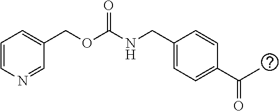 [SMILES: CC(=O)c1ccc(CNC(=O)OCc2cccnc2)cc1] | 13 | 0.51 | 0.07 | 30 | 12 | — | 6.2 | — | 21 | 11.5 | — |
| | MS-275 | | | | | | | | | | | |

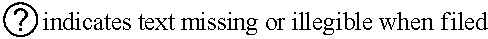

TABLE 5
Training Set Composition. Inhibitor names, corresponding HDAC used
in the complex, and information on source of protein structure.

| | Compound | HDAC | Protein | |
|---|---|---|---|---|
| # | Name | isoform | Source | pIC₅₀ |
| 1 | VALP | HDAC1 | ModWeb | 3.00 |
| 2 | NABUT | HDAC1 | ModWeb | 3.50 |
| 3 | MS-275 | HDAC1 | M4T | 4.89 |
| 4 | APHA8 | HDAC1 | SwissModel | 5.43 |
| 5 | SBHA | HDAC1 | CPH | 5.68 |
| 6 | SCRIP | HDAC1 | ModWeb | 6.77 |
| 7 | SAHA | HDAC1 | M4T | 7.00 |
| 8 | OXAM | HDAC1 | ModWeb | 7.30 |
| 9 | TSA | HDAC1 | CPH | 8.30 |
| 10 | VALP | HDAC2 | Crystal | 3.00 |
| 11 | NABUT | HDAC2 | Crystal | 4.54 |
| 12 | APHA8 | HDAC2 | Crystal | 5.13 |
| 13 | SBHA | HDAC2 | Crystal | 5.34 |
| 14 | LLX | HDAC2 | Crystal | 6.05 |
| 15 | SCRIP | HDAC2 | Crystal | 6.19 |
| 16 | MS-275 | HDAC2 | Crystal | 6.29 |
| 17 | SAHA | HDAC2 | Crystal | 6.36 |
| 18 | OXAM | HDAC2 | Crystal | 6.70 |
| 19 | TSA | HDAC2 | Crystal | 7.68 |
| 20 | VALP | HDAC3 | CPH | 3.65 |
| 21 | NABUT | HDAC3 | SwissModel | 4.65 |
| 22 | APHA8 | HDAC3 | CPH | 6.38 |
| 23 | SBHA | HDAC3 | SwissModel | 6.39 |
| 24 | MS-275 | HDAC3 | CPH | 7.16 |
| 25 | SCRIP | HDAC3 | SwissModel | 7.52 |
| 26 | SAHA | HDAC3 | CPH | 7.70 |
| 27 | OXAM | HDAC3 | SwissModel | 8.00 |
| 28 | TSA | HDAC3 | SwissModel | 8.30 |
| 29 | NABUT | HDAC4 | Crystal | 4.52 |
| 30 | MS-275 | HDAC4 | Crystal | 4.92 |
| 31 | APHA8 | HDAC4 | Crystal | 5.51 |
| 32 | SBHA | HDAC4 | Crystal | 5.89 |
| 33 | HA3 | HDAC4 | Crystal | 6.01 |
| 34 | TFMK | HDAC4 | Crystal | 6.44 |
| 35 | SCRIP | HDAC4 | Crystal | 6.70 |
| 36 | SAHA | HDAC4 | Crystal | 7.30 |
| 37 | OXAM | HDAC4 | Crystal | 7.52 |
| 38 | TSA | HDAC4 | Crystal | 7.85 |
| 39 | NABUT | HDAC5 | ModWeb | 2.70 |
| 40 | VALP | HDAC5 | ModWeb | 2.70 |
| 41 | SAHA | HDAC5 | CPH | 6.42 |
| 42 | TSA | HDAC5 | CPH | 7.80 |
| 43 | NABUT | HDAC6-1 | M4T | 3.00 |
| 44 | VALP | HDAC6-1 | CPH | 3.00 |
| 45 | APHA8 | HDAC6-1 | SwissModel | 7.00 |
| 46 | MS-275 | HDAC6-1 | ModWeb | 7.00 |
| 47 | SBHA | HDAC6-1 | CPH | 7.00 |
| 48 | SAHA | HDAC6-1 | SwissModel | 7.70 |
| 49 | TSA | HDAC6-1 | SwissModel | 8.30 |
| 50 | SCRIP | HDAC6-1 | SwissModel | 8.40 |
| 51 | NABUT | HDAC6-2 | CPH | 3.00 |
| 52 | VALP | HDAC6-2 | ModWeb | 3.00 |
| 53 | APHA8 | HDAC6-2 | CPH | 7.00 |
| 54 | MS-275 | HDAC6-2 | M4T | 7.00 |
| 55 | SBHA | HDAC6-2 | ModWeb | 7.00 |
| 56 | OXAM | HDAC6-2 | CPH | 7.05 |
| 57 | SAHA | HDAC6-2 | CPH | 7.70 |
| 58 | TSA | HDAC6-2 | M4T | 8.30 |
| 59 | SCRIPTAID | HDAC6-2 | M4T | 8.40 |
| 60 | NABUT | HDAC7 | Crystal | 4.52 |
| 61 | MS-275 | HDAC7 | Crystal | 5.21 |
| 62 | APHA8 | HDAC7 | Crystal | 5.51 |
| 63 | SBHA | HDAC7 | Crystal | 5.89 |
| 64 | SCRIP | HDAC7 | Crystal | 6.80 |
| 65 | SAHA | HDAC7 | Crystal | 7.30 |
| 66 | OXAM | HDAC7 | Crystal | 7.52 |
| 67 | TSA | HDAC7 | Crystal | 7.85 |
| 68 | VALP | HDAC8 | Crystal | 3.64 |
| 69 | NABUT | HDAC8 | Crystal | 4.07 |
| 70 | MS-275 | HDAC8 | Crystal | 4.52 |
| 71 | SBHA | HDAC8 | Crystal | 5.43 |
| 72 | APHA8 | HDAC8 | Crystal | 5.55 |
| 73 | SCRIP | HDAC8 | Crystal | 5.64 |
| 74 | OXAM | HDAC8 | Crystal | 5.66 |
| 75 | SAHA | HDAC8 | Crystal | 5.66 |
| 76 | TSA | HDAC8 | Crystal | 5.96 |
| 77 | MS344 | HDAC8 | Crystal | 6.60 |
| 78 | NHB | HDAC8 | Crystal | 6.76 |
| 79 | NABUT | HDAC9 | ModWeb | 2.70 |
| 80 | VALP | HDAC9 | CPH | 2.70 |
| 81 | SAHA | HDAC9 | ModWeb | 6.50 |
| 82 | TSA | HDAC9 | ModWeb | 7.42 |
| 83 | VALP | HDAC10 | M4T | 3.00 |
| 84 | NABUT | HDAC10 | CPH | 3.54 |
| 85 | MS-275 | HDAC10 | ModWeb | 4.94 |
| 86 | APHA8 | HDAC10 | SwissModel | 5.38 |
| 87 | SBHA | HDAC10 | M4T | 5.64 |
| 88 | SCRIP | HDAC10 | ModWeb | 6.77 |
| 89 | SAHA | HDAC10 | ModWeb | 7.00 |
| 90 | OXAM | HDAC10 | CPH | 7.30 |
| 91 | TSA | HDAC10 | CPH | 8.30 |
| 92 | SAHA | HDAC11 | ModWeb | 6.44 |
| 93 | TSA | HDAC11 | ModWeb | 7.82 |
| 94 | SAHA | HDAC6-1 | SwissModel | 7.70 |

The training set complexes were energy minimized with Amber 10 (Case, D. A., et al., 2005) and multiply aligned using Modeller (Fiser, A., et al., 2003) to establish structure-based residue equivalence. This alignment provided the structural basis for computing the molecular-interaction fields with a corresponding per-residue basis for all enzyme isoforms. Because different isoforms of HDACs show structural diversity in terms of amino-acid sequences and differed in numbers of amino acids (multi-target study), all HDACs residues were renumbered in an arbitrary way: the same numbering was assigned to those residues showing spatial superimposition; conversely, a “ghost” residue was attributed to the regions which presented structural diversity (see Supplemental File 5). In this way, a total of 571 amino-acid residues, 12-fragmented HDACs isoform structures were obtained. The calculation of the ligand/residues was conducted similarly as previously reported (Ballante, F., et al., 2012). The calculated molecular descriptors were imported in R (Ballante, F. and Ragno, R., 2012) to generate structure-based 3-D QSAR models. The purpose of training-set complex minimization was to generate not only 94 optimized complexes, but also to have several conformations for each HDAC useful in the subsequent preparation of test-set complexes by ligand cross-docking (see below).

Each derived DISCRIMINATE model was subjected to internal (cross-validation) and external (test-set) assessments. Cross-validation was done using both the leave-one-out (LOO) and random 5 groups leave-some-out (R5G-LSO) techniques. For external validation, a series of molecules with known inhibitory activity against HDAC isozymes was selected as an external test set for the model's predictability assessment.

External Test Sets for the DISCRIMINATE Model Validation.

Three different test sets were used for external validation. The first one (modeled test set, MTS) contained a series of molecules, docked with AutoDockVina (Trott, O., et al., 2010), that showed inhibitory activity against several HDAC isoforms (Table 6).

TABLE 6
MTS chemical structures and reported HDACs inhibitory activities (IC₅₀ expressed in μM).

| | | HDAC | | | | | |
|---|---|---|---|---|---|---|---|
| | | Class | | | | | |
| | | I | | | | IIa | |
| | | Number | | | | | |
| | | 1 | 2 | 3 | 8 | 4 | 5 |
| Chem- ical Struc- tures and IDS | 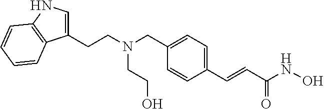 [SMILES: O=C(/C=C/c1ccc(CN(CCO)CCc2c[nH]c3ccccc23)cc1)NO] | 0.00323 | 0.01570 | 0.01050 | 0.00384 | 0.00582 | 0.00558 |
| | LAQ824 (Hanessian, S., et al., 2007) | | | | | | |
| | 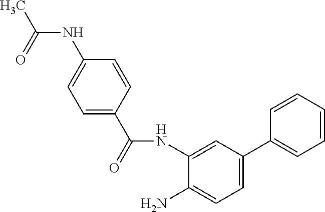 [SMILES: CC(=O)Nc1ccc(C(=O)Nc2cc(-c3ccccc3)ccc2N)cc1] | 0.41 | — | 0.75 | 100 | — | — |
| | CI-994 (Beckers, T., et al., 2007) | | | | | | |
| | 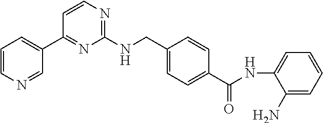 [SMILES: Nc1ccccc1NC(=O)c1ccc(CNc2nccc(-c3cccnc3)n2)cc1] | 0.15 | 0.29 | 1.66 | — | — | — |
| | MGCD0103 (Zhou, N., et al., 2008) | | | | | | |
| | 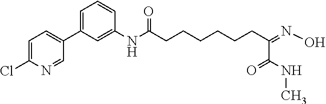 [SMILES: CNC(=O)/C(CCCCCCC(=O)Nc1cccc(-c2ccc(Cl)nc2)c1)=N\O] | 19.3 | 69.7 | 1.99 | 100 | 58.9 | 21.0 |
| | JMC-23 (Botta, C. B., et al., 2011) | | | | | | |
| | 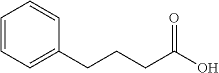 [SMILES: O=C(O)CCCc1ccccc1] | 64 | 65 | 260 | 93 | 2000 | 2000 |
| | MCL-3 (Fass, D. M., et al., 2010) | | | | | | |
| | 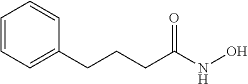 [SMILES: O=C(CCCc1ccccc1)NO] | 0.6 | 0.6 | 2 | 4 | 140 | 25 |
| | MCL-4 (Fass, D. M., et al., 2010) | | | | | | |
| | 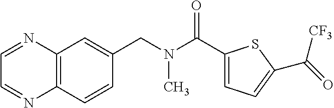 [SMILES: CN(Cc1ccc2nccnc2c1)C(=O)c1ccc(C(=O)C(F)(F)F)s1] | 0.58 | — | 0.67 | — | 0.098 | — |
| | MCL08-3i (Bottomley, M. J., et al., 2008) | | | | | | |
| | 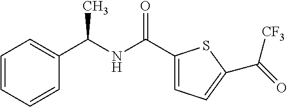 [SMILES: C[C@@H](NC(=O)c1ccc(C(=O)C(F)(F)F)s1)c1ccccc1] | 0.32 | — | 0.23 | — | 0.076 | — |
| | MCL08-3d (Bottomley, M. J., et al., 2008) | | | | | | |
| | 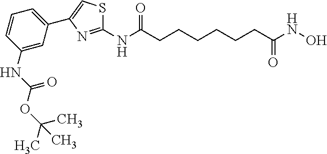 [SMILES: CC(C)(C)OC(=O)Nc1cccc(-c2csc(NC(=O)CCCCCCC(=O)NO)n2)c1] | 0.004 | 0.021 | 0.002 | 2.58 | — | — |
| | CMC-25b (Kozikowski, A. P., et al., 2008a,b) | | | | | | |
| | 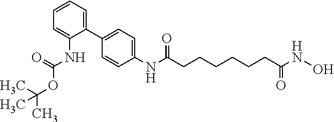 [SMILES: CC(C)(C)OC(=O)Nc1ccccc1-c1ccc(NC(=O)CCCCCCC(=O)NO)cc1] | 0.057 | 0.074 | 0.018 | 1.72 | — | — |
| | CMC-7f (Kozikowski, A. P., et al., 2008a,b) | | | | | | |

| | | HDAC | | | | |
|---|---|---|---|---|---|---|
| | | Class | | | | |
| | | IIa | | IIb | | IV |
| | | Number | | | | |
| | | 7 | 9 | 6 | 10 | 11 |
| Chem- ical Struc- tures and IDS | 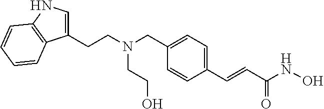 [SMILES: O=C(/C=C/c1ccc(CN(CCO)CCc2c[nH]c3ccccc23)cc1)NO] | 0.00611 | 0.00824 | 0.00593 | 0.00841 | 0.00558 |
| | LAQ824 (Hanessian, S., et al., 2007) | | | | | |
| | 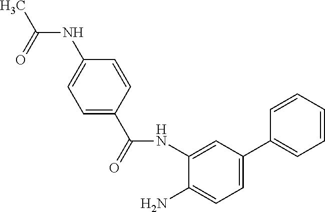 [SMILES: CC(=O)Nc1ccc(C(=O)Nc2cc(-c3ccccc3)ccc2N)cc1] | — | — | 100 | — | — |
| | CI-994 (Beckers, T., et al., 2007) | | | | | |
| | 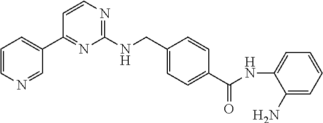 [SMILES: Nc1ccccc1NC(=O)c1ccc(CNc2nccc(-c3cccnc3)n2)cc1] | — | — | — | — | 0.59 |
| | MGCD0103 (Zhou, N., et al., 2008) | | | | | |
| | 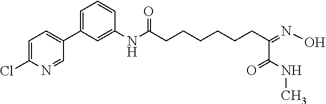 [SMILES: CNC(=O)/C(CCCCCCC(=O)Nc1cccc(-c2ccc(Cl)nc2)c1)=N\O] | 29.7 | 13.3 | 93.5 | 23.1 | 34.1 |
| | JMC-23 (Botta, C. B., et al., 2011) | | | | | |
| | 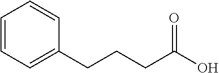 [SMILES: O=C(O)CCCc1ccccc1] | 2000 | 2000 | 240 | — | — |
| | MCL-3 (Fass, D. M., et al., 2010) | | | | | |
| | 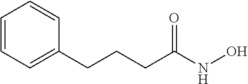 [SMILES: O=C(CCCc1ccccc1)NO] | 150 | 430 | 0.5 | — | — |
| | MCL-4 (Fass, D. M., et al., 2010) | | | | | |
| | 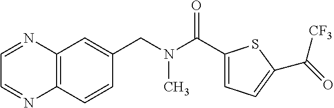 [SMILES: CN(Cc1ccc2nccnc2c1)C(=O)c1ccc(C(=O)C(F)(F)F)s1] | — | — | 0.089 | — | — |
| | MCL08-3i (Bottomley, M. J., et al., 2008) | | | | | |
| | 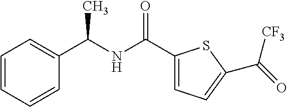 [SMILES: C[C@@H](NC(=O)c1ccc(C(=O)C(F)(F)F)s1)c1ccccc1] | — | — | 0.36 | — | — |
| | MCL08-3d (Bottomley, M. J., et al., 2008) | | | | | |
| | 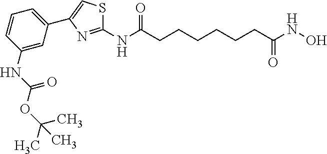 [SMILES: CC(C)(C)OC(=O)Nc1cccc(-c2csc(NC(=O)CCCCCCC(=O)NO)n2)c1] | — | — | 0.0002 | 0.002 | — |
| | CMC-25b (Kozikowski, A. P., et al., 2008a,b) | | | | | |
| | 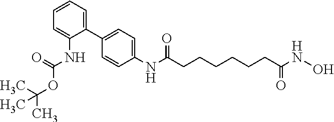 [SMILES: CC(C)(C)OC(=O)Nc1ccccc1-c1ccc(NC(=O)CCCCCCC(=O)NO)cc1] | — | — | 0.011 | 0.083 | — |
| | CMC-7f (Kozikowski, A. P., et al., 2008a,b) | | | | | |

The second test set was comprised of a series of co-crystallized complexes structures (crystal test set, CTS) containing two HDAC8 complexes (not available from the PDB during model development) and four bacterial HDAC homologs (Table 7). The third test set was also modeled, using largazole (a cyclotetrapeptide—containing HDAC inhibitor, largazole test set, LTS) whose crystal structure with HDAC8 was reported, (Cole, K. E., et al., 2011) but whose inhibitory activity was available only for four HDAC isoforms (Table 8). For LTS, largazole was docked with HDAC1, HDAC2, HDAC3 and HDAC6-1. The bacterial HDAC complexes with hydroxamic acids were available from the PDB (Table 7).

TABLE 7
CTS: PDB Codes, Ligand Names, Chemical structures and HDAC Inhibitory Actitities.

| | Receptor | | | IC₅₀ |
|---|---|---|---|---|
| PDB code | name | Ligand structure | Ligand name | (μM) |
| 3SFF (Whitehead, L., et al., (2011) | HDAC8 | 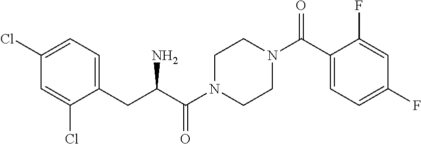 [SMILES: N[C@H](Cc1ccc(Cl)cc1Cl)C(=O)N1CCN(C(=O)c2ccc(F)cc2F)CC1] | (2R)-2-amino-3-(3- chlorophenyl-1-[4-(2,5- difluorobenzoyl) piperazin-1-yl]propan- 1-one (0DI) | 0.2 |
| 3SFH (Whitehead, L., et al., 2011) | HDAC8 | 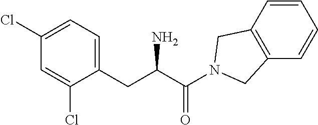 [SMILES: N[C@H](Cc1ccc(Cl)cc1Cl)C(=O)N1Cc2ccccc2C1] | (2R)-2-amino-3-(2,4- dichlorophenyl)-1- (1,3-dihydro-2H- isoindol-2-yl)propan- 1-one (1DI) | 0.09 |
| 1C3R (Finnin, M. S., et al., 1999) | HDLP | 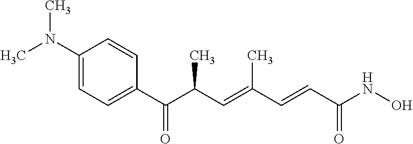 [SMILES: CC(/C=C/C(=O)NO)=C\[C@H](C)C(=O)c1ccc(N(C)C)cc1] | TSA | 0.4 |
| 2GH6 (Nielsen, T. K., et al., 2007) | HDAH | 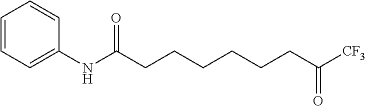 [SMILES: O=C(CCCCCCC(=O)C(F)(F)F)Nc1ccccc1] | 9,9,9-trifluoro-8-oxo- n-phenylnonanamide (CF3) | 11.19 |
| 1ZZ1 (Nielsen, T. K., et. al., 2005) | HDAH | 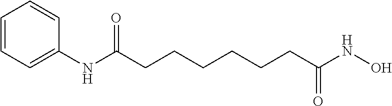 [SMILES: O=C(CCCCCCC(=O)Nc1ccccc1)NO] | SAHA | 0.95 |
| 1ZZ3 (Nielsen, T. K., et al., 2005) | HDAH | 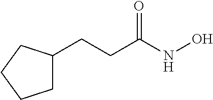 [SMILES: O=C(CCC1CCCC1)NO] | 3-cyclopentyl-n- hydroxypropanamide (3YP) | 0.29 |

TABLE 8
LTS: PDB Code, Ligand Name, Chemical Structure, and HDAC Inhibitory Activities

| | | | IC₅₀ (μM) | | | | |
|---|---|---|---|---|---|---|---|
| | | | HDAC | HDAC | HDAC | HDAC | HDAC |
| PDB code | Ligand structure | Ligand name | 1 | 2 | 3 | 6 | 8 |
| 3RQD (Cole, K. E., et al., 2011) | 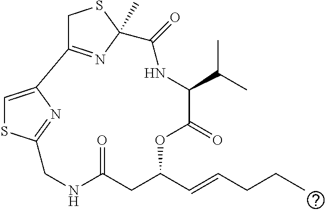 [SMILES: CCC/C=C/[C@@H]1CC(=O)NCc2nc(cs2)C2=N[C@@](C)(SC2)C(=O)N[C@@H](C(C)C)C(=O)O1] | Largazolethiol | 0.0012 | 0.0035 | 0.0034 | 0.049 | — |

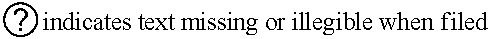

### Results and Discussion

DISCRIMINATE Models—

Overall analysis. All final models contained 94-inhibitor/enzyme complexes spanning an activity range, expressed as pIC₅₀, between 2.7 (NABUT against HDAC5) to 8.4 (SCRIPTAID against HDAC6). The statistical results of the final models are summarized in Table 9. Genetic algorithm variable-selection was applied, but provided little improvement in either descriptive or predictive performance, hence the non-GA-optimized models were used.

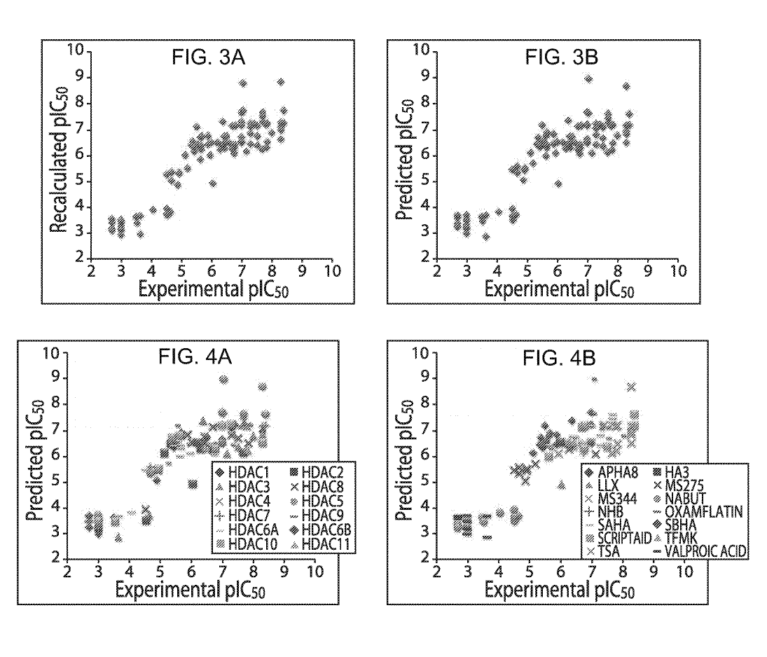

Structure-activity relationships of the various HDAC inhibitors have previously been described in other studies. (Ragno, R., et al., 2006, Ragno, R., et al., 2008). Crystal structures of receptor-ligand complexes have been analyzed qualitatively or by comparison of bound ligands. (Mai, A., et al., 2002, Mai, A., et al., 2003). DISCRIMINATE analysis permits quantification of structure-activity relationships through the electrostatic (coulombic) and van der Waals interaction energies as well as additional parameters, such as solvation energy. Distinguished from the original COMBINE procedure of Ortiz (Ortiz, A. R., et al., 1995), DISCRIMINATE computes enzyme/ligand interactions using the AutoGrid program based on the AMBER united-atom force field and chosen for its simpler molecular format (PDBQT). The data in Table 9 refer to the mono-probe fields (ELE, STE, DRY) and the multi-probe ones: electrostatic-steric (ELE+STE), electrostatic-desolvation (ELE+DRY) and electrostatic-steric-desolvation (ELE+STE+DRY). The reported statistical coefficients allowed estimates of goodness and robustness of each model. Results indicated the ELE+DRY model as the best. In fact, the overall generated model showed the highest conventional squared correlation coefficient (r²) and lowest standard deviation error of calculation (SDEC) values: 0.80 and 0.73 respectively (FIG. 3A), comparable to those reported by Wade et al. in a similar application (Henrich, S., et al., 2010). To assess the models' internal predictive power and robustness, two validation methods were used as follows: cross-validation (CV, internal validation) and Y-scrambling. LOO and R5G-LSO methods were chosen for cross-validation, obtaining for both q² values of 0.76 for the ELE+DRY probe, using only 2 principal components (FIG. 3B). These results suggested good internal predictability (CV) of the model. Furthermore, SDEP (standard deviation error-of-prediction) provided an estimation of model internal predictivity by means of cross-validation; values less than 1 are generally considered indexes of good predictions. Upon further inspection, a high level of inverse correlation between the DRY and STE fields was found; more than 84 out of 94 complexes (˜90%) showed a correlation coefficient between −0.60 and −0.99, rationalizing the similar statistical coefficients among models 4, 5 and 7 (Table 9). Therefore, the DRY field maybe interpreted here as a probable estimation of steric interactions as well.

TABLE 9
Statistical results of the DISCRIMINATE models.

| | | | | | | | | | scrambled q² | |
|---|---|---|---|---|---|---|---|---|---|---|
| | | | | | | | | | % positive | Max. |
| # | Field | PC | r² | SDEC | q²_{K5fold} | SDEP_{K5fold} | q²_{LOO} | SDEP_{LOO} | values | value |
| 1 | ELE | 2 | 0.69 | 0.91 | 0.67 | 0.94 | 0.68 | 0.93 | 5 | 0.07 |
| 2 | STE | 2 | 0.27 | 1.40 | 0.14 | 1.52 | 0.15 | 1.51 | n.d. | n.d. |
| 3 | DRY | 2 | 0.46 | 1.21 | 0.34 | 1.33 | 0.36 | 1.32 | n.d. | n.d. |
| 4 | ELE + STE | 2 | 0.74 | 0.84 | 0.68 | 0.93 | 0.68 | 0.93 | 2 | 0.05 |
| 5 | ELE + DRY | 2 | 0.80 | 0.73 | 0.76 | 0.81 | 0.76 | 0.81 | 6 | 0.08 |
| 6 | STE + DRY | 3 | 0.54 | 1.11 | 0.33 | 1.34 | 0.35 | 1.33 | n.d. | n.d. |
| 7 | ELE + DRY + STE | 2 | 0.77 | 0.78 | 0.72 | 0.87 | 0.72 | 0.87 | 4 | 0.04 |

The charts in FIG. 3 highlight the results of Table 9 and show linearity between experimental and recalculated/predicted data, expressed as pIC₅₀. Two views of experimental versus the R5G-LSO cross-validation predictions, indicating with different symbols each inhibitor and each HDAC isoform, are shown in FIG. 4. This double representation emphasizes how the DISCRIMINATE model retains the correlation within various subgroups, either considering all the training-set inhibitors versus each HDAC (correlation of anti-HDAC inhibitors potency, left of FIG. 4), or considering the each inhibitor binding into different HDAC isoforms (correlation of selectivity, right of FIG. 4). This latter consideration is consistent and supported the fact that the LOO and R5G-LSO cross-validation q²s showed the same values. Furthermore, to check for methodological self-consistency, reduced DISCRIMINATE models built for several inhibitors against each HDAC isoform (inhibition potencies) and for each inhibitor against several HDAC isoforms (selectivity issue) revealed the existence of relationships with r² ranging from 0.7 to 0.8.

Finally, both robustness and absence-of-chance correlation of the DISCRIMINATE models listed in Table 9 were checked by random scrambling (Y-scrambling). Through this approach, a random reassignment of inhibitory activity to compounds of the data set was achieved to generate numerous datasets; for each scrambled dataset, a R5G-LSO cross-validation was run. One hundred Y-scrambling runs were examined; their analysis revealed that only 6% of all Y vectors had a correlation with the original Y values with maximum scrambled q² of only 0.08 in the case of ELE+DRY probe. Regarding the other models, in the case of ELE and ELE+STE+DRY, a chance correlation of 4% and 5% with a q² maximum value of 0.04 and 0.07 were observed, respectively. The ELE+STE probe showed a chance correlation of 2% with a q² maximum value of 0.05. These correlations appear random and excluded possible correlations between the original Y vector and the scrambled Y vectors. For the best model (ELE+DRY) in 100-random scrambled models, the number of positive q² values were only 6 leading to a probability of chance correlation lower than 1% with a q² value of 0.1, quite acceptable results considering the cross-validation coefficients of 0.76 of the model. Cross-validation runs using the most stringent leave-half-out method confirmed the robustness of the models.

ELE-DRY Model Interpretation.

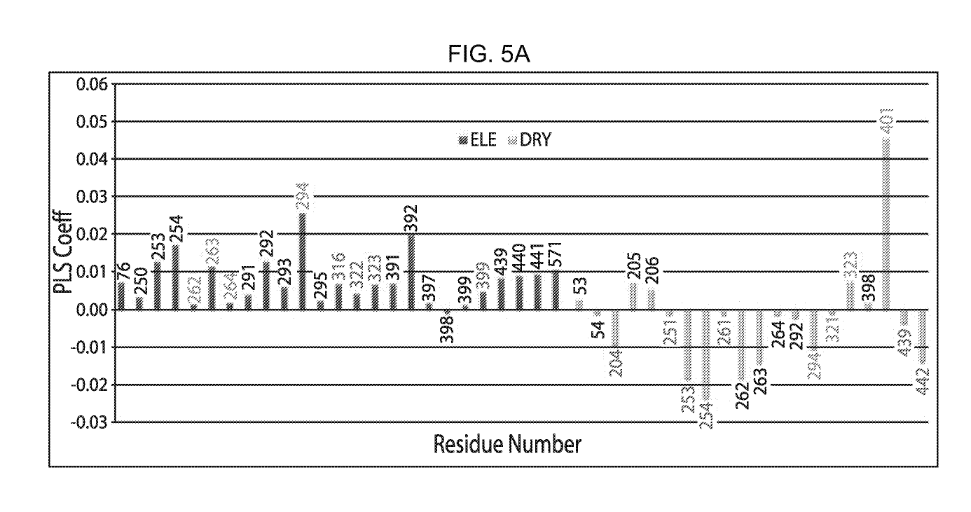

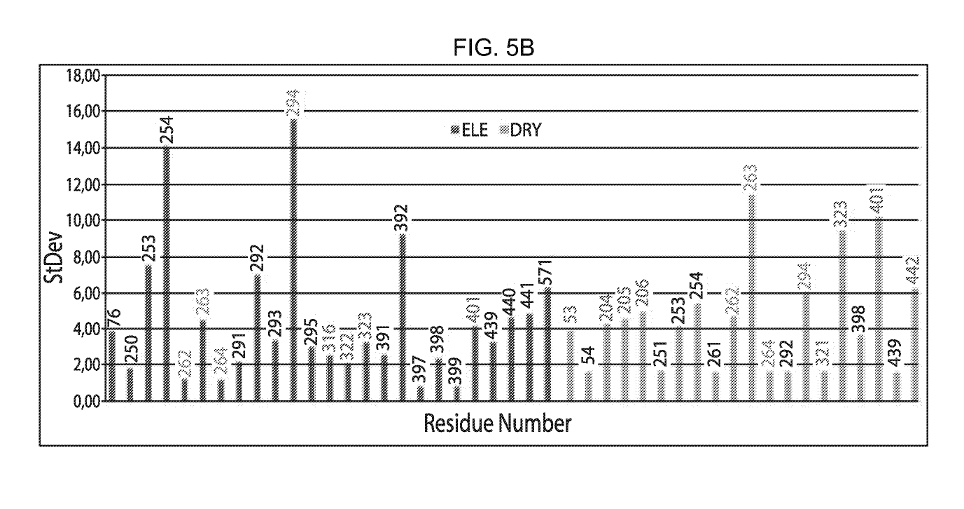

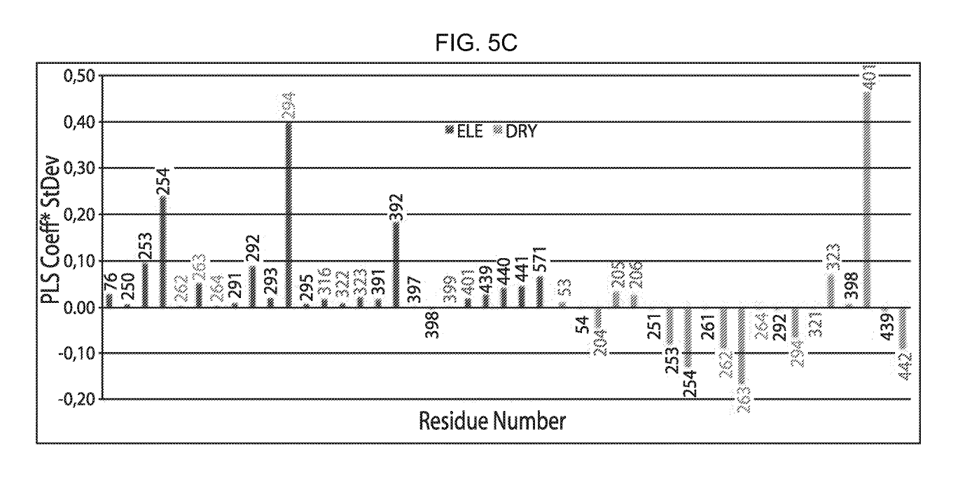

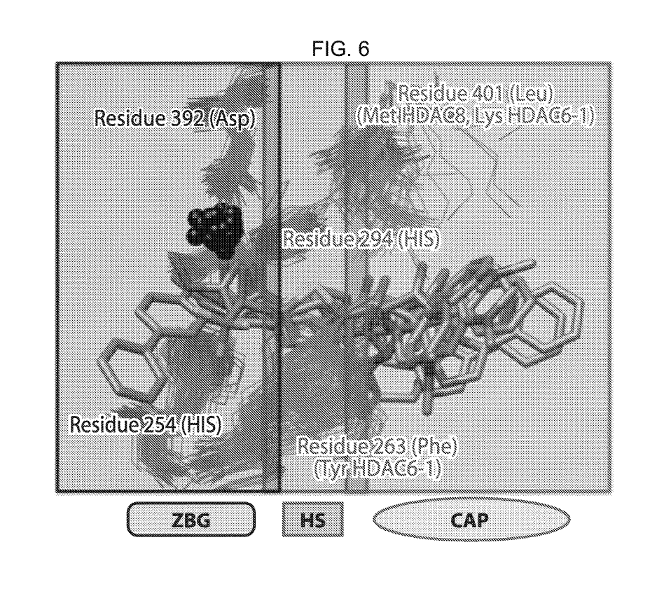

Interpretation of DISCRIMINATE models can identify the residues relevant for differences in activity and quantify their relative importance. To this aim, the PLS-coefficients (FIG. 5) and activity-contribution plots (FIG. 6) are useful. The former provides a global view and gives information on all of the training set. The sign and the magnitude of PLS coefficient of an energy term multiplied by the corresponding energy term (field) show the influence of the corresponding residue on ligand binding. (Perez, C., et al., 1998). Interpretation of the PLS coefficients can lead, however, to possible misconceptions. A positive PLS coefficient for an attractive, negative energy term indicates a term that contributes favorably to binding affinity (resulting in a more negative ΔG value). A positive PLS coefficient for a repulsive, positive energy term indicates a term that is unfavorable for binding affinity (resulting in a more positive ΔG value). On the other hand, a negative PLS coefficient will result in an energy term favoring binding when the energy term is positive (repulsive) and disfavoring binding when the energy term is negative (attractive). (Henrich, S., 2010). The PLS coefficient plot is shown in FIG. 5A. By multiplying the PLS coefficients with the field values, the activity-contribution plots are obtained for each training-set compound. As can be seen (Table 10 and FIG. 5), the DISCRIMINATE model can explain isoform selectivity considering only 34 residues of the enzymes (Table 10) even though all residues of the eleven HDAC isoforms with a PLS coefficient greater than 0.001 were included in the analyses.

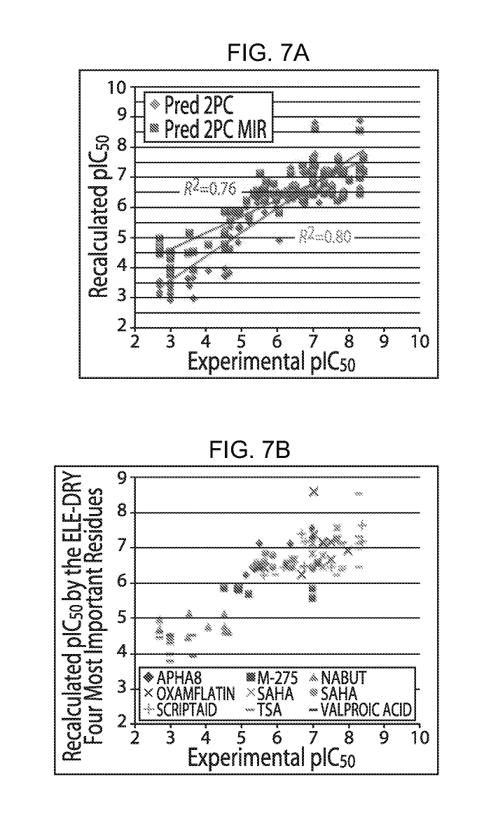

To analyze the significance of the fields (ELE and DRY) and the contribution for each ligand/residue interaction, the residues were color-coded in Table 10. The residues located in the rim region are colored red, while the residues forming the central channel are blue, and those in proximity to the catalytic Zn ion are black (Supplemental File 2). In FIG. 5B are reported the ligand/residue/interactions standard deviations (StDev) used to produce the PLS Coeff*StDev plot (FIG. 5C) in which the PLS coefficients are weighted so that the global importance of the interactions can be understood similar to a standard 3-D QSAR model. (Cramer, R. D., et al., 1988). The variables reported in FIG. 5 and Table 10 are significant for the model; however, the most important residues that modulate the inhibitory activities are as follows: 254 (His for all the HDACs, in the Zn-binding site), 294 (His for all the HDACs, either in the Zn— or tube-binding sites) and 392 (Asp for all the HDACs, in the Zn-binding site) mainly for the ELE field while 263 (Tyr for HDAC6-1 and Phe for all the others in the tube-binding sites) and 401 (Met for HDAC8, Lys for HDAC6-1 and Leu for all the others, in the rim-binding site) for the DRY field (FIG. 6). Residue 254 has also some negative modulating factor in the DRY field. These five residues account for 95% of the explained variance (˜80%) of the model indicating that interactions of ligands with these four residues are of major importance in determining the inhibitor potencies (coarse tuning, FIG. 7). Fine tuning of both potency and selectivity result from other contributions and, therefore, each isoform need to be inspected individually.

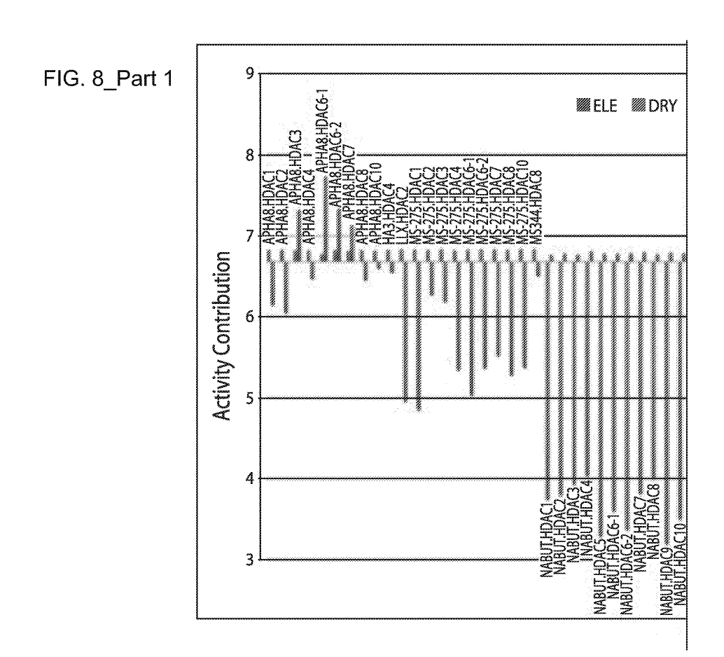

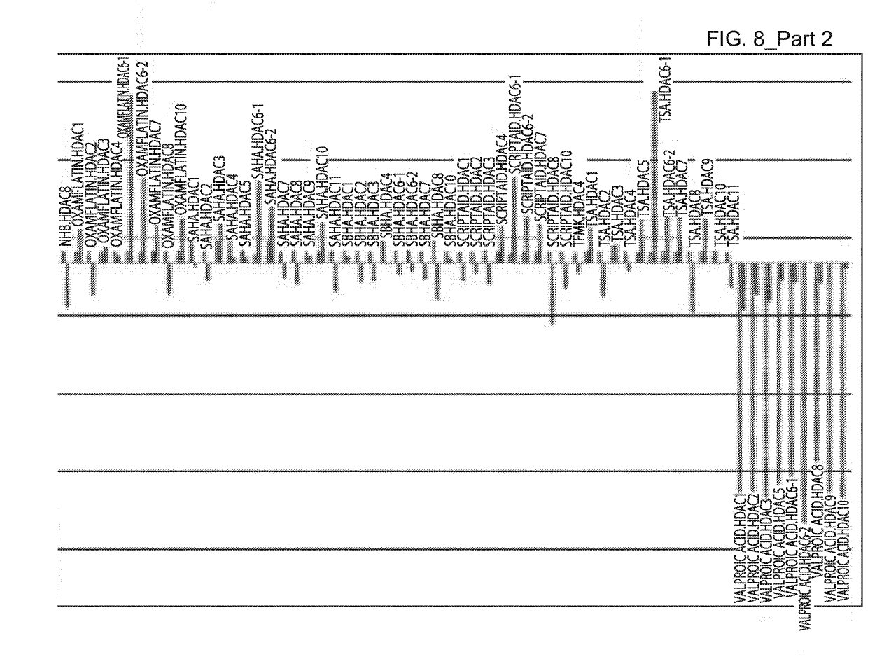

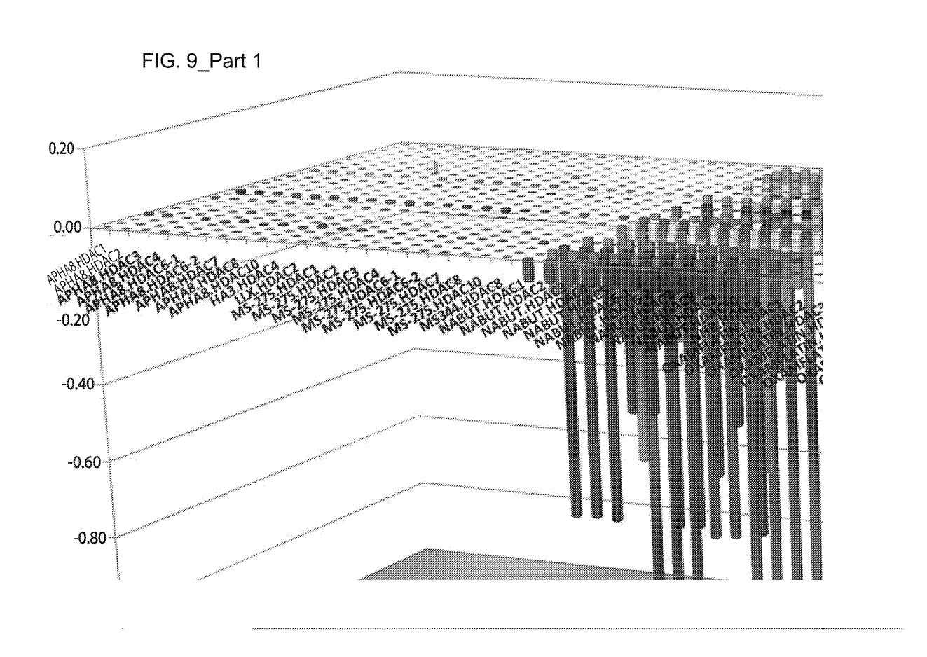

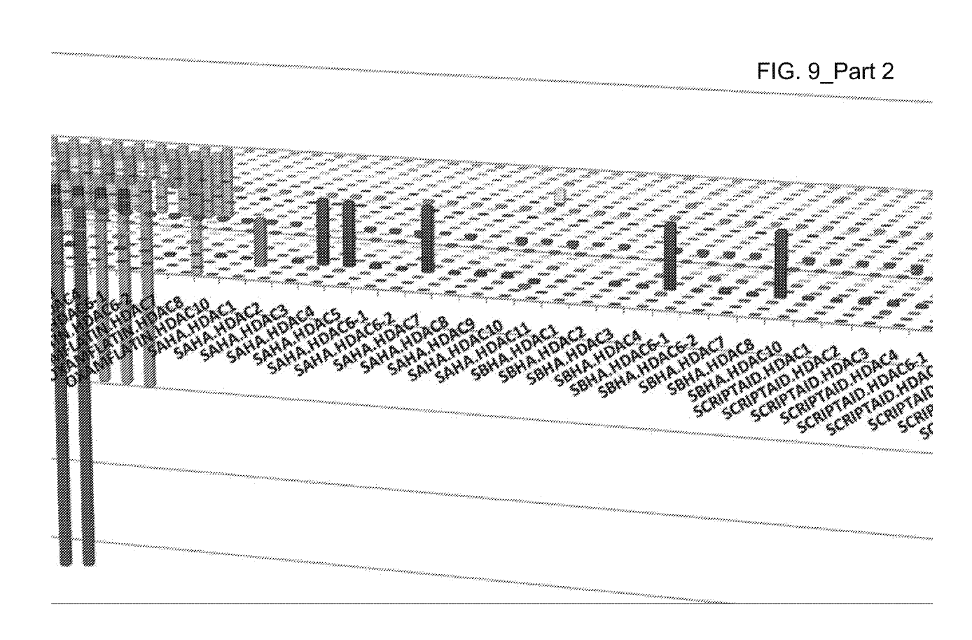

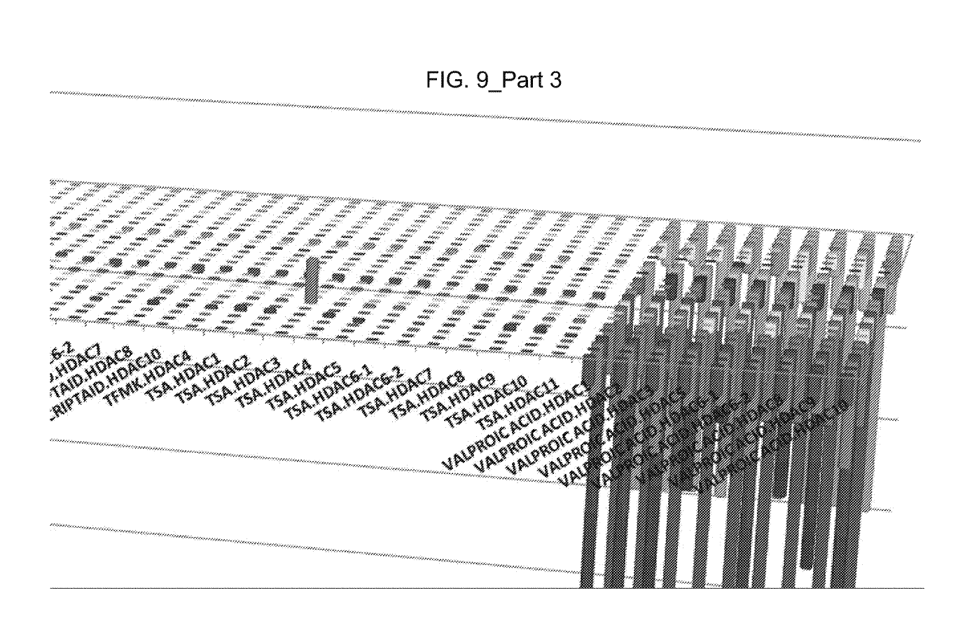

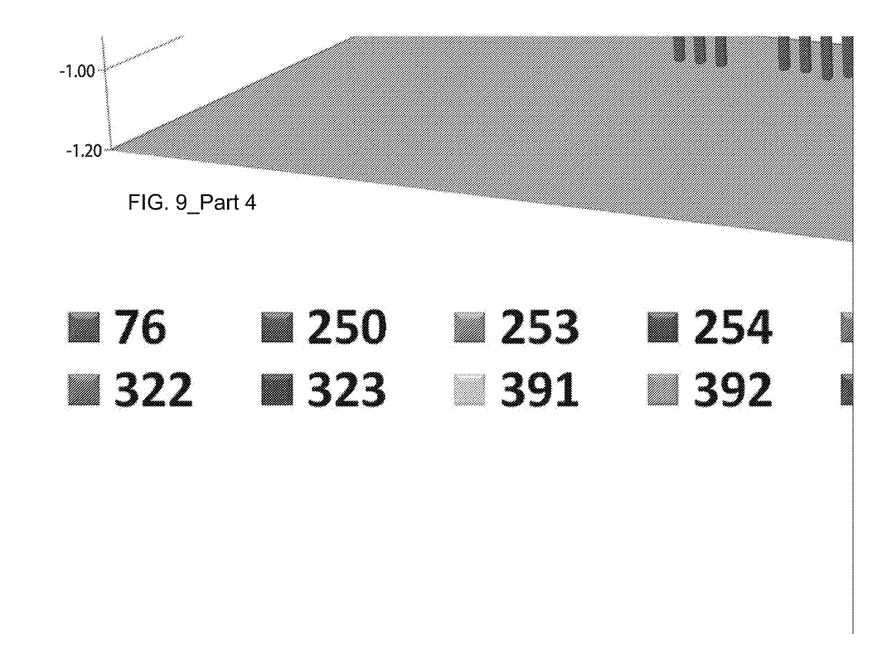

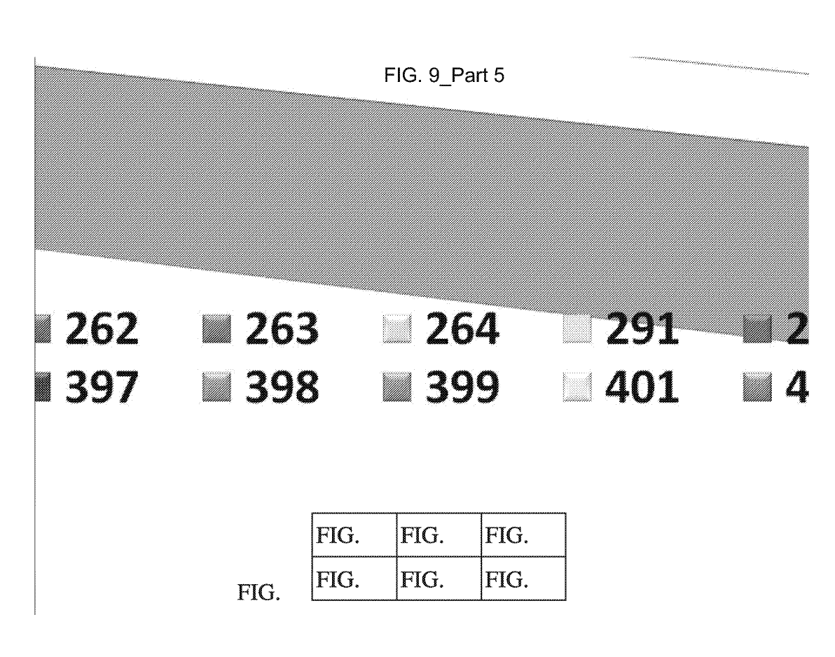

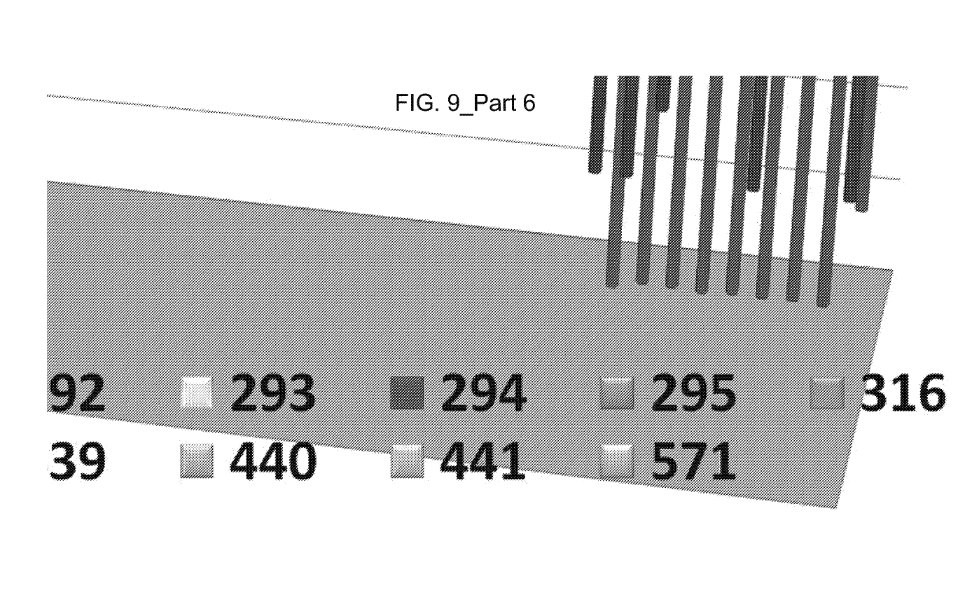

Regarding the importance of the overall interactions, the sums for either the ELE or DRY activity contributions for each training-set complex are shown in FIG. 8. While the DRY field contribution mostly modulates the activities (bigger red bars on bulkier compounds), the ELE contribution becomes more important in modulating the low activities of the smaller inhibitors (bigger blue bars on short fatty acid inhibitors), NABUT and VALPROIC ACID (VA), due to missing interactions with residue 401 and others at the enzymes' rims (FIG. 9). Indeed, the DISCRIMINATE model correctly indicates that NABUT and VA miss residue 401's contributions so activity contributions from other main residues (254, 294 and 392 of ELE field) are highly negative ranging from −0.27 to −1.02 and from −0.14 to −1.02 for NABUT and VA, respectively.

TABLE 10
List of most important residues to interpret the DISCRIMINATE model.

| N. of residuals | | 53* | 54 | 76 | 204* | 205* | 206* | 250 | 251 | 253 | 254 | 261 |
|---|---|---|---|---|---|---|---|---|---|---|---|---|
| CLASS | HDAC1 | HIS28* | PRO29 | ARG34 | GLU98 | — | — | GLY138 | LEU13 | HIS140 | HIS141 | SER148 |
| I | HDAC2 | HIE22* | PRO23 | ARG28 | GLU92 | — | — | GLY132 | LEU13 | HIE134 | HIE135 | SER142 |
| | HDAC3 | HIS22* | PRO23 | ARG28 | ASP92 | — | — | GLY132 | LEU13 | HIS134 | HIS135 | SER142 |
| | HDAC8 | — | — | ARG37 | TYR10 | — | — | GLY140 | TRP14 | HIS142 | HIS143 | MET16 |
| Class | HDAC4 | — | — | ARG32 | — | — | — | PRO15 | GLY15 | HIE153 | HIE154 | MET84 |
| IIa | HDAC5 | HIS704 | PRO705 | ARG71 | — | — | — | PRO83 | GLY83 | HIS832 | HIS833 | ASP137 |
| | HDAC7 | HIE27* | PRO28 | ARG33 | — | — | — | PRO15 | GLY15 | HIE155 | HIE156 | CYS137 |
| | HDAC9 | — | — | ARG66 | — | — | — | PRO78 | GLY78 | HIS782 | HIS783 | MET16 |
| Class | HDAC6 | PHE19 | PRO20 | ARG25 | THR84 | TYR8 | — | PRO12 | GLY12 | HIS129 | HIS130 | SER150 |
| IIb | HDAC6 | HIS19* | PRO20 | ARG25 | — | — | PHE85 | PRO12 | GLY12 | HIS129 | HIS130 | MET79 |
| | HDAC1 | GLU24 | ILE25 | ARG30 | — | — | — | PRO13 | GLY13 | HIS134 | HIS135 | ASN142 |
| Class | HDAC1 | HIS35* | PRO36 | LYS41 | PR010 | — | — | GLY140 | PHE14 | HIS142 | HIS143 | GLY150 |

| N. of residuals | | 262\hat{ } | 263\hat{ } | 264\hat{ } | 291 | 292 | 293 | 294\hat{ } | 295 | 316* | 321* | 322* |
|---|---|---|---|---|---|---|---|---|---|---|---|---|
| CLASS | HDAC1 | GLY14 | PHE15 | CYS15 | ILE175 | ASP17 | ILE177 | HIS178 | HIS17 | LYS20 | GLU20 | TYR20 |
| I | HDAC2 | GLY14 | PHE14 | CYS14 | ILE169 | ASP17 | ILE171 | HIE172 | HIE17 | LYS19 | TYR19 | — |
| | HDAC3 | GLY14 | PHE14 | CYS14 | ILE169 | ASP17 | ILE171 | HIS172 | HIS17 | LYS19 | ASN19 | TYR19 |
| | HDAC8 | GLY15 | PHE15 | CYS15 | LEU177 | ASP17 | LEU17 | HIE180 | HIS18 | LYS20 | GLY20 | PHE20 |
| Class | HDAC4 | GLY16 | PHE16 | CYS16 | TRP190 | ASP19 | VAL19 | HIE193 | HIE19 | ARG21 | ASN22 | PHE22 |
| IIa | HDAC5 | GLY84 | PHE84 | CYS84 | TRP869 | ASP87 | ILE871 | HIS872 | HIS87 | ARG89 | ASN89 | PHE90 |
| | HDAC7 | GLY16 | PHE16 | CYS16 | TRP192 | ASP19 | VAL19 | HIE195 | HIE19 | ARG21 | ASN22 | PHE22 |
| | HDAC9 | GLY79 | PHE79 | CYS79 | LEU819 | ASP82 | VAL82 | HIS822 | HIS82 | ARG84 | ASN84 | PHE85 |
| Class | HDAC6 | GLY13 | TYR13 | CYS14 | TRP166 | ASP16 | VAL16 | HIS169 | HIS17 | ARG19 | ARG19 | PHE19 |
| IIb | HDAC6 | GLY13 | PHE13 | CYS14 | TRP167 | ASP16 | VAL16 | HIS170 | HIS17 | ARG19 | THR19 | PHE19 |
| | HDAC1 | GLY14 | PHE14 | CYS14 | TRP171 | ASP17 | VAL17 | HIS174 | HIS17 | ARG19 | ARG20 | PHE20 |
| Class | HDAC1 | GLY15 | PHE15 | CYS15 | LEU180 | ASP18 | ALA18 | HIS183 | GLN1 | ASN20 | ILE208 | TYR20 |

| N. of residuals | | 323* | 391 | 392 | 397 | 398 | 399* | 401* | 439 | 440 | 441 | 442* |
|---|---|---|---|---|---|---|---|---|---|---|---|---|
| CLASS | HDAC1 | — | SER263 | ASP26 | ASP269 | ARG27 | — | LEU271 | GLY30 | GLY301 | GLY302 | TYR303 |
| I | HDAC2 | PHE199 | ALA257 | ASP25 | ASP263 | ARG26 | — | LEU265 | GLY29 | GLY295 | GLY296 | TYR297 |
| | HDAC3 | PHE199 | ALA258 | ASP25 | ASP264 | ARG26 | — | LEU266 | GLY29 | GLY296 | GLY297 | TYR298 |
| | HDAC8 | PHE208 | ALA266 | ASP26 | ASP272 | PRO27 | — | MET27 | GLY30 | GLY304 | GLY305 | TYR306 |
| Class | HDAC4 | PHE222 | PHE284 | ASP28 | HIE290 | PRO29 | THR29 | LEU294 | GLU32 | GLY325 | GLY326 | HIE327 |
| IIa | HDAC5 | PHE901 | PHE963 | ASP96 | HIS969 | LEU97 | SER97 | LEU973 | GLU10 | GLY100 | GLY100 | HIS100 |
| | HDAC7 | PHE224 | PHE286 | ASP28 | HIE292 | PRO29 | ALA29 | LEU296 | GLU32 | GLY327 | GLY328 | HIE329 |
| | HDAC9 | PHE851 | PHE913 | ASP91 | HIS919 | THR92 | PRO92 | LEU923 | GLU95 | GLY954 | GLY955 | HIS956 |
| Class | HDAC6 | TRP198 | PHE259 | ASP26 | ASP265 | PRO26 | — | LYS267 | GLU29 | GLY298 | GLY299 | TYR300 |
| IIb | HDAC6 | PHE199 | PHE260 | ASP26 | ASP266 | PRO26 | — | LEU268 | GLU29 | GLY299 | GLY300 | TYR301 |
| | HDAC1 | TRP203 | PHE264 | ASP26 | ASP270 | PRO27 | GLU27 | — | GLU30 | GLY303 | GLY304 | TYR305 |
| Class | HDAC1 | — | THR260 | ASP26 | ASP266 | ARG26 | — | LEU268 | SER301 | GLY302 | GLY303 | TYR304 |

“*” denotes the residues in the HDAC's rim region;
“\hat{ }” denotes those forming the central tube channel; and unmarked residues are those in the proximity of the catalytic Zn.
“*” residues correspond to red residues,
“\hat{ }” residues correspond to blue residues, and unmarked residues correspond to black residues according to the pharmacophoric model published previously (Mai, A., et al., 2005). The residues were selected using a PLS Coefficient threshold value of 0.001. See Supplemental File 2 for 3-D graphical disposition of the listed residues in each HDAC isoform.

Field ELE.

All residues selected having PLS Coeff. higher than 0.001, except for 398, showed positive values, indicating that all the electrostatic interaction are attractive (FIG. 5A). Indeed the PLS Coeff*StDev plot clearly indicates that all electrostatic interactions are positively contributing to the model. In particular, plots in FIG. 5 show that ELE field is definitively more important in the inner part (black-labeled residues) of the HDACs catalytic domains than for residues forming the channel (blue-labeled residues in FIG. 5) and those at the entrance rim (red-labeled residues in FIG. 5) where only four and five out of 27 residues displayed PLS Coefficients higher than the chosen threshold value.

In the outer part of the enzymes, the five selected residues (FIG. 5) do not show appreciable activity contributions highlighting that these parts are not associated with high variation in ligand/enzyme electrostatic interactions. Detectable negative values relate to small compounds (NABUT and VA) for which the model correctly records the missing contribution.

Regarding the channel-forming residues, 294 (at the edge between the channel and the bottom of the HDAC-binding sites) displayed the highest values in all three plots of FIG. 5. Indeed, this residue (a conserved histidine for all HDACs) is primarily involved in modulating the potency between small inhibitors (NABUT and VA) and channel-filling inhibitors (i.e. SAHA and TSA). For NABUT and VA, diminished interactions with residue 294 account for 0.8 to 1.0 decrement in activity. To some extent, the fact that either NABUT or VA are carboxylic acids indicates that higher negative charge (NABUT and VA were modeled as carboxylates, thus bearing a discrete negative formal charge) in proximity to residue 294 is unproductive. Analogous to a CoMFA analysis, the high PLS Coeff*StDev values for residue 294 represent a blue polyhedron, placed in the same space of 294, indicating that an enhanced negative charge decreases the overall activity, while a positive-charged group (or a less negative one) is preferred to maintain the activity (the maximum contribution associated with 294 is lower than 0.01). Among the other channel-forming selected residues 262 (always a Gly), 263 (mostly a Phe) and 264 (always a Cys), the most interesting is residue 263 involved in modulating the activity decrement for small compounds, in particular for VA.

Most of the ELE-selected residues (18 out of 27) are in the deep part of the channels around the catalytic Zn. Of particular interest are residues, involved in HDAC catalytic process conserved among the 12 isoforms, as follows: residues 253 (His), 254 (His), 292 (Asp), 392 (Asp) and 571 (Zn). In general the activity contribution associated with these five residues modulates the activity decrement for carboxylate-based zinc-binding groups. As examples, residues 253 (SAHA in HDAC1) and 254 (SAHA in HDAC3, HDAC4 and HDAC6-2; and SBHA in HDAC4 and HDAC8) are associated with a positive activity contribution of about 0.1.

Field DRY.

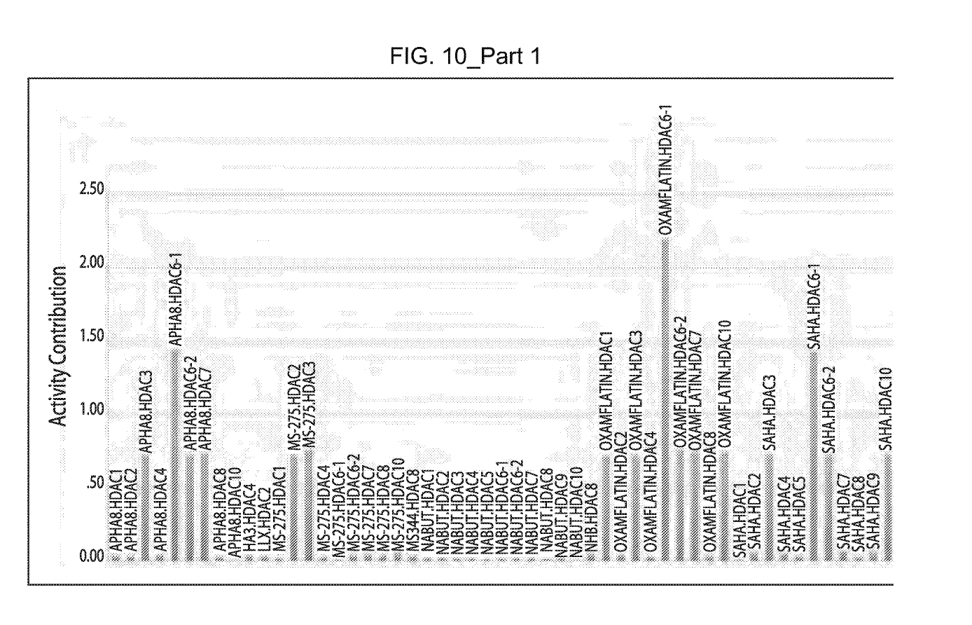

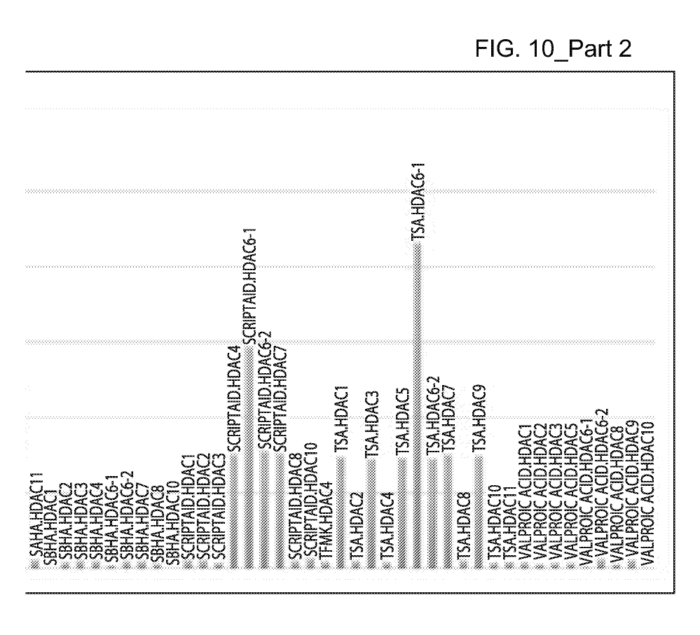

The DRY field gives a rough estimation of steric interactions. Between ELE and DRY selected residues about 35% of these are shared (12 out of 34) in significance, nevertheless, for the DRY field a totally different and more complicated scenario can be observed on the relative importance of each residue. In general, the most important modulating interaction relates to 401 Leu, replaced by Met in HDAC8 or by Lys in HDAC6-1 (Table 10). Upon deeper inspection (not considering the small-molecule complexes, NABUT, VA and NHB), only 27 of 94 activities are modulated by residue 401 with activity contributions ranging between 0.7 and 2.13 (Supplemental File 1, FIG. 10).

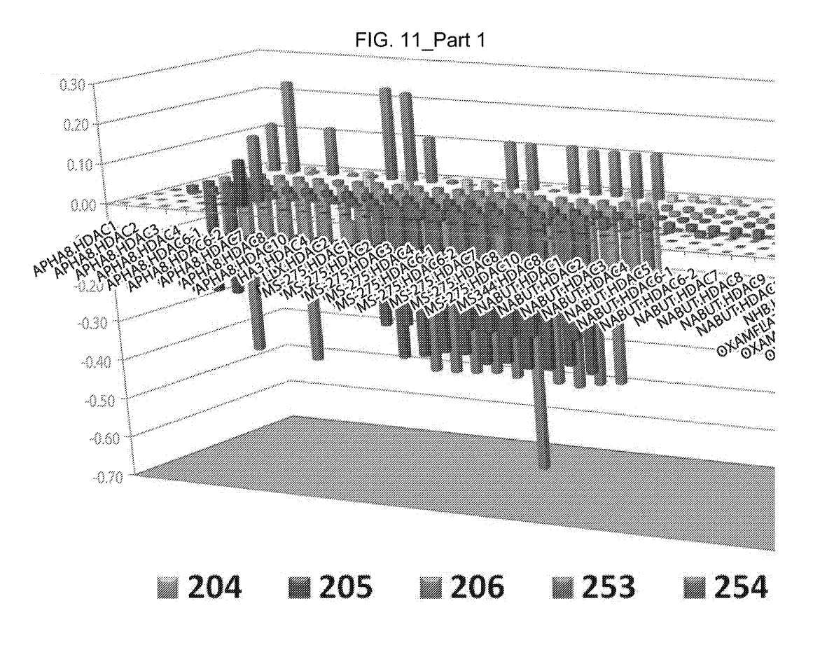

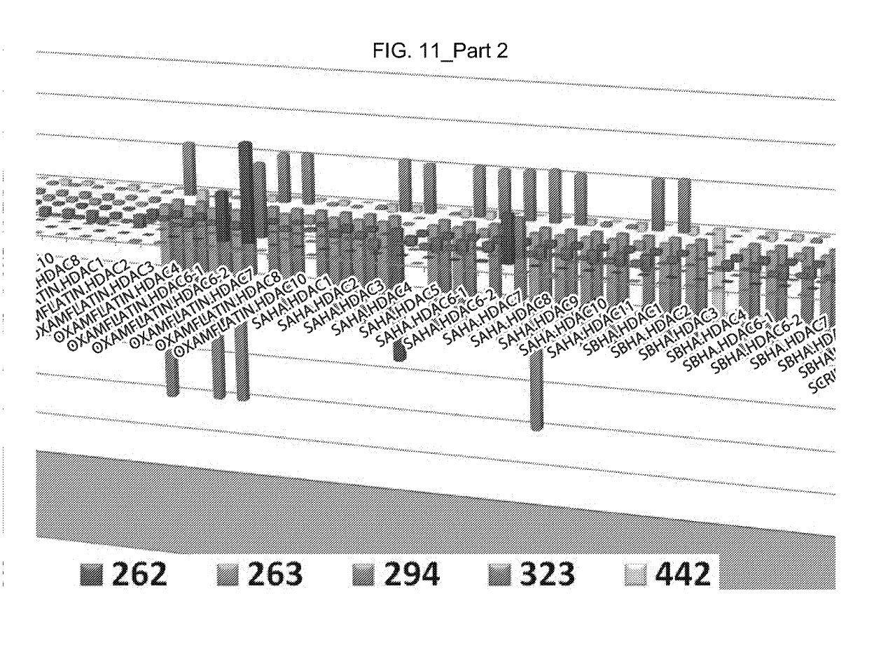

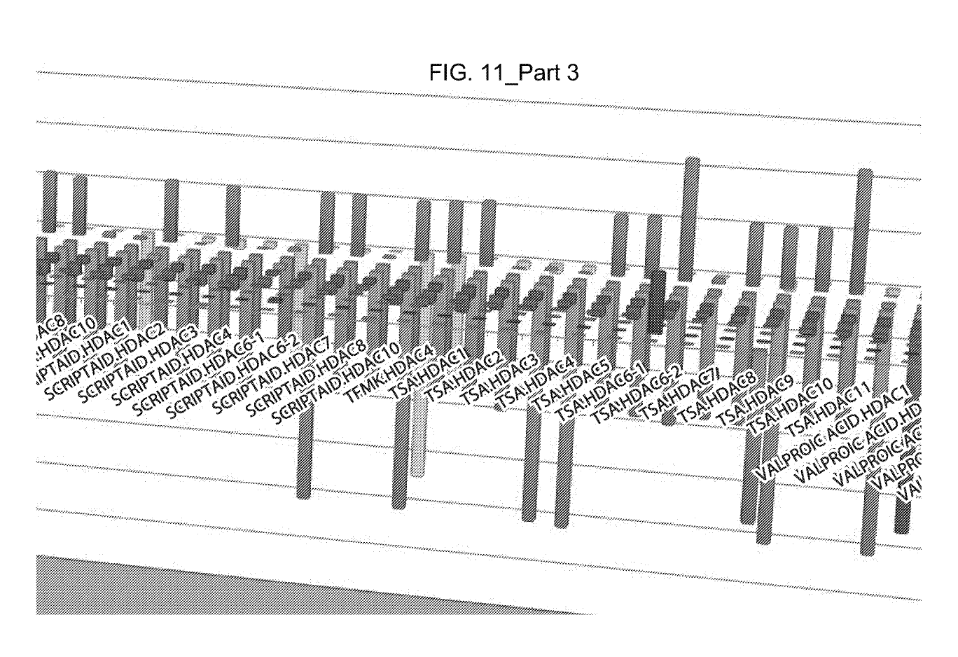

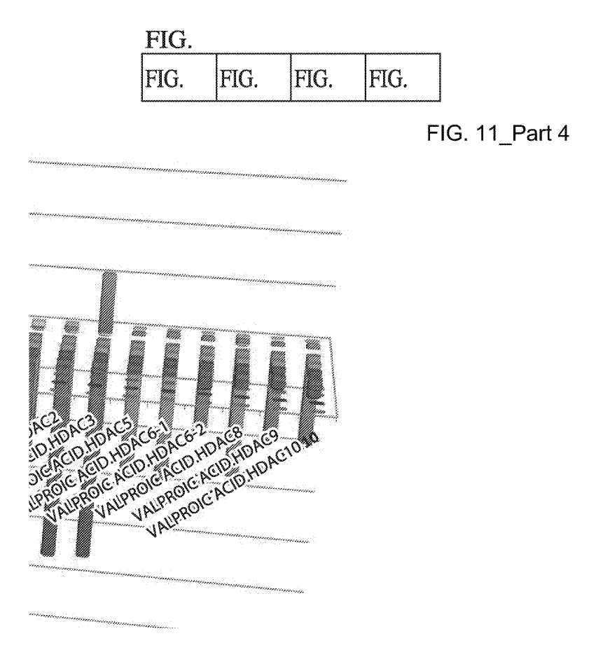

Without considering the contribution of residue 401, it is evident from the plot in FIG. 9B that the other 10 residues play a major role in modulating the overall biological activities (Supplemental File 1, FIG. 11, Table 11).

TABLE 11
Minimum, Maximum, standard deviation and range
of DRY-selected most important residues displaying
the higher absolute activity-contribution values.

| Residue # | Min Value | Max Value | St Dev | Range |
|---|---|---|---|---|
| 204 | 0.000 | −0.311 | 0.042 | 0.311 |
| 205 | 0.225 | 0.000 | 0.032 | 0.225 |
| 206 | 0.169 | 0.000 | 0.026 | 0.169 |
| 253 | 0.000 | −0.307 | 0.078 | 0.307 |
| 254 | 0.000 | −0.405 | 0.127 | 0.405 |
| 262 | −0.006 | −0.310 | 0.087 | 0.304 |
| 263 | 0.000 | −0.699 | 0.164 | 0.699 |
| 294 | 0.000 | −0.335 | 0.064 | 0.335 |
| 323 | 0.239 | 0.000 | 0.069 | 0.239 |
| 401 | 2.197 | 0.000 | 0.464 | 2.197 |
| 442 | 0.000 | −0.445 | 0.088 | 0.445 |

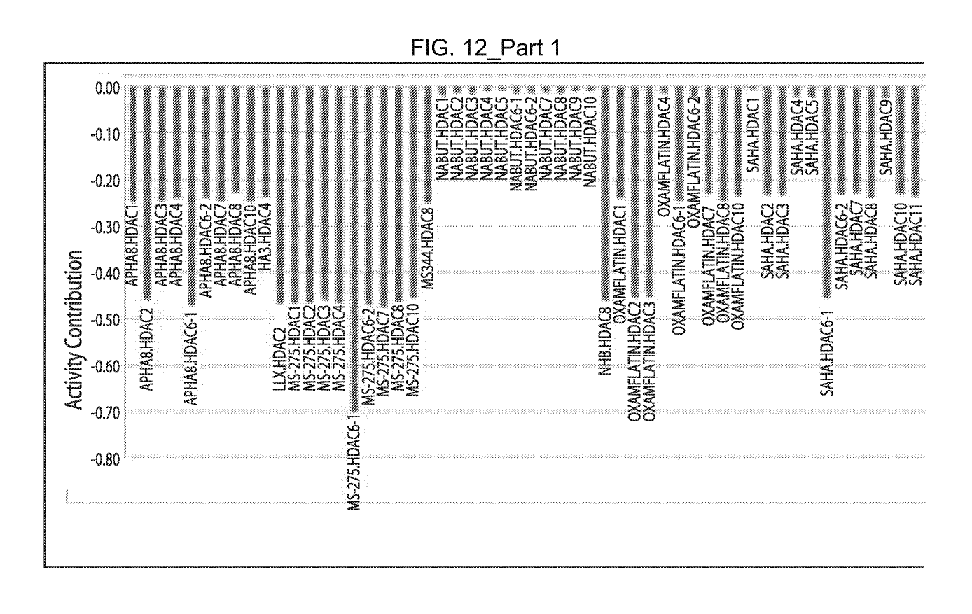

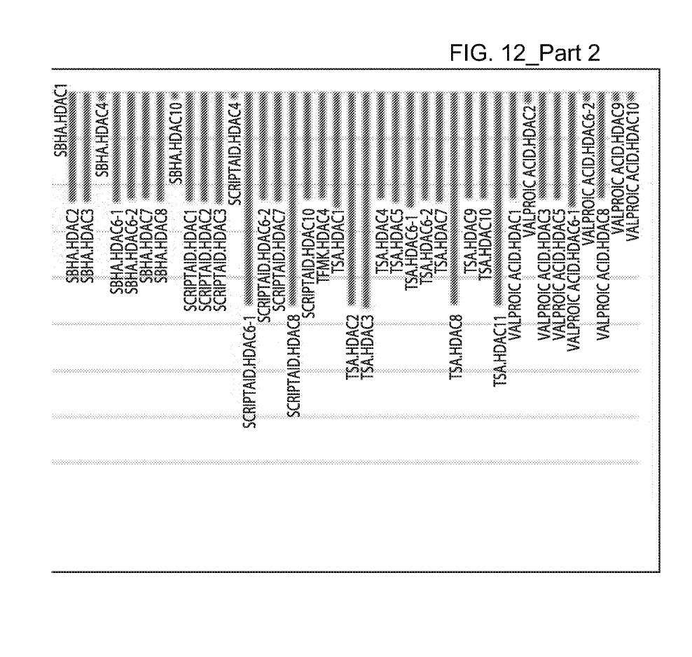

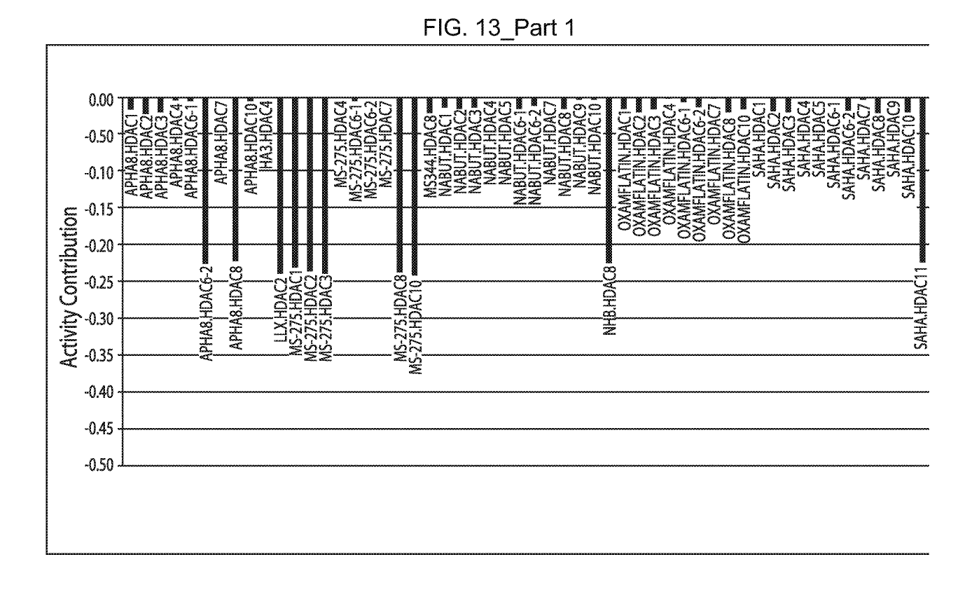

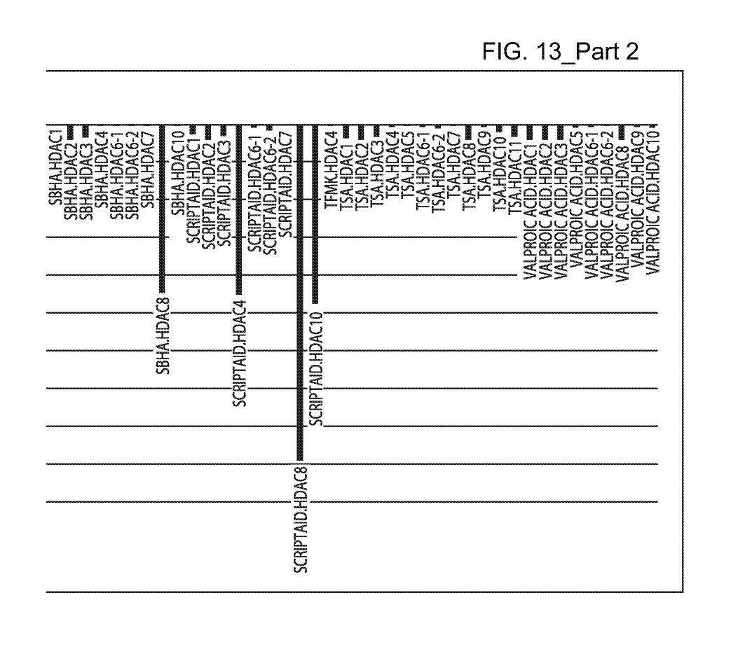

Seven out of 10 residues (204, 253, 254, 262, 263, 294 and 442) are related to negative modulating values, while the other three (205, 206 and 323) are positive modulators. Residue 263 (Tyr for HDAC6-1 and Phe for the others) located in the wall of the channel shows the largest range with larger negative values. No specific pattern is detected for residue 263 in modulating regarding the different enzyme classes or inhibitor structures (Supplemental File 1, FIG. 12). The small inhibitor NABUT is not influenced by residue 263, likely due to the fact that there are no direct contacts. Residue 442 (His for Class IIa and Tyr for the others) located in the bottom of the binding sites shows the largest range with larger negative values associated mainly with class I complexes, with particular reference to HDAC8 (Supplemental File 1, FIG. 13) thus suggesting that interaction with this residues might be used to selectively avoid inhibition of HDAC8.

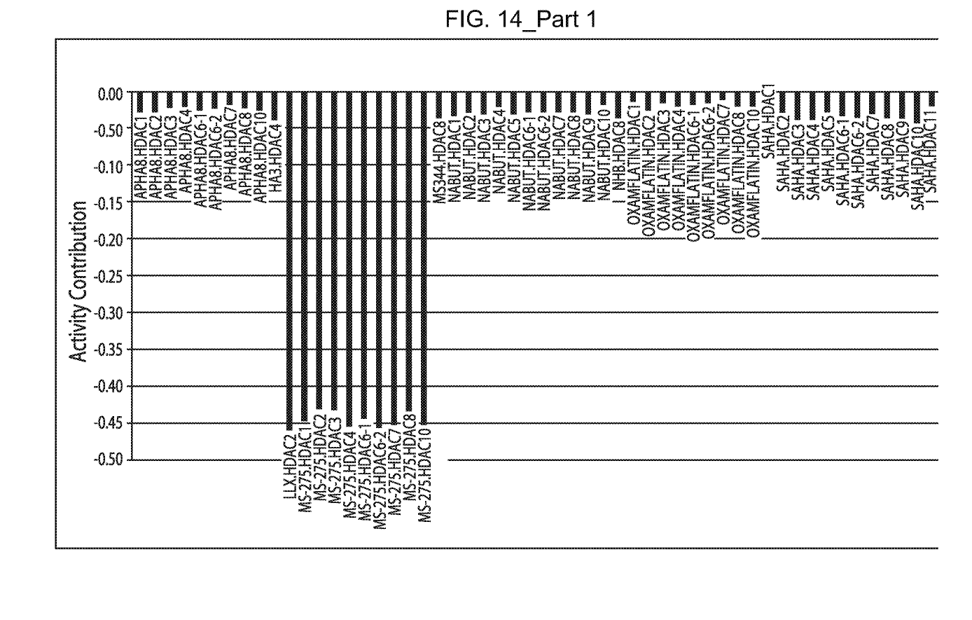

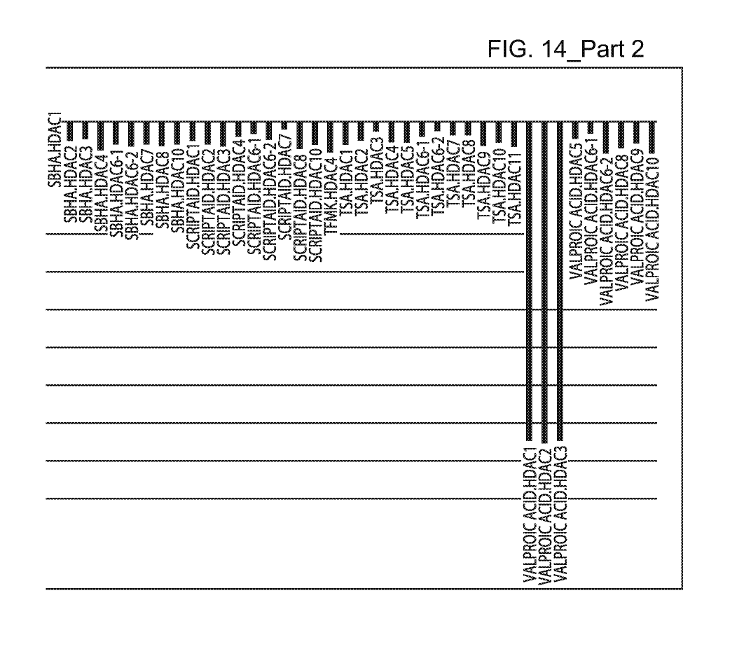

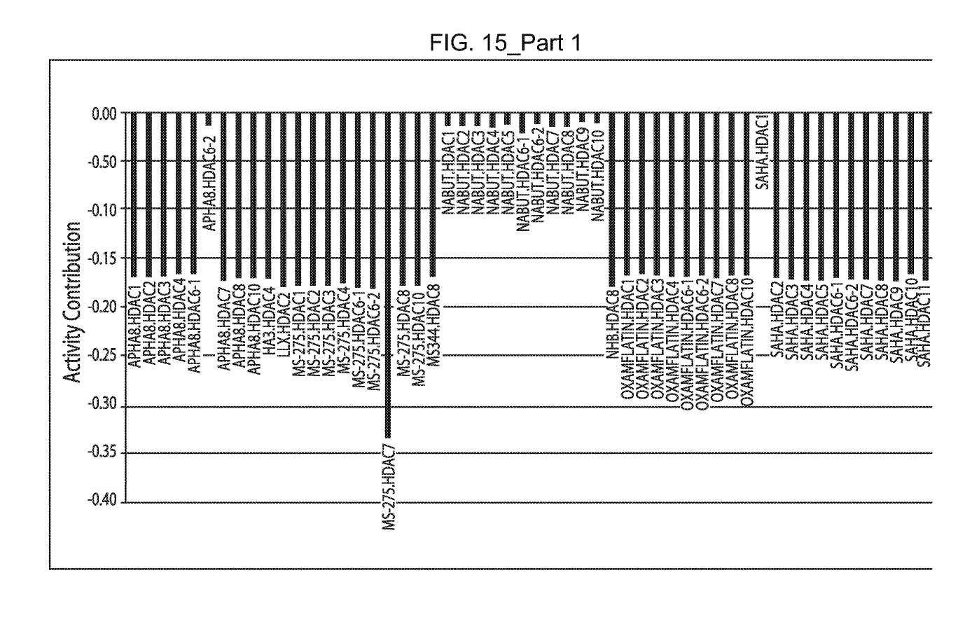

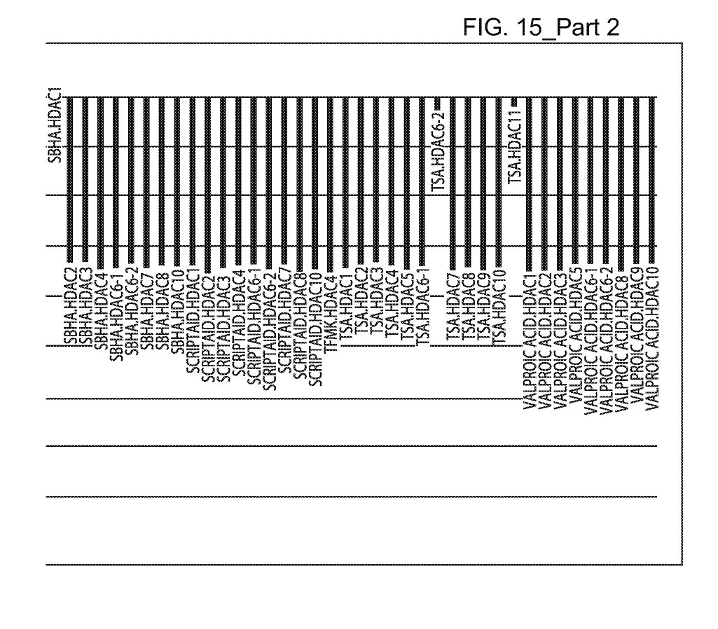

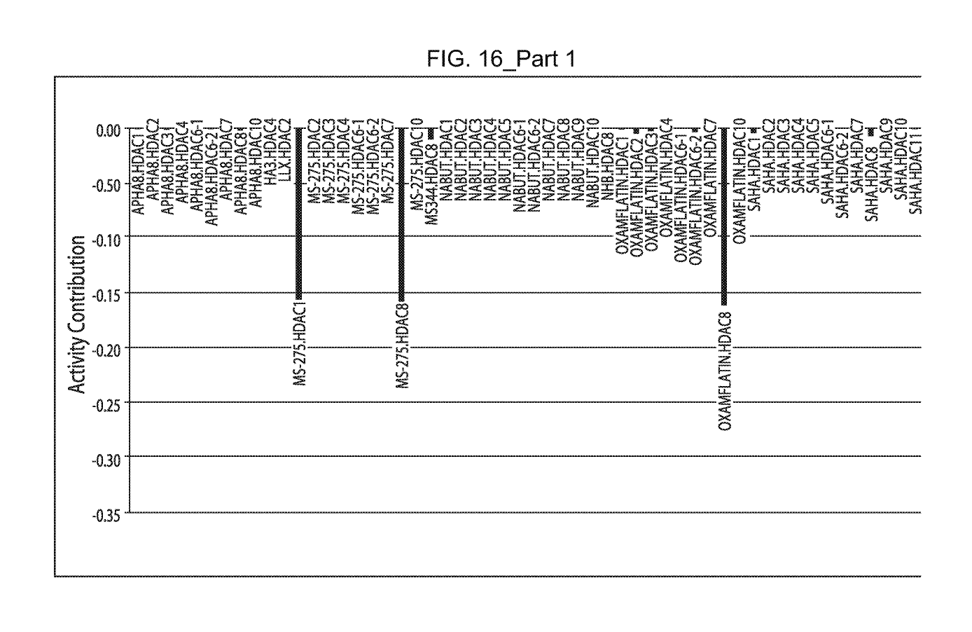

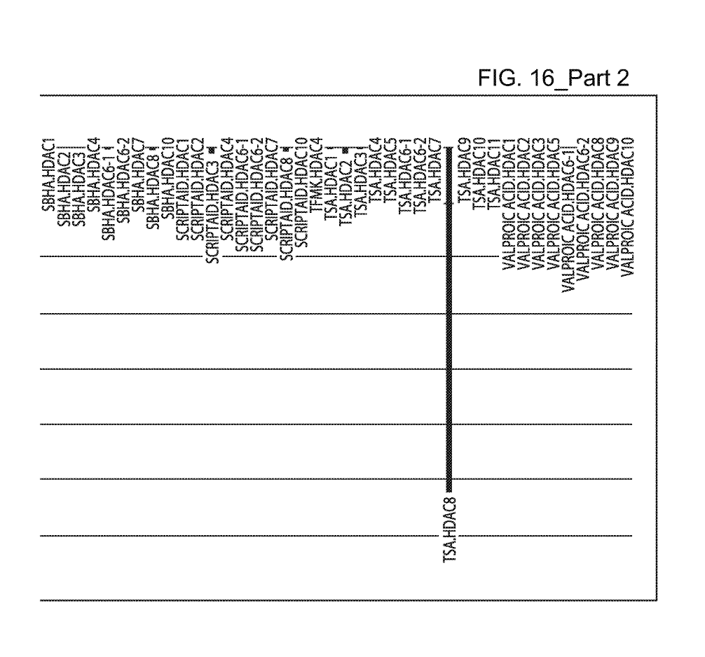

Residue 254 (His in the zinc-binding region) is second with the higher StDev value and from FIG. 14 clearly negatively modulates mainly non-hydroxamate inhibitors making complexes (LLX, MS-275 and VA) consistently with that reported for the ELE field. Residue 204 (of various nature present on the rim of 6 out of 12 HDACs) and 294 (His, a channel-forming residue) are also negative-modulating residues, but the associated low standard deviation indicates that no selectivity can be attributed to the DRY interactions (FIGS. 15-16); residue 204 seems to specifically modulate the inhibitory activity for HDAC8 complexes (FIG. 16). Considering the high correlation between DRY and STE, interactions with residues 263 and 294 are of crucial importance for optimal fitting of inhibitors in the HDAC channels.

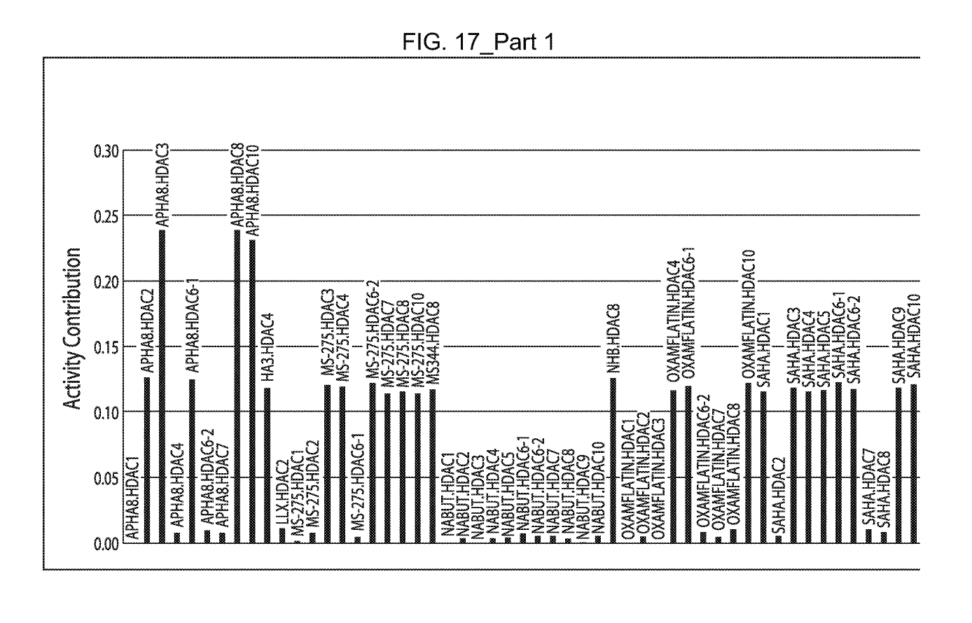

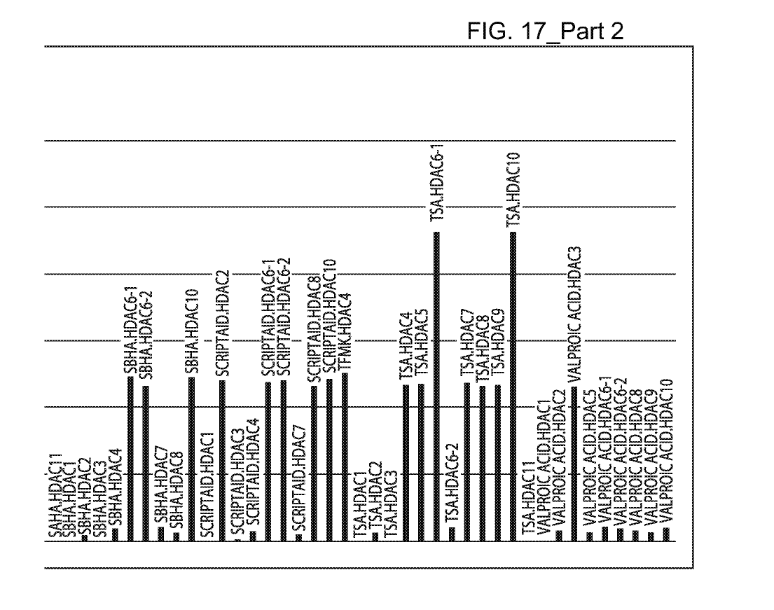

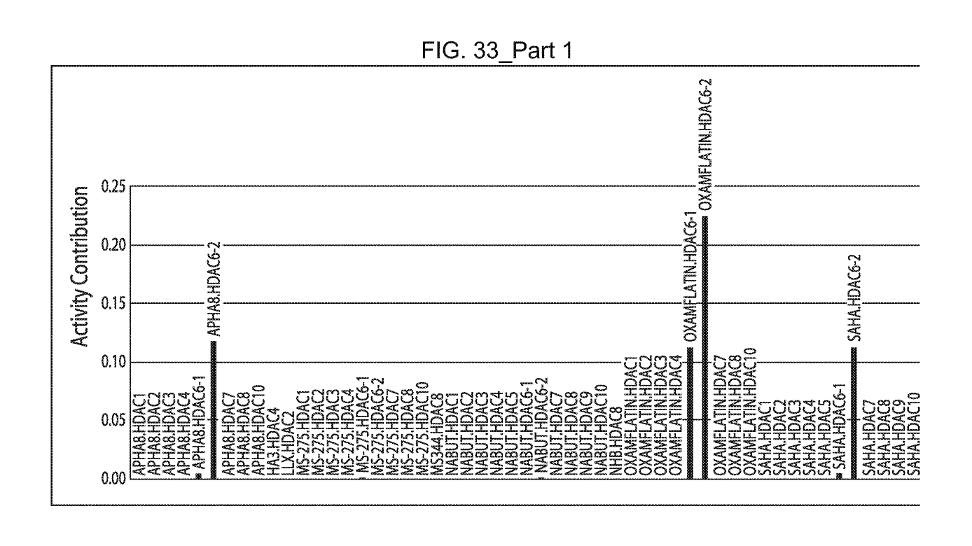

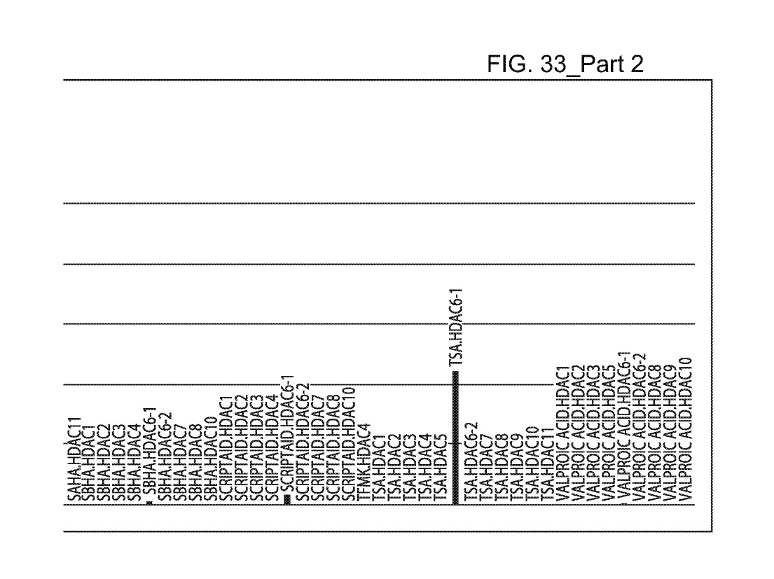

Among the three DRY positive-modulating residues, 323, an aromatic side-chain-bearing residue missing in HDAC1 and HDAC11, shows the highest maximum-activity contribution and larger variability; maximum-activity contributions occur with APHA8 and TSA binding to either class I or class II enzymes (FIG. 17). The other highly positively contributing residue 205 is peculiar for HDAC6-1 (Tyr85) and thus uniquely modulates inhibition of this enzyme (FIG. 33).

Analysis of Interactions Contributing to Isoform Selectivity.

Interaction- and activity-contribution analyses suggest that useful insight into structural determinants exists for both HDAC isoforms and their inhibitors to help optimize isoform-specific inhibitors using the derived DISCRIMINATE model. Derivation of rules to guide the structural basis for isoform selectivity required single analysis for each specific isoform model. For nine of the inhibitors used in the training set (Table 4), at least 9 out of 12 isoform-inhibition profiles were available (Table 12, Supplemental File 1).

TABLE 12
Bioactivity ranges (ΔpIC₅₀) for inhibitors with activities profiled
with several HDAC isoforms.

| Inhibitor | DpIC₅₀ | StDev | # of Activities |
|---|---|---|---|
| APHA8 | 1.87 | 0.72 | 9 |
| MS-275 | 2.63 | 0.88 | 9 |
| NABUT | 1.95 | 0.78 | 11 |
| OXAMFLATIN | 2.34 | 0.66 | 9 |
| SAHA | 2.04 | 0.65 | 12 |
| SBHA | 1.66 | 0.63 | 9 |
| SCRIPTAID | 2.76 | 0.93 | 9 |
| TSA | 2.34 | 0.66 | 12 |
| VALPROIC ACID | 0.95 | 0.35 | 9 |

In Supplemental File 3 are reported the recalculated activity profiles for each of the nine inhibitors of Table 4 showing the models sensitivity to HDAC-isoform inhibition by different compounds. To illustrate the DISCRIMINATE model's potential use, two inhibitors were selected seeking potential structure determinants for isoform selectivity. Among the training set, analysis on the activity range indicated MS-275 and SCRIPTAID as good examples. From Supplemental File 1, Table 12, MS-275 and

SCRIPTAID display large variability, and from Table 4 MS-275 results partially selective for class I HDACs (particularly for HDAC3 IC₅₀=0.07 μM and HDAC2 IC₅₀=0.5 μM), while SCRIPTAID is partially selective for class II displaying sub-micromolar activities against these enzymes.

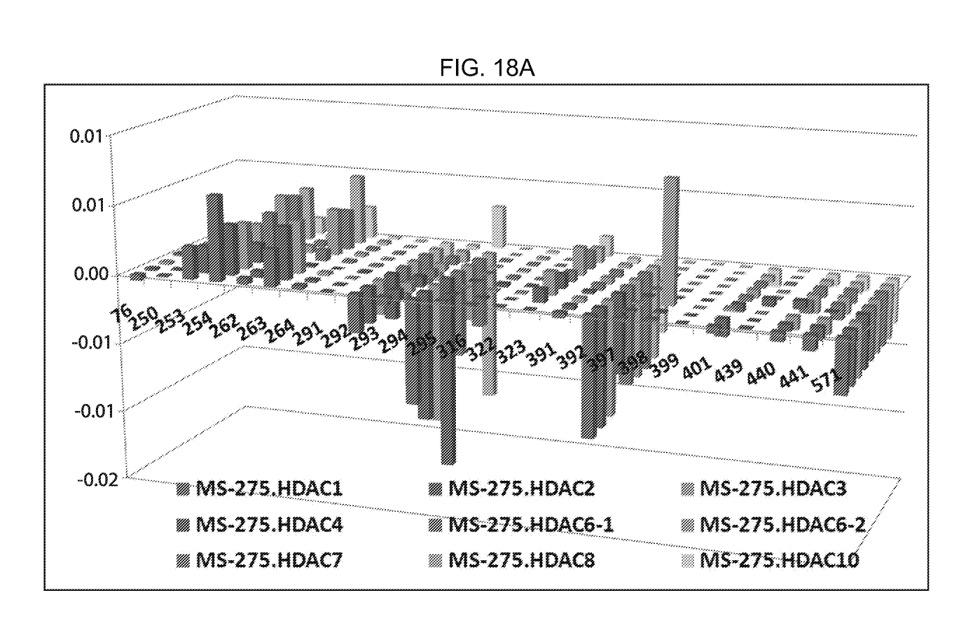

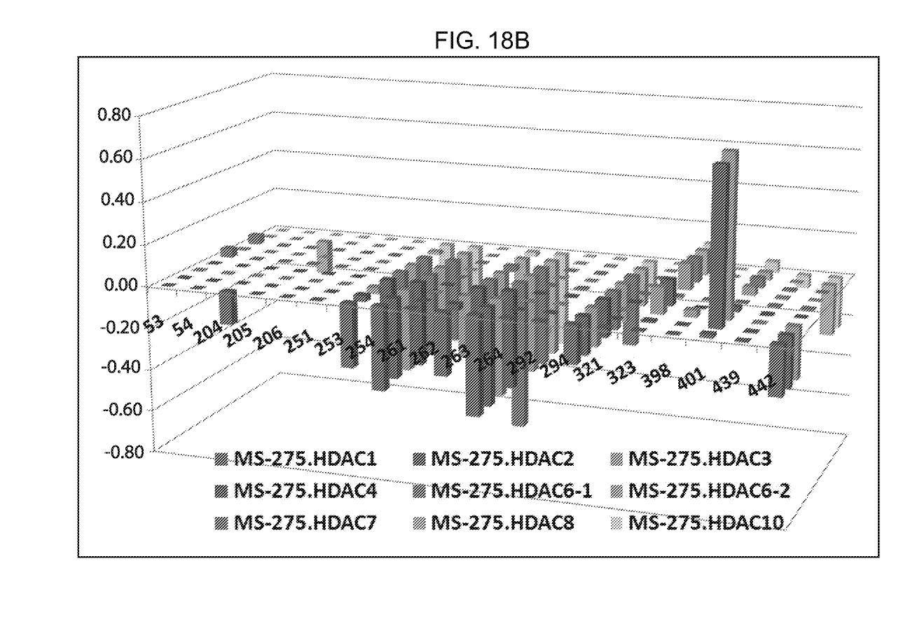

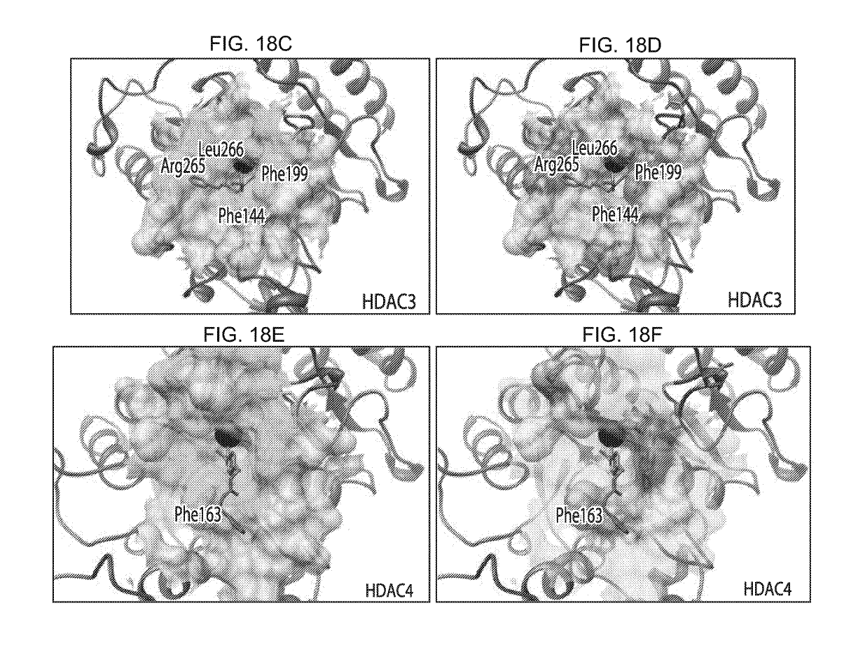

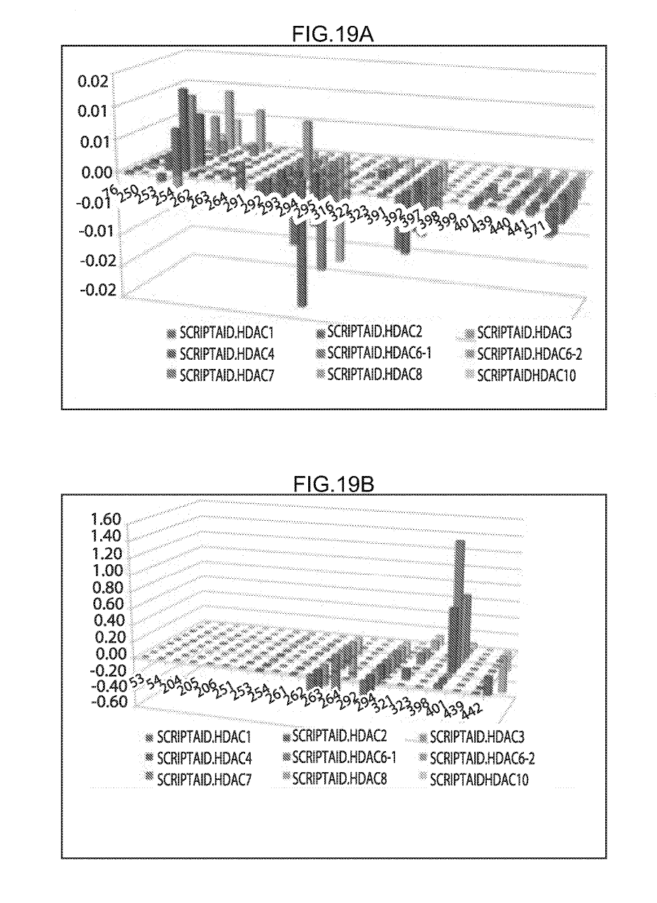

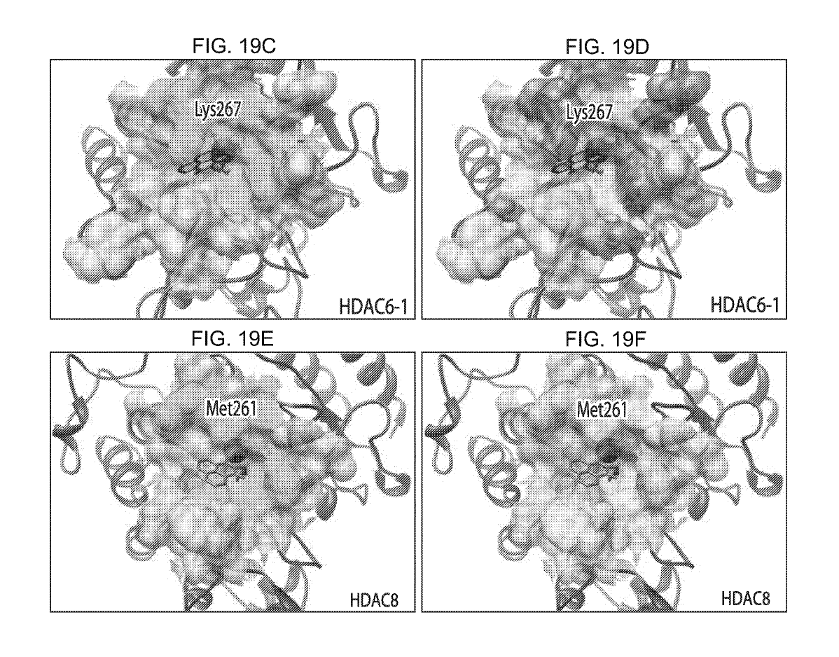

MS-275. This inhibitor is specifically selective for class I HDAC3 over class IIa HDAC4 and comparison of data belonging to the relative complexes shows how the model helps rationalize the higher activity of MS-275 for HDAC3 versus HDAC4. As shown in FIG. 18, it is possible to indicate, either numerically or graphically, the residues responsible for this activity difference. Considering electrostatic interactions, it is evident that, as already above highlighted, there is very low correlation with activity, and only gray or light blue surfaces can be observed in FIGS. 19C, 19E (see FIG. 18 description for color coding). On the other hand, the DRY field seems very sensitive as shown in FIGS. 18D, 18F; there is a high color variation clearly indicating those residues responsible for the higher activity of MS-275 against HDAC3 (Phe199 and Arg265 are dark green). Other green-colored residues are also located around the rim, for example, Leu266. A few residues are colored yellow, residue 263 (Phe144 in FIG. 18D) indicating that MS-275 anti-HDAC3 activity could be improved by optimizing the interactions in the enzyme channel. Going to the MS-275/HDAC4 complex, many DRY surfaces have turned from green to yellow thus highlighting that residue 263 (HDAC4-Phe163) plays a major role in decreasing activity with many residues showing zero activity contribution.

SCRIPTAID.

SCRIPTAID was chosen as a selective class II inhibitor. Similarly to MS-275, the electrostatic interactions differentiated when comparing the activity contributions of HDAC6 and HDAC8 (FIG. 19). Indeed, FIG. 19A clearly indicates that the ELE contributions are below 0.02. So analogously to MS-275, DRY terms help rationalize the inhibitory activities of SCRIPTAID with HDAC6 and HDAC8. Most differences are located in the rim zone. Specifically, Lys267 in HDAC6 is responsible of a strong positive contribution, while Met261, its counterpart in HDAC8, displays a much smaller contribution.

Docking Assessment.

X-ray structures of HDAC-inhibitors were used to evaluate the ability of a docking program to predict the correct geometry of protein-ligand complex (Redocking). To this aim, two different docking programs were tested: AutoDock Ver. 4.2 and AutoDockVina Ver. 1.1. Docking results were assessed with RMSD (root-mean-square deviation) of the predicted ligand configuration versus the crystal structure. Tables 13 and 14 show RMSD values for best docked (the lowest energy docked conformation of the first cluster generated), best cluster (the lowest energy docked conformation of the most populated cluster) and best fit (the lowest energy conformation of the cluster showing the lowest RMSD value) (Musmuca, I., et al., 2010), obtained with the two programs. In all cases AutoDockVina was found to be more accurate displaying a docking accuracy (DA) of 75% for the best cluster poses (Tables 13 and 14). AutoDockVina was able to predict the right binding disposition of all ligands with a RMSD<3 Å. From Tables 13 and 14, the best cluster conformation displayed the lowest RMSD values. For subsequent dockings, therefore, only the AutoDockVina program was used considering the best cluster conformation as the first choice. Considering the Best Fit pose, AutoDockVina proved to be able to find the correct binding mode with a DA of 100%. Although the Best Fit poses is irrelevant for the docking applicability, it further supported that AutoDockVina is quite good in searching for the right conformation, but the scoring function is not able to select it. For docking, the side-chain flexibility features of AutoDock and AutoDockVina were not used as the results were always worse than in fixed receptor dockings in preliminary docking studies.

TABLE 13
Redocking results (RMSD) with AutoDock program.

| Complex name | Best docked | Best Cluster | Best Fit |
|---|---|---|---|
| LLX.HDAC2 | 0.48 | 0.48 | 0.48 |
| HA3.HDAC4 | 5.25 | 4.76 | 4.4 |
| TMFK.HDAC4 | 3.46 | 5.75 | 3.46 |
| SAHA.HDAC7 | 10.36 | 10.36 | 2.18 |
| TSA.HDAC7 | 6.06 | 6.06 | 1.4 |
| APHA.HDAC8 | 5.4 | 2.26 | 2.26 |
| SAHA.HDAC8 | 5.84 | 7.29 | 4.1 |
| TSA.HDAC8 | 5.1 | 5.52 | 1.45 |
| DA % | 12.5 | 18.75 | 50 |

TABLE 14
Redocking results (RMSD) with AutoDockVina program.

| Complex name | Best docked | Best Cluster | Best Fit |
|---|---|---|---|
| LLX.HDAC2 | 0.24 | 0.24 | 0.24 |
| HA3.HDAC4 | 3.87 | 2.34 | 1.93 |
| TMFK.HDAC4 | 4.02 | 1.9 | 1.46 |
| SAHA.HDAC7 | 2.45 | 2.45 | 1.88 |
| TSA.HDAC7 | 2.19 | 2.19 | 1.21 |
| APHA.HDAC8 | 1.43 | 1.43 | 1.43 |
| SAHA.HDAC8 | 2.49 | 2.49 | 1.72 |
| TSA.HDAC8 | 2.09 | 1.22 | 1.22 |
| DA % | 50 | 75 | 100 |

Model Predictivity.

Once the docking protocols were assessed, cross-docking approach was applied to the MTS, CTS and LTS test sets of inhibitors to prepare the HDAC-x complexes.

Modeled Test Set.

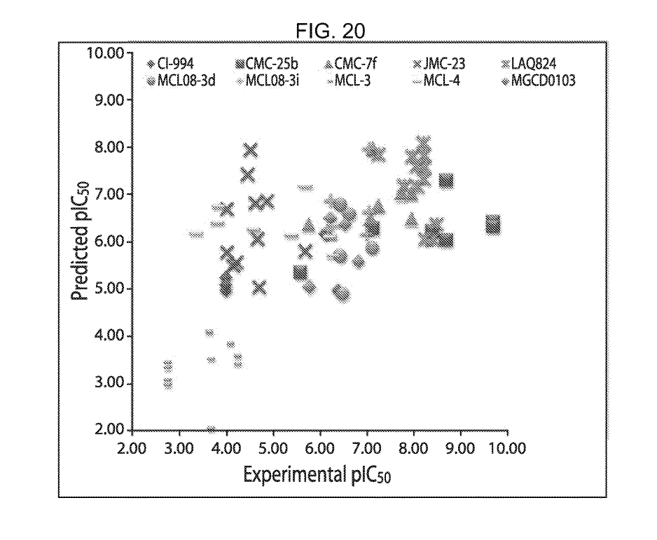

Regarding the MTS, all minimized HDAC structures were used as templates for docking simulations. Thus, each inhibitor of Table 6 was docked into all receptor binding sites, a total of 304 individual docking simulations. For each isoform, all poses were collected in a bin and the output poses clustered by means of the AutoDock program. It was found that AutoDockVina had the ability to reproduce the experimental binding modes with modest errors (Table 14); in some cases, the best cluster conformation was found in a non-active pose (i.e. the zinc-binding group rotated away from the Zn ion). This clearly indicated the limitations of the docking protocol in selecting the correct poses. In these cases, either the best-docked pose or an arbitrary-chosen conformation on the basis of Zn chelation that mimicking the binding mode of closest-related experimentally bound inhibitor was used. This approach is consistent with the fact that AutoDock Vina proved to be able to find the right binding mode (see comments for the Best Fit pose in Docking Assessment section). For MTS, a total of 76 HDAC-inhibitors complexes were compiled, and the ELE+DRY DISCRIMINATE model was used to predict inhibitors activities. FIG. 20 and Table 15 show the pIC50 predicted for the MTS external test set and statistical results (SDEPₑₓₜ and AAEP). Model showed a good external predictivity with SDEP of 1.41 for the optimal 2 principal components. FIG. 20 reveals that JMC-23 and MCL-4 are the worst predicted compounds. JMC-23 contains an oxime amide as a ZBG (Zn binding group) that can be interpreted as a modified version of the efficient hydroxamate moiety. As reported by Botta et al. (Botta, C. B., et al., 2011), this compound is a poor pan-HDAC inhibitor, the DISCRIMINATE model fails in predicting correctly 5 out of 11 activities. Regarding MCL-4, this is the hydroxamate version of MCL-3, while the latter is recognized as a very poor inhibitor with the correct trend, MCI-4 is highly over predicted in HDAC4, HDAC5, HDAC7 and HDAC9 complexes. Nevertheless the average pIC₅₀ value for MCL-4 (Exp.=5.18, Pred.=6.31) was correctly calculated to be higher than that for MCL-3 (Exp.=3.40, Pred.=3.33).

TABLE 15
Predicted pIC₅₀ for the MTS. The SDEP and the average absolute error of predictions (AAEP)
are reported for all the first five PCs. AAEP are also reported for each HDAC isoform.

| | | | | Principal Components | | | | |
|---|---|---|---|---|---|---|---|---|
| | | | | 1 | 2 | 3 | 4 | 5 |
| | | | | SDEPₑₓₜ | | | | |
| | | | | 1.44 | 1.41 | 1.47 | 1.59 | 1.60 |
| | | | | Average Absolute Error of Prediction | | | | |
| Enzyme | | Reference | | 1.13 | 1.10 | 1.16 | 1.25 | 1.25 |
| source | InhibitorName | Complex | Exp. | 1 comps | 2 comps | 3 comps | 4 comps | 5 comps |
| SwissModel | MCL-3 | OXAMFLATIN-HDAC1 | 4.19 | 3.91 | 3.42 | 3.52 | 3.24 | 3.16 |
| ModWeb | JMC-23 | MS-275-HDAC1 | 4.71 | 6.51 | 5.04 | 5.11 | 4.64 | 4.54 |
| SwissModel | MCL-4 | OXAMFLATIN-HDAC1 | 6.22 | 6.49 | 6.11 | 6.13 | 6.18 | 6.00 |
| CPH | MCL08-3i | OXAMFLATIN-HDAC1 | 6.24 | 6.81 | 6.88 | 7.40 | 7.52 | 7.76 |
| CPH | CI-994 | MS-275-HDAC1 | 6.39 | 6.52 | 4.97 | 5.07 | 5.00 | 5.08 |
| ModWeb | MCL08-3d | MS-275-HDAC1 | 6.50 | 6.63 | 4.90 | 4.66 | 3.98 | 3.79 |
| ModWeb | MGCD0103 | MS-275-HDAC1 | 6.82 | 7.21 | 5.58 | 5.46 | 4.96 | 4.78 |
| CPH | CMC-7f | SAHA-HDAC1 | 7.24 | 6.32 | 6.75 | 6.59 | 6.69 | 6.16 |
| CPH | CMC-25b | APHA8-HDAC1 | 8.40 | 6.58 | 6.23 | 6.47 | 6.56 | 6.58 |
| ModWeb | LAQ824 | MS-275-HDAC1 | 8.49 | 7.77 | 6.37 | 6.27 | 6.00 | 5.92 |
| AAEP | | | | 0.70 | 1.09 | 1.17 | 1.30 | 1.45 |
| Crystal | JMC-23 | LLX-HDAC2 | 4.16 | 6.91 | 5.50 | 4.88 | 4.20 | 4.36 |
| Crystal | MCL-3 | LLX-HDAC2 | 4.19 | 3.86 | 3.58 | 3.89 | 3.68 | 3.85 |
| Crystal | MCL-4 | LLX-HDAC2 | 6.22 | 6.72 | 6.09 | 5.88 | 5.80 | 5.74 |
| Crystal | MGCD0103 | LLX-HDAC2 | 6.54 | 7.56 | 6.37 | 6.55 | 6.21 | 6.42 |
| Crystal | CMC-25b | LLX-HDAC2 | 7.13 | 6.79 | 6.28 | 6.72 | 7.01 | 7.34 |
| Crystal | CMC-7f | NABUT-HDAC2 | 7.13 | 6.88 | 7.95 | 8.01 | 8.00 | 8.18 |
| Crystal | LAQ824 | LLX-HDAC2 | 7.80 | 8.02 | 7.18 | 6.75 | 6.17 | 6.26 |
| AAEP | | | | 0.77 | 0.65 | 0.53 | 0.56 | 0.56 |
| CPH | MCL-3 | TSA-HDAC3 | 3.59 | 4.24 | 4.08 | 4.14 | 4.19 | 4.37 |
| CPH | MCL-4 | TSA-HDAC3 | 5.70 | 6.70 | 7.16 | 7.14 | 7.21 | 7.32 |
| CPH | JMC-23 | TSA-HDAC3 | 5.70 | 7.01 | 5.80 | 4.72 | 3.64 | 3.80 |
| SwissModel | MGCD0103 | MS-275-HDAC3 | 5.78 | 7.17 | 5.04 | 4.70 | 3.97 | 3.73 |
| CPH | CI-994 | MS-275-HDAC3 | 6.13 | 6.71 | 6.16 | 5.75 | 5.25 | 5.23 |
| CPH | MCL08-3i | MS-275-HDAC3 | 6.17 | 6.81 | 6.26 | 5.76 | 5.31 | 5.52 |
| CPH | MCL08-3d | MS-275-HDAC3 | 6.64 | 6.83 | 6.58 | 6.12 | 5.71 | 5.87 |
| CPH | CMC-7f | MS-275-HDAC3 | 7.75 | 6.86 | 7.01 | 6.91 | 6.82 | 7.21 |
| CPH | LAQ824 | TSA-HDAC3 | 7.98 | 7.39 | 7.80 | 7.35 | 7.60 | 8.14 |
| CPH | CMC-25b | SBHA-HDAC3 | 8.70 | 6.77 | 7.29 | 7.73 | 8.22 | 8.61 |
| CPH | MCL-3 | TSA-HDAC3 | 3.59 | 4.24 | 4.08 | 4.14 | 4.19 | 4.37 |
| AAEP | | | | 0.92 | 0.53 | 0.78 | 1.04 | 0.94 |
| Crystal | MCL-3 | HA3-HDAC4 | 2.70 | 3.91 | 3.34 | 2.52 | 2.70 | 3.08 |
| Crystal | MCL-4 | SAHA-HDAC4 | 3.85 | 6.47 | 6.73 | 6.42 | 6.51 | 6.38 |
| Crystal | JMC-23 | MS-275-HDAC4 | 4.23 | 6.65 | 5.56 | 6.08 | 6.30 | 6.46 |
| Crystal | MCL08-3i | HA3-HDAC4 | 7.01 | 6.47 | 6.17 | 6.81 | 7.52 | 7.79 |
| Crystal | MCL08-3d | MS-275-HDAC4 | 7.12 | 6.52 | 5.87 | 5.63 | 5.56 | 5.57 |
| Crystal | LAQ824 | MS-275-HDAC4 | 8.24 | 7.52 | 7.59 | 7.46 | 7.24 | 7.19 |
| AAEP | | | | 1.35 | 1.26 | 1.18 | 1.30 | 1.42 |
| ModWeb | MCL-3 | OXAMFLATIN-HDAC5 | 2.70 | 4.01 | 3.44 | 3.05 | 3.28 | 3.52 |
| CPH | MCL-4 | VALPROIC ACID-HDAC5 | 4.60 | 6.33 | 6.25 | 5.99 | 5.95 | 5.67 |
| SwissModel | JMC-23 | TSA-HDAC5 | 4.68 | 6.64 | 6.06 | 6.93 | 7.62 | 7.93 |
| M4T | LAQ824 | VALPROIC ACID-HDAC5 | 7.25 | 7.34 | 7.85 | 7.25 | 6.69 | 6.65 |
| AAEP | | | | 1.27 | 1.09 | 1.00 | 1.36 | 1.44 |
| SwissModel | MCL-3 | SCRIPTAID-HDAC6-1 | 3.62 | 4.02 | 3.52 | 3.42 | 3.49 | 4.18 |
| SwissModel | CI-994 | MS-275-HDAC6-1 | 4.00 | 6.66 | 4.97 | 4.43 | 3.94 | 4.34 |
| ModWeb | JMC-23 | APHA8-HDAC6-1 | 4.03 | 6.72 | 5.78 | 5.22 | 4.36 | 4.08 |
| CPH | MCL-4 | APHA8-HDAC6-1 | 6.30 | 6.43 | 5.69 | 5.67 | 5.91 | 6.33 |
| ModWeb | MCL08-3d | SCRIPTAID-HDAC6-1 | 6.44 | 6.57 | 5.70 | 5.26 | 4.90 | 4.78 |
| ModWeb | MCL08-3i | SAHA-HDAC6-1 | 7.05 | 7.22 | 7.97 | 8.51 | 8.45 | 8.99 |
| CPH | CMC-7f | VALPROIC ACID-HDAC6-1 | 7.96 | 6.99 | 6.47 | 5.84 | 5.73 | 6.15 |
| CPH | LAQ824 | APHA8-HDAC6-1 | 8.23 | 7.77 | 7.33 | 7.00 | 6.70 | 7.11 |
| CPH | CMC-25b | APHA8-HDAC6-1 | 9.70 | 7.00 | 6.41 | 6.45 | 6.24 | 6.58 |
| SwissModel | MCL-3 | SCRIPTAID-HDAC6-1 | 3.62 | 4.02 | 3.52 | 3.42 | 3.49 | 4.18 |
| SwissModel | CI-994 | MS-275-HDAC6-1 | 4.00 | 6.66 | 4.97 | 4.43 | 3.94 | 4.34 |
| AAEP | | | | 1.15 | 1.20 | 1.30 | 1.23 | 1.18 |
| SwissModel | MCL-3 | OXAMFLATIN-HDAC6-2 | 3.62 | 3.26 | 2.05 | 1.49 | 1.62 | 1.99 |
| SwissModel | CI-994 | APHA8-HDAC6-2 | 4.00 | 6.47 | 5.24 | 4.78 | 4.22 | 3.83 |
| M4T | JMC-23 | APHA8-HDAC6-2 | 4.03 | 6.96 | 6.69 | 6.51 | 6.27 | 6.53 |
| CPH | MCL-4 | SAHA-HDAC6-2 | 6.30 | 6.45 | 6.34 | 5.96 | 5.91 | 5.80 |
| SwissModel | MCL08-3d | NABUT-HDAC6-2 | 6.44 | 6.52 | 6.78 | 6.73 | 6.53 | 6.40 |
| M4T | MCL08-3i | SCRIPTAID-HDAC6-2 | 7.05 | 6.94 | 6.64 | 6.48 | 6.25 | 6.52 |
| CPH | CMC-7f | OXAMFLATIN-HDAC6-2 | 7.96 | 6.71 | 7.02 | 6.04 | 5.27 | 5.21 |
| CPH | LAQ824 | MS-275-HDAC6-2 | 8.23 | 7.38 | 7.84 | 7.71 | 7.50 | 7.89 |
| M4T | CMC-25b | SAHA-HDAC6-2 | 9.70 | 6.68 | 6.31 | 6.17 | 6.16 | 6.44 |
| AAEP | | | | 1.25 | 1.22 | 1.39 | 1.41 | 1.30 |
| Crystal | MCL-3 | MS-275-HDAC7 | 2.70 | 3.87 | 2.98 | 2.37 | 2.39 | 2.84 |
| Crystal | MCL-4 | TSA-HDAC7 | 3.82 | 6.44 | 6.39 | 6.35 | 6.51 | 6.54 |
| Crystal | JMC-23 | TSA-HDAC7 | 4.53 | 6.96 | 7.94 | 7.87 | 7.61 | 7.77 |
| Crystal | LAQ824 | MS-275-HDAC7 | 8.21 | 7.79 | 8.09 | 8.58 | 8.64 | 8.87 |
| AAEP | | | | 1.66 | 1.59 | 1.64 | 1.63 | 1.69 |
| Crystal | CI-994 | SBHA-HDAC8 | 4.00 | 6.60 | 5.08 | 4.99 | 4.84 | 4.97 |
| Crystal | MCL-3 | NABUT-HDAC8 | 4.03 | 3.92 | 3.84 | 4.09 | 3.96 | 4.07 |
| Crystal | MCL-4 | MS344-HDAC8 | 5.40 | 6.53 | 6.13 | 6.01 | 6.04 | 6.06 |
| Crystal | CMC-25b | SBHA-HDAC8 | 5.59 | 6.66 | 5.35 | 5.26 | 5.04 | 5.05 |
| Crystal | CMC-7f | SCRIPTAID-HDAC8 | 5.76 | 6.72 | 6.36 | 6.67 | 6.56 | 6.70 |
| Crystal | LAQ824 | NABUT-HDAC8 | 8.42 | 7.41 | 6.05 | 6.26 | 6.51 | 6.95 |
| AAEP | | | | 1.15 | 0.87 | 0.84 | 0.80 | 0.77 |
| M4T | MCL-3 | NABUT-HDAC9 | 2.70 | 3.33 | 3.07 | 2.35 | 2.37 | 2.64 |
| ModWeb | MCL-4 | SAHA-HDAC9 | 3.37 | 6.56 | 6.17 | 6.06 | 6.13 | 6.16 |
| M4T | JMC-23 | NABUT-HDAC9 | 4.88 | 6.74 | 6.86 | 6.68 | 6.38 | 6.47 |
| ModWeb | LAQ824 | NABUT-HDAC9 | 8.08 | 7.11 | 7.17 | 6.82 | 6.39 | 6.54 |
| AAEP | | | | 1.67 | 1.52 | 1.53 | 1.57 | 1.49 |
| ModWeb | JMC-23 | OXAMFLATIN-HDAC10 | 4.64 | 7.02 | 6.82 | 6.73 | 6.72 | 7.20 |
| SwissModel | CMC-7f | SCRIPTAID-HDAC10 | 7.08 | 6.87 | 6.47 | 6.60 | 6.71 | 7.00 |
| SwissModel | LAQ824 | TSA-HDAC10 | 8.08 | 7.74 | 7.60 | 7.18 | 7.24 | 7.39 |
| SwissModel | CMC-25b | OXAMFLATIN-HDAC10 | 8.70 | 6.80 | 6.04 | 5.87 | 5.67 | 5.78 |
| AAEP | | | | 1.21 | 1.48 | 1.58 | 1.58 | 1.56 |
| CPH | JMC-23 | SCRIPTAID-HDAC11 | 4.47 | 6.82 | 7.42 | 7.72 | 7.73 | 7.80 |
| CPH | MGCD0103 | TSA-HDAC11 | 6.23 | 7.10 | 6.49 | 6.13 | 5.76 | 5.61 |
| ModWeb | LAQ824 | APHA8-HDAC11 | 8.25 | 7.29 | 6.06 | 5.79 | 5.33 | 5.08 |
| AAEP | | | | 1.40 | 1.80 | 1.94 | 2.22 | 2.38 |

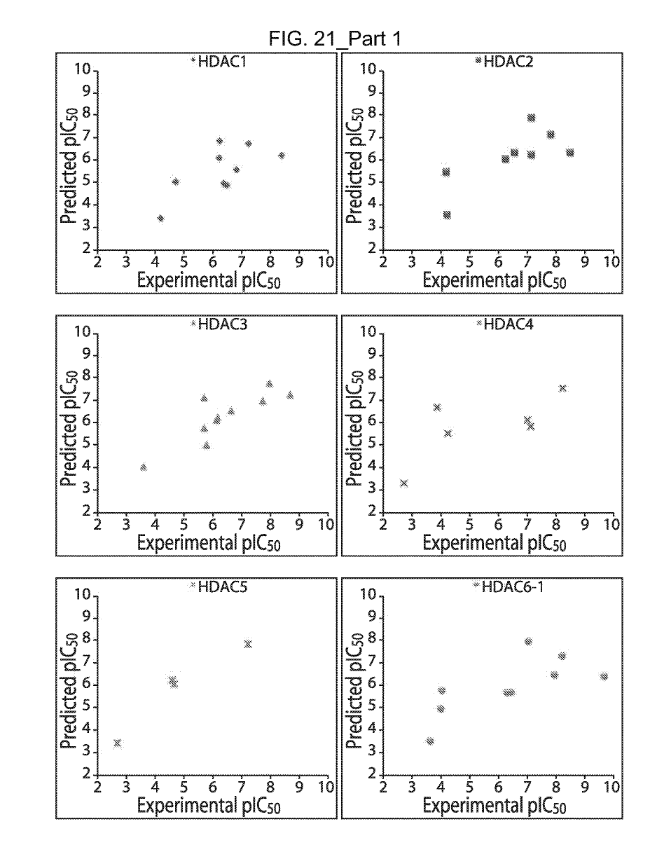

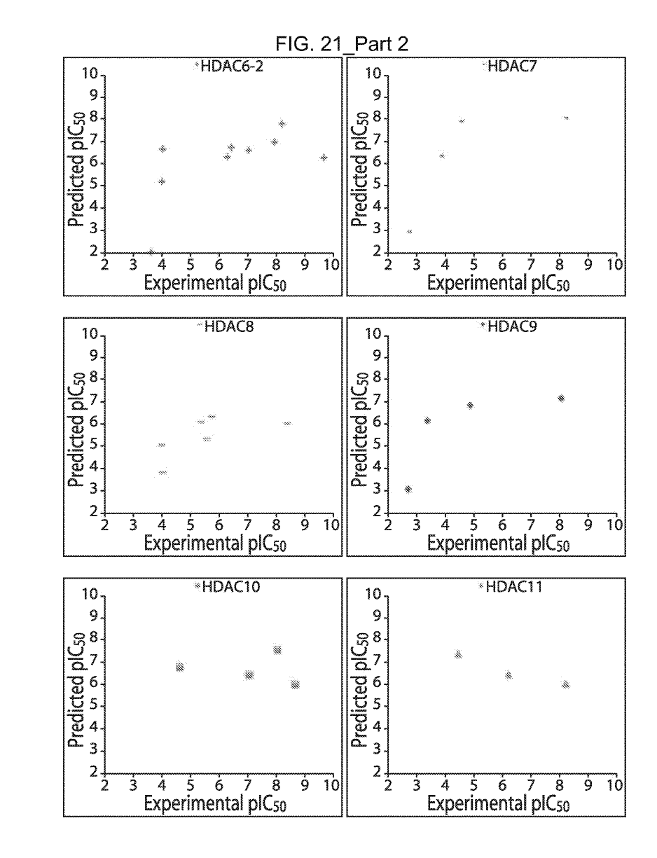

Comparisons of predictions for single HDAC isoforms reveal that complexes of HDAC2 and HDAC3 were the best predicted with an average absolute error of prediction (AAEP) of 0.53 and 0.65, respectively. Complexes related with HDAC7, HDAC9, HDAC10 and HDAC11 showed the highest AAEP values. For HDAC9, HDAC10 and HDAC11, the worst predictions were associated with a lower number of complexes in the training set. In general, the model was able to reproduce the activity of class I HDACs better than class II. Regarding HDAC10 and HDAC11, the smaller amount of experimental data in the training set was the probable cause for the failed activity-trend predictions (FIG. 21, Panels K and L). Notably the external SDEP value confirmed that the model at 2 PCs was indeed the most predictive as correctly indicated by the cross-validation runs (Table 15). The application of the DISCRIMINATE model to the MTS proved the ability of the model in predicting the relative potency and the correct activity trend of a given series of inhibitors for 10 out of twelve HDAC isoforms (Table 15 and FIG. 21) even when the binding conformations of the test set inhibitors were obtained from docking. Furthermore the lowest SDEPₑₓₜ and AAEP values obtained from the MTS analysis fully supported the optimal number of PCs as indicated by cross-validation.

Crystal Test Set.

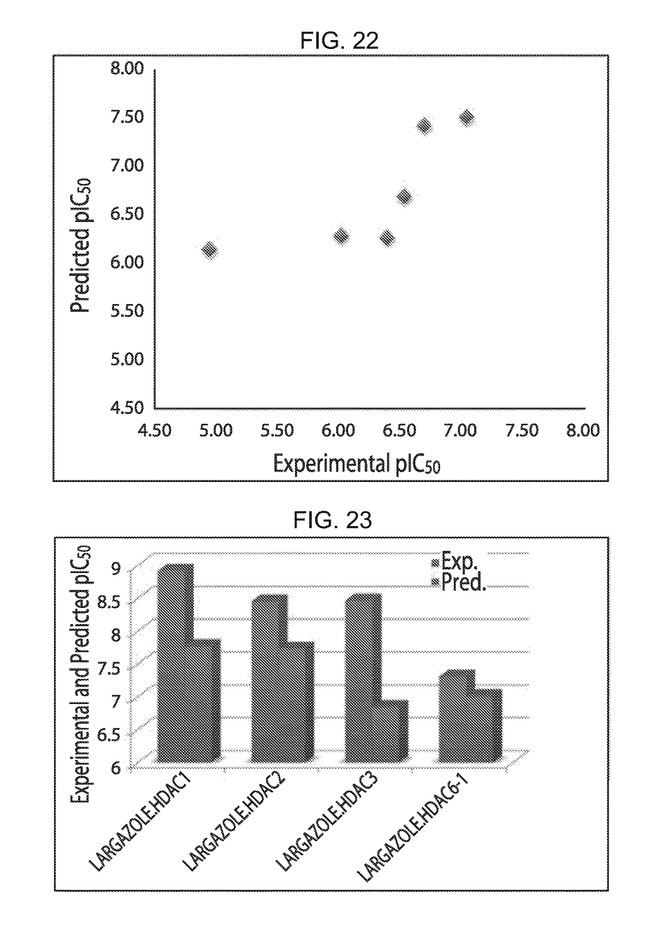

The CTS was compiled using only experimental bound inhibitors. The usefulness of this test set was two-fold. Firstly, from Table 16, the training-set model-binding conformations were confirmed to be self-consistent with only 2 PCs (FIG. 22), the DISCRIMINATE model predicted the correct trend and activity potencies with an AAEP values of only 0.71 (not shown). Secondly, the inclusion of bacterial HDACs (HDAH and HDLP) indicates that the derived DISCRIMINATE model might be used to predict activities against non-human HDACs, potentially useful in the search for antiparasitic, antifungal and antibacterial therapeutics.

TABLE 16
Experimental/predicted pIC₅₀ for the CTS test set

| | | Mole- | | | | | | |
|---|---|---|---|---|---|---|---|---|
| PDB | | cule | Experi- | | | | | |
| code | HDAC | Name | mental | PC1 | PC2 | PC3 | PC4 | PC5 |
| 3SFF³⁹ | HDAC8 | 1DI | 7.05 | 8.81 | 7.50 | 7.34 | 7.19 | 7.08 |
| 3SFH³⁹ | HDAC8 | 0DI | 6.70 | 8.90 | 7.41 | 7.21 | 6.90 | 6.96 |
| 1ZZ3⁴² | HDAH | 3YP | 6.54 | 6.46 | 6.69 | 6.39 | 6.48 | 6.34 |
| 2GH6⁴¹ | HDAH | CF3 | 4.95 | 6.53 | 6.14 | 5.99 | 6.02 | 6.05 |
| 1ZZ1⁴² | HDAH | SAHA | 6.02 | 6.72 | 6.28 | 6.01 | 5.82 | 5.76 |
| 1C3R⁴⁰ | HDLP | TSA | 6.40 | 6.72 | 6.26 | 6.45 | 6.58 | 6.76 |

Largazole Test Set. Finally the third test set comprised a cyclotetrapeptide-like inhibitor (largazole) (Cole, K. E., et al., 2011). In this case the model was tested for its predictive ability against a class of inhibitor (peptide-like) totally different from those included in the training set. To some extent, the DISCRIMINATE model was able to recognize the relative potency of largazole for HDAC1, HDAC2 and HDAC6-1; while for HDAC3, the predicted pIC₅₀ was underestimated, indicating that further modeling of this class of inhibitor is needed (Table 17 and FIG. 23). As a matter of fact, the docking approach used did not allowed flexibility of the largazole cyclic headgroup; thus, better docking and smaller error of prediction should be expected with better docking and inclusion of more inhibitors that interact with the headgroup region.

TABLE 17
Experimental/predicted pIC₅₀ for the LTS test set. The predicted
values at different principal components (PC) is reported.

| | Exp. | PC1 | PC2 | PC3 | PC4 | PC5 |
|---|---|---|---|---|---|---|
| HDAC1 | 8.92 | 6.98 | 7.64 | 8.03 | 7.88 | 8.09 |
| HDAC2 | 8.46 | 6.94 | 7.72 | 7.59 | 7.23 | 7.33 |
| HDAC3 | 8.47 | 6.80 | 6.73 | 6.97 | 6.80 | 6.86 |
| HDAC6-1 | 7.31 | 7.12 | 6.47 | 6.26 | 5.77 | 6.35 |

### Conclusion

A structure-based 3-D QSAR model using comparative binding-energy analysis that focused on the selectivity of the 11 human zinc-based histone deacetylase isoforms has been developed through a modified protocol called DISCRIMINATE. The derived DISCRIMINATE model shows good statistical coefficients, was predictive for the compounds in the test sets, and robust to cross-validation while omitting multiple data. The model was able to rationalize the different activity profiles of the HDAC inhibitors studied. This model provides a useful tool for the a priori prediction of activity of compounds yet to be synthesized in order to improve their selectivity profiles. The role of dynamic acetylation in epigenetics and other signaling pathways (Choudhary, C., et al., 2009) provides strong motivation for the development of molecular scalpels, specific inhibitors of histone deacetylases, to dissect the complexities of epigenetic control of gene expression and other signaling pathways. The DISCRIMINATE model would prove useful in this endeavor.

### Example 2

### Comprehensive Model of Wild-Type and Mutant HIV-1 Reverse Transcriptases

### Materials and Methods

Molecular Modeling, DISCRIMINATE, and Docking Calculations.

All molecular modeling calculations were performed on a 6 blades (8 Intel-Xeon E5520 2.27 GHz CPU and 24 GB DDR3 RAM each) cluster (48 CPU total) running the Debian GNU/Linux 5.03 operating system. The experimental activities of EFV and NVP reported by Rotili et al. (Rotili, D., et al., 2012) were performed according to previous studies. (Cancio, R., et al., 2007, Samuele, A., et al., 2008). To build the non-experimental complexes, the cross-docking procedure previously described (Musmuca, I., et al., 2010) was used by the AutodockVina program. Docking assessment was checked for either Autodock 4.2 or AutodockVina 1.1, root mean square deviation (RMSD) errors are reported in Table 18.

TABLE 18
Docking assessment: root-mean-square deviations (RMSDs)
displayed by the Vina and Autodock docking programs.

| | | | Vina | | Autodock |
|---|---|---|---|---|---|
| PDB Code | Mutation | Ligand | Exp | Mod | Exp |
| 1fk9 | WT | EFV | 0.33 | 0.41 | 0.29 |
| 1fko | K103N | EFV | 0.35 | 0.43 | 0.59 |
| 1fkp | K103N | NVP | 0.53 | 0.81 | 3.41 |
| 1s1u | L100I | NVP | 0.26 | 0.48 | 3.52 |
| 1vrt | WT | NVP | 0.51 | 0.86 | 3.53 |

All complexes were arbitrary superimposed using as template 1vrt, since its superior crystallographic resolution (R=2.2 Å). The superimpositions of the RT complexes were made with Chimera (Pettersen, E. F., et al., 2004) using the command-line implementation of MatchMaker. (Meng, E. C., et al., 2006). Prior any minimization, all crystal waters were discarded following a procedure already described (Mai, A., et al., 2001, Quaglia, M., et al., 2001, Ragno, R., et al., 2004) and hydrogen atoms were added using the tleap module of the AMBER suite. (Case, D. A., et al., 2005). The protonation states at pH 7.4 were considered, i.e., lysines, arginines, aspartates, and glutamates were assumed to be in the ionized form and parameters were calculated by means of the Antechamber module of AMBER. The complexes were solvated (SOLVATEOCT command) in a box extending 10 Å with water molecules (TIP3 model) and neutralized with Na⁺ and Cl⁻ ions. The solvated complexes were then refined by a single-point minimization using the Sander module of AMBER. The minimized complexes were realigned with MatchMaker using the same reference complex separated while maintaining the coordinates (experimental alignments) into ligands (key) and proteins (lock) and were used as obtained for the energy deconvolution to develop the DISCRIMINATE models. Using Autogrid4 (Morris, G. M., et al., 2009), three contributing energy fields were calculated: the electrostatic (ELE), the steric (STE) and the desolvation (DRY). Being the RT composed of 1000 residues, 1000 COMBINE descriptors were calculated for each field. Seven combination of the field were set up (ELE, STE, DRY, ELE+STE, ELE+DRY, STE+DRY and ELE+STE+DRY). By the means of the PLS algorithm as implemented in the R (Mevik, B-H., et al., 2007), an in-house script was adapted to carry out all the statistical calculations and cross-validations (Table 19).

TABLE 19
Statistical coefficients of the DISCRIMINATE models.

| CM | Model | r² | SDEC | q²_{LOO} | SDEP_{LOO} | q²_{LSO5} | SDEP_{LSO5} | q²_{LSO2} | SDEP_{LSO2} |
|---|---|---|---|---|---|---|---|---|---|
| 1 | DRY | 0.91 | 0.31 | 0.82 | 0.43 | 0.79 | 0.46 | 0.63 | 0.58 |
| 2 | ELE | 0.80 | 0.45 | 0.51 | 0.71 | 0.49 | 0.72 | 0.37 | 0.79 |
| 3 | STE | 0.81 | 0.44 | 0.69 | 0.57 | 0.65 | 0.60 | 0.52 | 0.68 |
| 4 | DRY_STE | 0.88 | 0.35 | 0.78 | 0.48 | 0.75 | 0.50 | 0.61 | 0.61 |
| 5 | ELE_STE | 0.82 | 0.43 | 0.58 | 0.66 | 0.53 | 0.69 | 0.44 | 0.75 |
| 6 | DRY_ELE | 0.89 | 0.34 | 0.66 | 0.59 | 0.63 | 0.62 | 0.48 | 0.70 |
| 7 | DRY_ELE_STE | 0.86 | 0.38 | 0.66 | 0.59 | 0.62 | 0.62 | 0.50 | 0.70 |

CM: DISCRIMINATE Model Number;
r²: conventional squared-correlation coefficient;
SDEC: standard error of calculation;
g²: cross-validation coefficient;
LOO: leave-one-out;
SDEP: standard error of prediction;
LSO5 and LSO2: leave-some-out using 5 and 2 groups respectively.

### Results and Discussion

DISCRIMINATE Model.

To build the DISCRIMINATE model, training set selection was driven by both the availability of co-crystal structures and homogeneous inhibition data from the Mai lab. From a literature search, 14 complexes (characterized by 7 different HIV-RT wild-type and mutant enzymes) were selected as a training set using complexes with only two HIV-RT inhibitors, NVP and EFV, for which inhibition constants were available as previously tested by our collaborators. (Musmuca, I., et al., 2010).

As reported in Table 20, the training set was composed of NVP and EFV in complex with seven different HIV-RT enzymes (WT, L100I, K103N, V106A, V179D, Y181I, Y188L). Of the 14 complexes, structural data were experimentally available from the PDB for only five (WT/EFV: 1fk9, (Ren, J., et al., 2000), K103N/EFV: 1fko, (Id.), WT/NVP: 1vrt, (Ren, J., et al., 1995), L100I/NVP: 1s1u, (Ren, J., et al., 2004) and K103N/NVP: 1fkp (Ren, J., et al., 2000). The other nine complexes (L100/EFV, V106A/NVP, V106A/EFV, V179D/NVP, V179D/EFV, Y181I/NVP, Y181I/EFV, Y188L/NVP and Y188L/EFV) were directly modeled using side-chain structural information retrieved from other complexes present in the PDB and using the BUILD module of UCSF Chimera.

TABLE 20
Structures, anti-HIV-RT activities (μM) of Nevirapine (NVP)
and Efavirenz (EFV) used to build the DISCRIMINATE model.

| | |
|---|---|
| 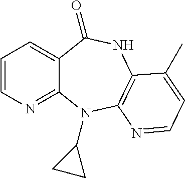 [SMILES: Cc1ccnc2c1NC(=O)c1cccnc1N2C1CC1] | 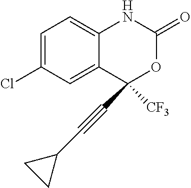 [SMILES: O=C1Nc2ccc(Cl)cc2[C@@](C#CC2CC2)(C(F)(F)F)O1] |

| | |
|---|---|
| Nevirapine (NVP) | Efavirenz (EFV) |

| RT | NVP | EFV |
|---|---|---|
| WT | 0.4 | 0.03 |
| L100I | 9.0 | 0.12 |
| K103N | 7.0 | 0.16 |
| V106A | 10.0 | 0.04 |
| V179D | 2.0 | 0.10 |
| Y181I | 36.0 | 0.15 |
| Y188L | 18.0 | 0.38 |

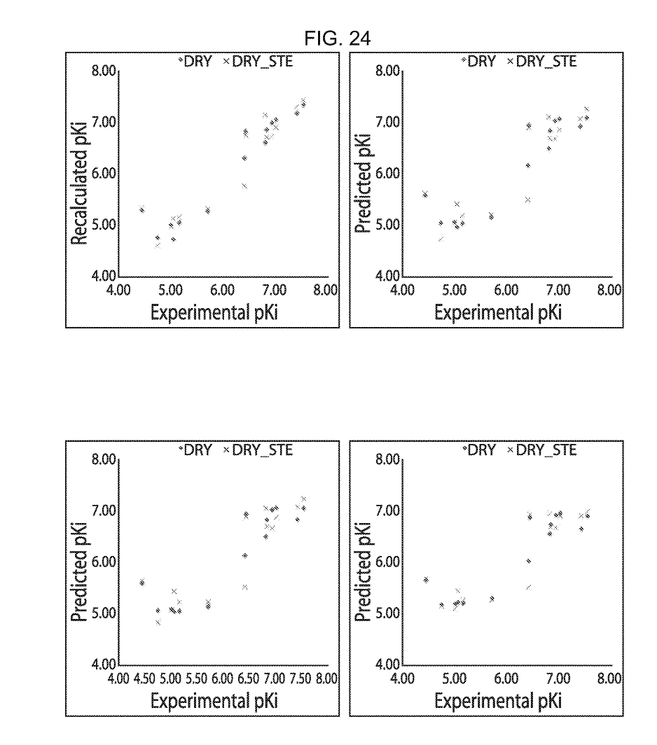

Different from the original COMBINE protocol, DISCRIMINATE used the Autogrid module of the AutoDock 4 suite (Morris, G. M., et al., 2009) to compute the energy interactions between the inhibitors and each amino-acid residue of the enzyme in a complex. The ligand/residues/energy deconvolution matrix was directly obtained by the sum of the interaction energies between all ligand atoms and those composing each amino acid residue in HIV-RT. The complexes were optimized by a short energy minimization followed by docking experiments conducted with AutoDockVina. (Trott, O., et al., 2010). From the Autogrid application, three kinds of interaction contributions were calculated: the steric (STE), the electrostatic (ELE) and the desolvation (DRY) ones. HIV-1 RT is a heterodimer with a subunit of 560 residues (p66) and a second subunit (p51) of 440 residues. Therefore, for each contribution, a total of 1000 interactions were computed, and modeled using the PLS algorithm implemented in the R (R-Development-Core-Team. The R Foundation for Statistical Computing. http://www.r-project.org) environment. Considering all possible combination of contributions, seven different DISCRIMINATE models were independently derived (CM1-CM7, Table 2). From data reported in Table 19, all seven DISCRIMINATE models were highly robust and endowed with good predictive power. Among the seven models, CM1 and CM4 (FIG. 24) exhibited the best statistical-value profiles (compare r², q² and SDEP values in Table 19).

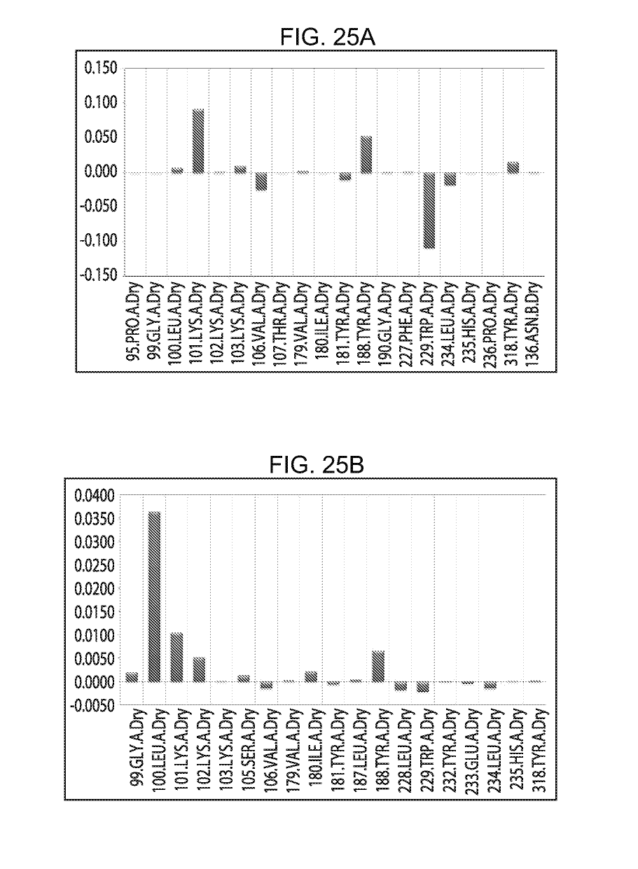

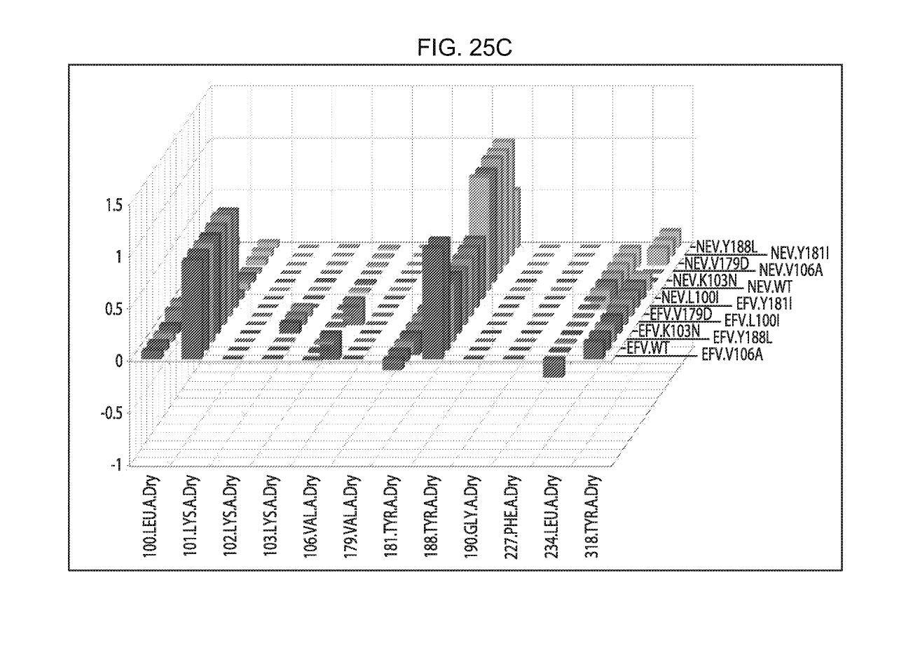

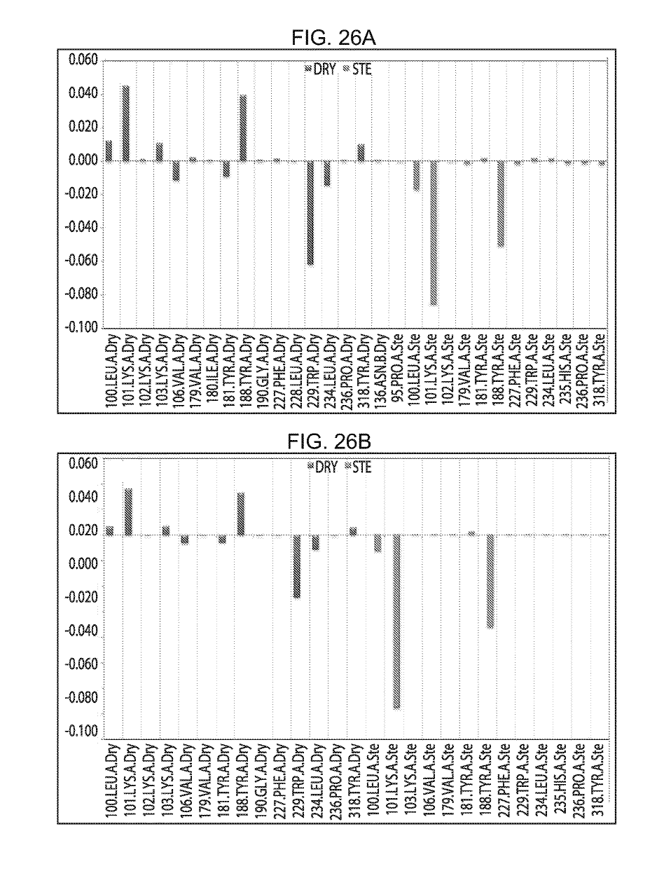

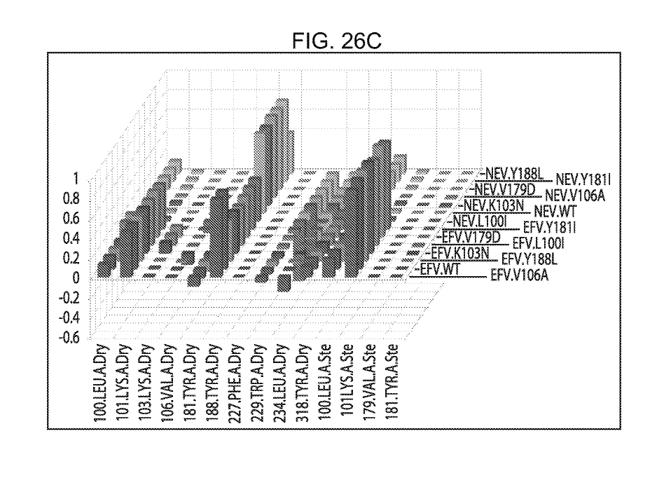

As discussed by Gago et al. (Perez, C., et al., 1998, Rodriguez-Barrios, F., et al., 2004) and common to other 3-D QSAR studies (Ballante, F., et al., 2012, Baroni, M., et al., 1993). COMBINE-like models have to be analyzed by means of PLS coefficients and activity contribution (interaction energies multiplied by the PLS coefficients) plots. While PLS coefficients indicated which residues contributed most to the COMBINE relationships (general indication), the activity contributions provided the real pKᵢ contribution for each inhibitor/residue pair to the enhancement or decrease of the given inhibitor activity starting from a constant threshold value (intercept). Further indications of significance can be inferred from the PLS coefficients weighted by the standard deviation values (PLS*StDev) to give the overall importance of each amino-acid residue in the DISCRIMINATE model. In FIGS. 25-26 are reported the PLS coefficients, the PLS*StDev and activity-contribution histograms for CM1 and CM4 models, respectively.

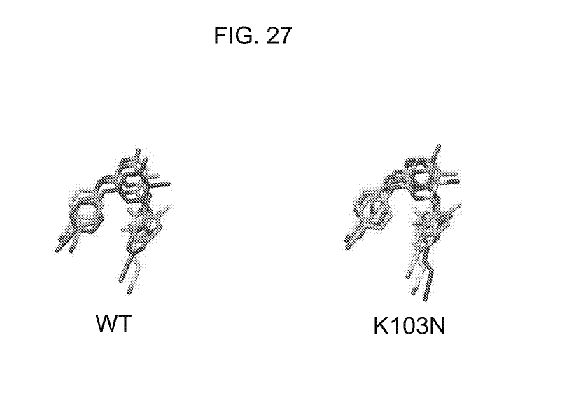

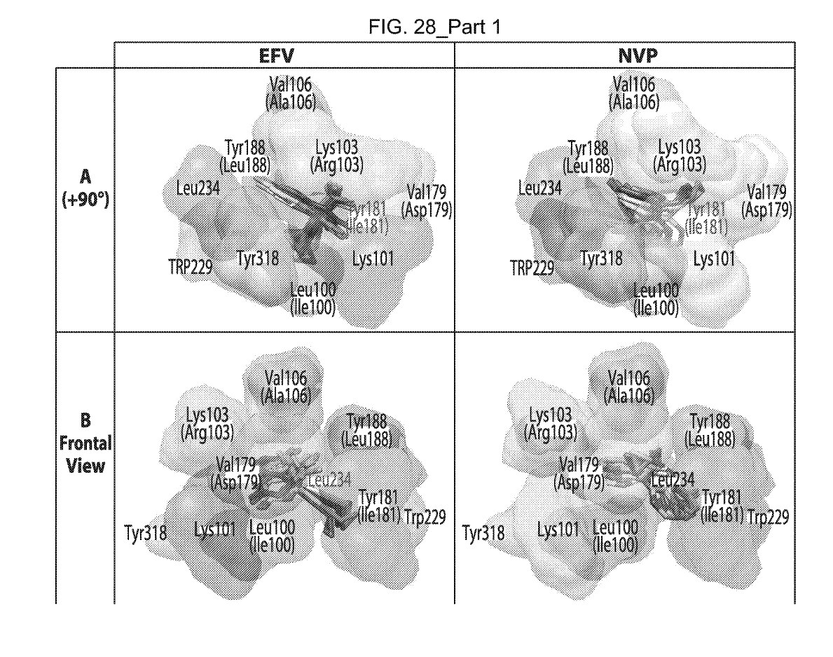

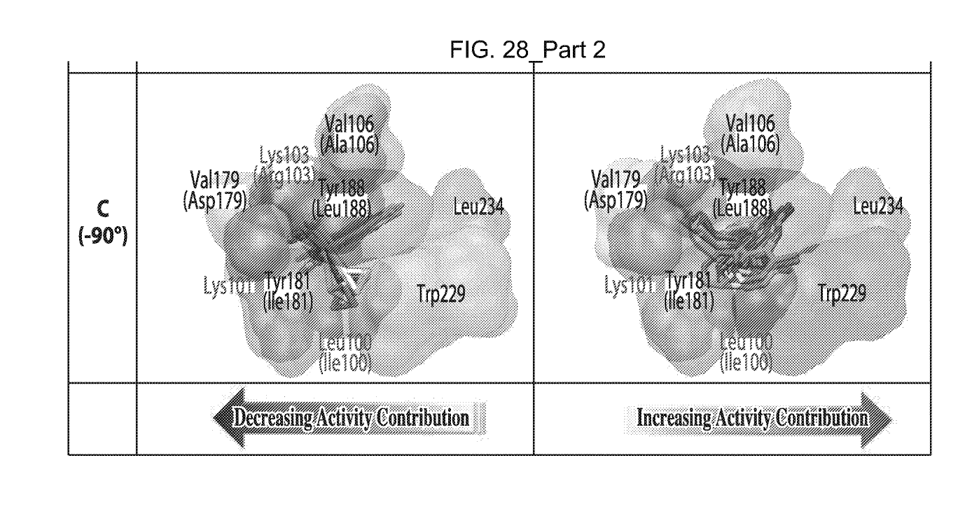

Regarding the desolvation energy (DRY), from FIGS. 25A and 26A, residues Leu100 (Ile100), Lys101, Lys103 (Asn103), Val106 (Ala106), Val179 (Asp179), Tyr181 (Ile181), Tyr188 (Leu188), Trp229, Leu234 and Tyr318 are mainly involved in defining either model CM1 or model CM4. As suggested by Wesson and Eisenberg (Wessen and Eisenberg, 1992), desolvation energy is proportional to the change in the surface area that is available to water, therefore, the DRY energies are an estimation of the hydrophobic effect similar to the DRY probe in the Goodford GRID program. (Goodford, P. J., 1985). The DRY interactions have only positive values; therefore, multiplication of the PLS value by the standard deviation of a certain residue can be interpreted in the same way as the 3-D QSAR CoMFA (Cramer, R. D., et al., 1988) plots in which positive PLS Coeff*StDev values are directly correlated with enhanced activity and negative values correlate with decreased biological affinities (FIG. 25B). In FIG. 25B, residues Leu100 (Ile100), Lys101 and Tyr188 (Leu188) have the highest PLS Coeff*StDev values and, therefore, interaction with these residues are desirable, while low negative PLS Coeff*StDev values are associated with residues Trp229 and Leu234 meaning that the interaction with these residues should be minimized. Observing FIG. 26A, in model CM4, residues Leu100 (Ile100), Lys101 and Tyr188 (Leu188) are more sensitive to steric interactions, in agreement with the above. On the other hand, investigation on the energy of interaction on the STE field revealed that almost only negative values are present, in agreement with the fact that the 14 complexes were generated by means of docking experiments with van der Waals and hydrogen-bonding optimized. Thus the significance of the PLS Coeff*StDev bars of histogram in FIG. 26B relative to the STE fields have inverse signification to those of the DRY fields. Although some redundancy occurs in the Autogrid-field calculations, the fact that the charge of the atom is incorporated in the calculation of desolvation interactions and that the STE fields is the sum of the interactions of the residue atoms, thus containing also hydrogen-bonding calculations, the DRY and the STE field together contain most of the electrostatic interactions. Similar analyses were also done for the ELE (CM2), STE (CM3), ELE_STE (CM5), DRY ELE (CM6) and the triple field containing DISCRIMINATE model CM7. In all DISCRIMINATE models containing the ELE field merged with other fields, its contribution to the description was almost negligible. As a matter of fact, the CM2 models (only ELE) had lower statistical coefficients, thus, indicating a lower correlation between the biological activities and electrostatic interactions. In the multifield models (CM4-CM7), therefore, the PLS code correctly recognized this low correlation and contribution of the ELE field was essentially eliminated. Since the models were obtained using single point RT-mutated forms, interesting sources of data are the activity contribution plot of FIGS. 25C and 26C. These plots reported the product of each residue field by the respective PLS coefficients. The sum of all these products and the intercept values for each complex returns the fitted values of the DISCRIMINATE models (FIG. 27). Due to the similar profile of the DRY field in both CM1 and CM4 models, only the DRY_STE double-field model is considered for future comments. It could be argued that all statistics of the DRY model are slightly better or comparable to those of the DRY_STE model. It was decided, nevertheless, to focus only on the DRY_STE model so to have a more complete description of the ligand/enzyme interactions. Analyses of activity-contribution plots confirmed that the amino-acids mutations were directly and indirectly responsible for the different activity profiles of EFV and NVP. Any description of the detailed interaction network is far too complicated; after analysis of the CM1 and CM4 models plots reported in FIGS. 25-26, a schematic view (FIG. 28) on the direct influence to the NVP and EFV anti-RT activities by their surrounding residues (and their mutations) is presented.

DISCRIMINATE Predictions.

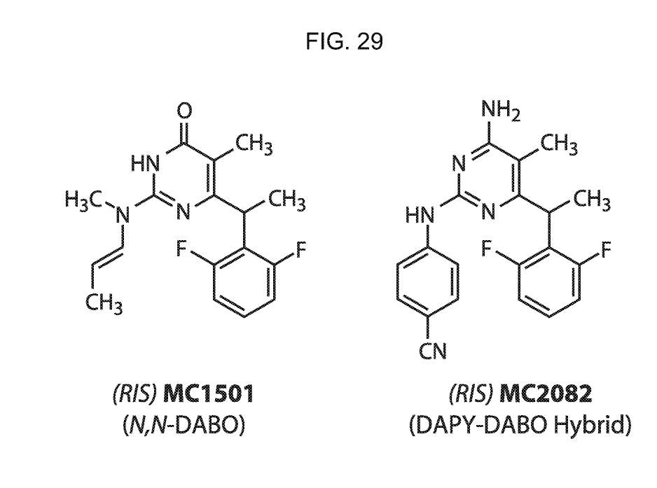

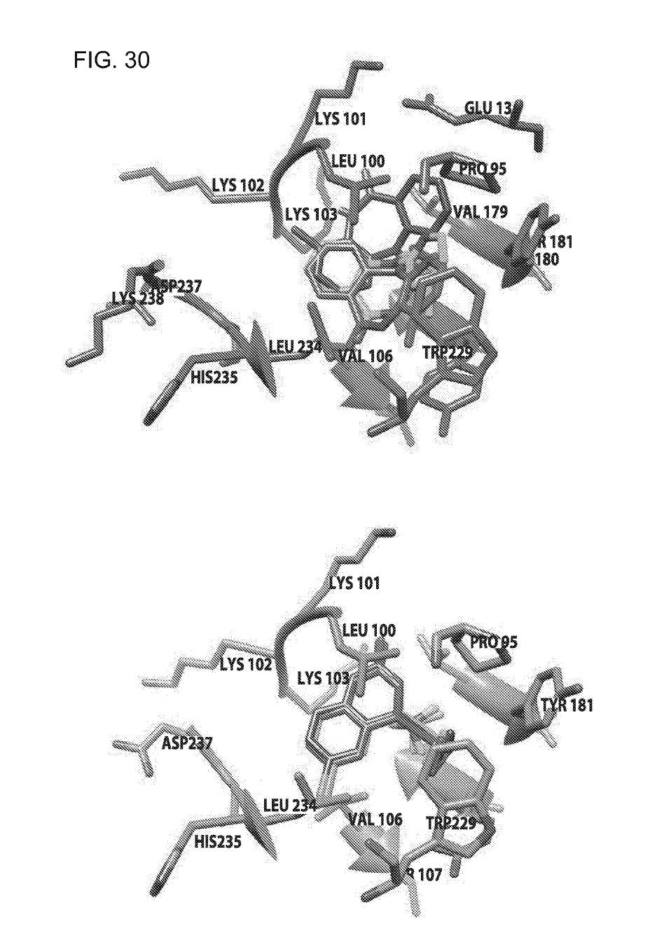

The reported DISCRIMINATE model CM4 was used to rationalize the role of mutation on the activity profile of (R)- and (S)-MC1501, and of (R)- and (S)-MC2082 reported by Rotili et al. (Rotili, D., et al., 2012). The binding modes of the four DABO derivatives (FIG. 29) were analyzed by the means of the Vina program (Trott, O., et al., 2010) which proved more reliable, as shown in Table 18 and FIG. 30, than Autodock (Morris, G. M., et al., 2009) in reproducing the EFV- and NVP-experimental binding modes. In redocking Vina was more reliable Autodock in reproducing the binding mode of both NVP and EFV starting from the experimental conformation of the ligands. (Musmuca, I., et al., 2010). In view of these results and the fact that Vina was 10-times faster than Autodock, Vina was selected for docking experiments.

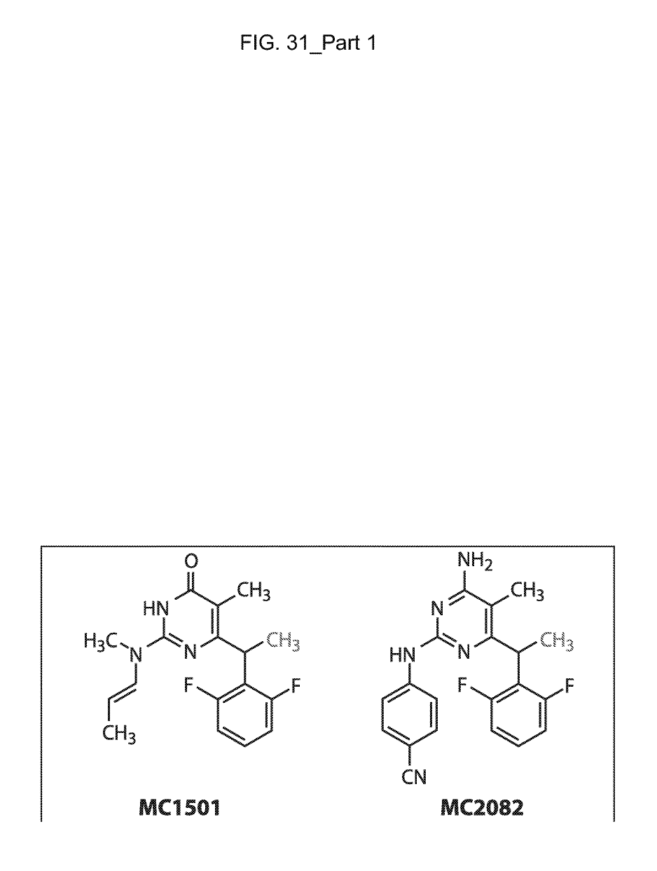

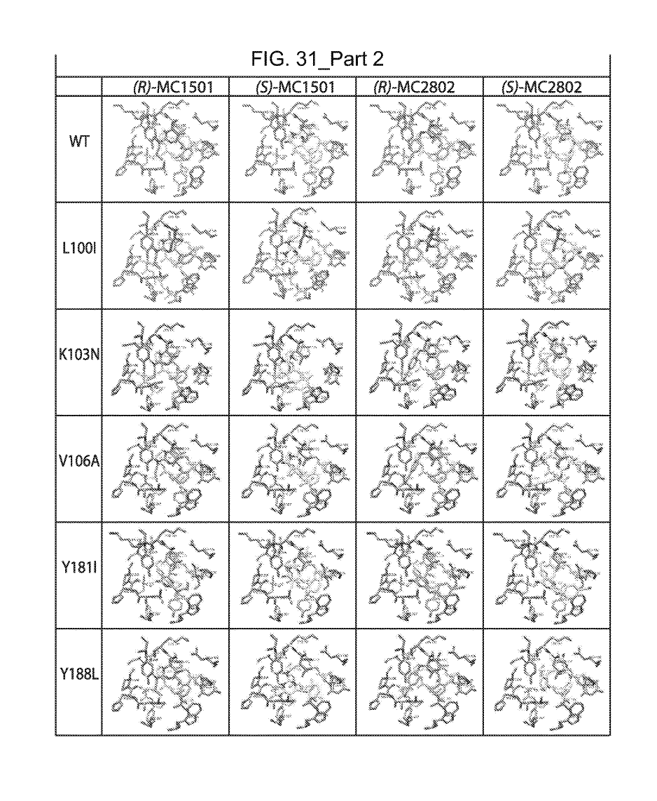

FIG. 31 shows the binding modes of the DABO derivatives with the WT and the mutated HIV-RTs used in this study. Similarly to previous studies (Mai, A., et al., 2001, Quaglia, M., et al., 2001, Ragno, R., et al., 2004), the R-conformations display an overall binding profile similar for either MC1501 or MC2082. In the S-configurations, the methyl at the C6-benzylic position (highlighted in red) prevented similar interactions (Ragno, R., et al., 2004). The (R)-MC2082 binding mode is comparable with that of TMC278 (rilpivirine) (Azijn, H., et al., 2010), a recently reported DAPY derivative now undergoing clinical trials (Macarthur, R. D., et al., 2011).

FIG. 27 displays the (R)-MC2082 binding modes overlapped with the experimental ones of etravirine and TMC278 in wild type and mutated RTs.

Once the binding modes of MC compounds were calculated, the DISCRIMINATE model CM4 was readily applied. As reported in Table 21, the DISCRIMINATE model, although developed on different classes of compounds, predicted the experimental MC activities with an acceptable average absolute error of prediction (0.89 pKᵢ). The CM4 model percentage of prediction error ranged between 61.6% and 0.9% with an average error of 14.3% which are comparable to those experimentally reported by Rotili et al. (Rotili, D., et al., 2012) that were 37.5%, 1.5% and 16.2%, respectively.

TABLE 21
Experimental and DISCRIMINATE model CM4 predicted activities
of MC compounds of Rotili et al. (Rotili, D., et al., 2012)

| | MC1501 | | | | MC2082 | | | |
|---|---|---|---|---|---|---|---|---|
| | R | | S | | R | | S | |
| | Exp | Pred | Exp | Pred | Exp | Pred | Exp | Pred |
| WT | 8.70 | 7.46 | 6.93 | 7.20 | 6.81 | 7.21 | 4.52 | 5.77 |
| V106A | 8.52 | 9.19 | 6.45 | 5.78 | 9.52 | 9.43 | 6.62 | 7.51 |
| K103N | 7.02 | 7.17 | 6.01 | 7.52 | 8.52 | 9.11 | 7.19 | 7.52 |
| L100I | 7.02 | 6.69 | 4.40 | 7.11 | 8.10 | 7.49 | 6.74 | 6.03 |
| Y188L | 6.71 | 7.51 | 4.40 | 5.11 | 8.10 | 7.09 | 4.40 | 5.95 |
| Y181I | 6.35 | 6.05 | 4.40 | 6.12 | 6.12 | 6.25 | 6.29 | 5.48 |

Most notably, the model was able to correctly predict the right eudismic ratio for the two R/S pairs of MC derivatives.

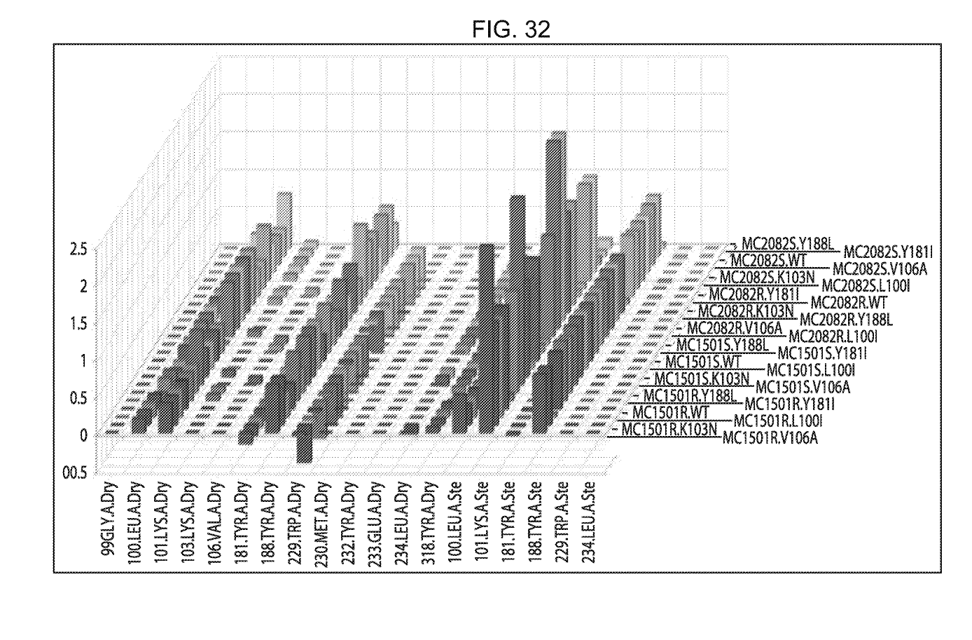

The DISCRIMINATE model CM4 application to the external set (MC compounds) gave further information from the interpretation of the calculated activity contributions (FIG. 32), for each compounds directly highlighting the difference between the MC1501 and MC2082 compounds upon binding to the RTs. In general, from FIG. 32 can be readily seen that the activity contribution associated to the interactions of the most active MC enantiomers (stereoisomers R) with residues Lys101 are those mainly responsible for the higher activities of (R)-MC2082 versus the (R)-MC1501 with an average increase of activities of about 0.29 and 0.19 of pKᵢ units for the hydrophobic and steric fields, respectively.

Comparing the activity contributions of R- and S-enantiomers of MC1501, the hydrophobic effect of residue Lys101 become negligible, while that from Trp229 became more appreciable, with an average contribution of 0.24 pKᵢ units. In comparison, Lys101-related steric contribution is more than doubled (see Tables 5 and 6). In the case of MC2082 R- and S-enantiomers, the activity contribution Lys101 is only reduced of 32% (0.17), that of Trp229 increased to 0.16 and the Lys101 steric contribution raised up to more than 5 times (1.05).

Single-point mutations from model CM4 residue 188 demonstrated a key role in modulating the interactions of the ligands both in its wild type (Tyr188) and in the Leu188 mutation. Interestingly, for another mutating residue, residue 188 seems to offset any loss of interaction as a result of the residue mutation itself, more remarkably in the case of the more active compounds (R)-MC1501 and (R)-MC2082. Comparing the activity contribution profile of (R)-MC2082 docked into wild type HIV-RT and in the V106A mutated form, the only values changing drastically are those associated with Tyr188. A possible explanation for this could be that the incoming missing interactions for the (R)-MC2082/Val106→(R)-MC2082/Ala106 replacement are readily filled by the augmented (R)-MC2082/Tyr188 interactions (compare Tyr188 positions in FIG. 26).

Finally, Tables 22 and 23 clearly demonstrated that most of the mutations contribute to force the ligands to re-adapt their interaction network mainly around the two non-mutating Lys101 and Trp229 residues, supplying in this way hydrogen bond and hydrophobic anchor points with which the ligands interact upon complex formation.

TABLE 22
CM4 model predicted MC1501 activity contributions with average values higher than 0.01 absolute pKi values.

| | Field | | | | | | | | | | | | |
|---|---|---|---|---|---|---|---|---|---|---|---|---|---|
| | Dry | | | | | | | | | Ste | | | |
| Residue Number | 100 | K101 | 103 | 106 | 181 | 188 | T229 | L234 | Y318 | 100 | K101 | 181 | 188 |
| (R)-MC1501.WT | 0.19 | 0.38 | 0.01 | −0.01 | −0.15 | 0.35 | −0.04 | −0.01 | 0.08 | 0.27 | 1.37 | −0.03 | 0.76 |
| (R)-MC1501.L100I | 0.20 | 0.38 | 0.01 | −0.01 | −0.15 | 0.33 | −0.05 | −0.01 | 0.08 | 0.28 | 1.34 | −0.03 | 0.05 |
| (R)-MC1501.K103N | 0.19 | 0.38 | 0.01 | −0.01 | −0.15 | 0.64 | −0.51 | −0.12 | 0.08 | 0.27 | 1.37 | −0.03 | 0.77 |
| (R)-MC1501.V106A | 0.20 | 0.39 | 0.01 | 0.00 | −0.14 | 0.65 | −0.05 | −0.01 | 0.08 | 0.51 | 2.55 | −0.03 | 0.78 |
| (R)-MC1501.Y181I | 0.10 | 0.38 | 0.09 | −0.01 | −0.07 | 0.65 | −0.51 | −0.01 | 0.01 | 0.26 | 0.10 | 0.00 | 0.80 |
| (R)-MC1501.Y188L | 0.19 | 0.38 | 0.09 | −0.01 | −0.15 | 0.33 | −0.04 | −0.01 | 0.08 | 0.27 | 1.37 | −0.03 | 0.75 |
| Average | 0.18 | 0.38 | 0.03 | −0.01 | −0.13 | 0.49 | −0.20 | −0.03 | 0.07 | 0.31 | 1.35 | −0.02 | 0.65 |
| SD | 0.04 | 0.00 | 0.04 | 0.00 | 0.03 | 0.17 | 0.24 | 0.04 | 0.03 | 0.10 | 0.78 | 0.01 | 0.29 |
| Max | 0.20 | 0.39 | 0.09 | 0.00 | −0.07 | 0.65 | −0.04 | −0.01 | 0.08 | 0.51 | 2.55 | 0.00 | 0.80 |
| Min | 0.10 | 0.38 | 0.01 | −0.01 | −0.15 | 0.33 | −0.51 | −0.12 | 0.01 | 0.26 | 0.10 | −0.03 | 0.05 |
| Range | 0.09 | 0.01 | 0.08 | 0.00 | 0.07 | 0.32 | 0.47 | 0.11 | 0.08 | 0.25 | 2.45 | 0.02 | 0.74 |
| (S)-MC1501.WT | 0.20 | 0.39 | 0.01 | 0.00 | −0.08 | 0.35 | −0.05 | −0.01 | 0.08 | 0.28 | 1.37 | −0.03 | 0.76 |
| (S)-MC1501.L100I | 0.10 | 0.37 | 0.01 | −0.01 | −0.15 | 0.64 | −0.52 | −0.12 | 0.08 | 0.26 | 0.10 | −0.03 | 0.77 |
| (S)-MC1501.K103N | 0.10 | 0.38 | 0.09 | 0.09 | −0.08 | 0.65 | −0.51 | −0.12 | 0.08 | 0.26 | 1.29 | 0.00 | 0.80 |
| (S)-MC1501.V106A | 0.20 | 0.73 | 0.01 | 0.00 | −0.08 | 0.65 | −0.50 | −0.01 | 0.08 | 0.51 | 2.58 | 0.00 | 0.78 |
| (S)-MC1501.Y181I | 0.19 | 0.38 | 0.01 | −0.01 | −0.08 | 0.65 | −0.52 | −0.01 | 0.08 | 0.27 | 0.11 | 0.00 | 0.78 |
| (S)-MC1501.Y188L | 0.10 | 0.03 | 0.01 | −0.09 | −0.08 | 0.34 | −0.52 | −0.12 | 0.08 | 0.26 | 0.07 | 0.00 | 0.76 |
| Average | 0.15 | 0.38 | 0.02 | −0.03 | −0.09 | 0.54 | −0.44 | −0.07 | 0.08 | 0.31 | 0.92 | −0.01 | 0.78 |
| SD | 0.05 | 0.22 | 0.03 | 0.05 | 0.03 | 0.16 | 0.19 | 0.06 | 0.00 | 0.10 | 1.01 | 0.01 | 0.01 |
| Max | 0.20 | 0.73 | 0.09 | 0.00 | −0.08 | 0.65 | −0.05 | −0.01 | 0.08 | 0.51 | 2.58 | 0.00 | 0.80 |
| Min | 0.10 | 0.03 | 0.01 | −0.09 | −0.15 | 0.34 | −0.52 | −0.12 | 0.08 | 0.26 | 0.07 | −0.03 | 0.76 |
| Range | 0.09 | 0.69 | 0.08 | 0.09 | 0.07 | 0.31 | 0.47 | 0.11 | 0.00 | 0.25 | 2.50 | 0.02 | 0.04 |
| RvsS* | 0.03 | 0.00 | 0.01 | 0.03 | −0.05 | −0.05 | 0.24 | 0.04 | −0.01 | 0.00 | 0.43 | −0.01 | −0.12 |

*differences between (R)-MC1501 and (S)-MC1501 activity contribution averages.
In bold are highlighted the values cited in the prediction interpretations reported in the text.

TABLE 23
CM4 model predicted MC2082 activity contributions with average values higher than 0.01 absolute pKi values.

| | Field | | | | | | | | | | | | |
|---|---|---|---|---|---|---|---|---|---|---|---|---|---|
| | Dry | | | | | | | | | Ste | | | |
| Residue Number | 100 | K101 | 103 | 106 | 181 | 188 | T229 | L234 | Y378 | 100 | K101 | 181 | 788 |
| (R)-MC2082.WT | 0.20 | 0.73 | 0.09 | −0.01 | −0.15 | 0.34 | −0.03 | −0.12 | 0.09 | 0.28 | 1.37 | −0.03 | 0.07 |
| (R)-MC2082.L100I | 0.20 | 0.73 | 0.09 | −0.09 | −0.15 | 0.35 | −0.51 | −0.12 | 0.08 | 0.28 | 1.35 | −0.03 | 0.76 |
| (R)-MC2082.K103N | 0.20 | 0.73 | 0.01 | −0.01 | −0.15 | 0.64 | −0.51 | −0.12 | 0.08 | 0.28 | 1.34 | −0.03 | 0.76 |
| (R)-MC2082.V106A | 0.20 | 0.73 | 0.01 | −0.01 | −0.15 | 0.64 | −0.05 | −0.12 | 0.08 | 0.51 | 2.54 | −0.03 | 0.78 |
| (R)-MC2082.Y181I | 0.10 | 0.37 | 0.09 | −0.01 | −0.08 | 0.96 | −0.54 | −0.12 | 0.08 | 0.26 | 0.09 | −0.03 | 0.82 |
| (R)-MC2082.Y188L | 0.20 | 0.73 | 0.01 | −0.01 | −0.15 | 0.34 | −0.04 | −0.12 | 0.08 | 0.51 | 2.55 | −0.03 | 0.76 |
| Average | 0.18 | 0.67 | 0.05 | −0.02 | −0.14 | 0.54 | −0.28 | −0.12 | 0.08 | 0.35 | 1.54 | −0.03 | 0.66 |
| SD | 0.04 | 0.14 | 0.04 | 0.03 | 0.03 | 0.25 | 0.26 | 0.00 | 0.00 | 0.12 | 0.92 | 0.00 | 0.29 |
| Max | 0.20 | 0.73 | 0.09 | −0.01 | −0.08 | 0.96 | −0.03 | −0.12 | 0.09 | 0.51 | 2.55 | −0.03 | 0.82 |
| Min | 0.10 | 0.37 | 0.01 | −0.09 | −0.15 | 0.34 | −0.54 | −0.12 | 0.08 | 0.26 | 0.09 | −0.03 | 0.07 |
| Range | 0.10 | 0.35 | 0.08 | 0.09 | 0.07 | 0.62 | 0.51 | 0.00 | 0.00 | 0.25 | 2.46 | 0.00 | 0.74 |
| (S)-MC2082.WT | 0.20 | 0.39 | 0.09 | −0.01 | −0.15 | 0.65 | −0.52 | −0.12 | 0.08 | 0.27 | 0.10 | −0.03 | 0.79 |
| (S)-MC2082.L100I | 0.19 | 0.37 | 0.01 | −0.09 | −0.15 | 0.65 | −0.51 | −0.12 | 0.08 | 0.26 | 0.07 | −0.03 | 0.77 |
| (S)-MC2082.K103N | 0.20 | 0.73 | 0.09 | −0.01 | −0.15 | 0.65 | −0.52 | −0.12 | 0.08 | 0.27 | 1.28 | −0.03 | 0.78 |
| (S)-MC2082.V106A | 0.19 | 0.40 | 0.09 | −0.01 | −0.08 | 0.35 | −0.01 | −0.12 | 0.09 | 0.27 | 1.28 | 0.00 | 0.76 |
| (S)-MC2082.Y181I | 0.10 | 0.37 | 0.09 | −0.01 | −0.08 | 0.67 | −0.55 | −0.12 | 0.08 | 0.26 | 0.08 | 0.00 | 0.81 |
| (S)-MC2082.Y188L | 0.20 | 0.72 | 0.09 | −0.01 | −0.15 | 0.33 | −0.50 | −0.01 | 0.08 | 0.27 | 0.12 | −0.03 | 0.07 |
| Average | 0.18 | 0.50 | 0.08 | −0.02 | −0.12 | 0.55 | −0.44 | −0.10 | 0.08 | 0.27 | 0.49 | −0.02 | 0.66 |
| SD | 0.04 | 0.18 | 0.03 | 0.04 | 0.04 | 0.16 | 0.21 | 0.04 | 0.00 | 0.01 | 0.61 | 0.01 | 0.29 |
| Max | 0.20 | 0.73 | 0.09 | −0.01 | −0.08 | 0.67 | −0.01 | −0.01 | 0.09 | 0.27 | 1.28 | 0.00 | 0.81 |
| Min | 0.10 | 0.37 | 0.01 | −0.09 | −0.15 | 0.33 | −0.55 | −0.12 | 0.08 | 0.26 | 0.07 | −0.03 | 0.07 |
| Range | 0.09 | 0.36 | 0.09 | 0.09 | 0.07 | 0.34 | 0.54 | 0.11 | 0.00 | 0.01 | 1.22 | 0.02 | 0.74 |
| RvsS* | 0.00 | 0.17 | −0.03 | 0.00 | −0.01 | −0.01 | 0.16 | −0.02 | 0.00 | 0.08 | 1.05 | −0.01 | −0.01 |

*differences between (R)-MC2082 and (S)-MC2082 activity contribution averages. In bold are highlighted the values cited in the prediction interpretations reported in the text.

### Conclusions

The DISCRIMINATE approach integrates multiple sources of SAR information to build a self-consistent model of the amino acid residues in both wild-type and mutant enzymes responsible for molecular recognition and discrimination. As with all such underdetermined 3-D QSAR models, predictability is the only real means of selecting one model over another. This study on HIV-RT used a minimal set of inhibitor complexes to extract possible models for HIV-RT variants that rationalize the experimentally observed inhibitory activity of a novel set of compounds described by Rotili et al. including the relative activity of two different sets of stereoisomers. Obviously, prediction of novel inhibitors and their activities against HIV-RT is a logical next step to validate the utility of the DISCRIMINATE approach.

### DOCUMENTS

Allerhand, A., Trull, E. A., Nuclear Magnetic Resonance. Ann Rev Phys Chem, 1970, 21: 317-348.
Arnold, K.; Bordoli, L.; Kopp, J.; Schwede, T., The SWISS-MODEL workspace: a web-based environment for protein structure homology modelling. Bioinformatics 2006, 22 (2), 195-201.
Azijn, H.; Tirry, I.; Vingerhoets, J.; de Bethune, M. P.; Kraus, G.; Boven, K.; Jochmans, D.; Van Craenenbroeck, E.; Picchio, G.; Rimsky, L. T. TMC278, a next-generation nonnucleoside reverse transcriptase inhibitor (NNRTI), active against wild-type and NNRTI-resistant HIV-1. Antimicrob Agents Chemother 2010, 54, 718-27.
Ballante, F.; Musmuca, I.; Marshall, G. R.; Ragno, R., Comprehensive Models of Wild-Type and Mutant HIV-1 Reverse Transciptases. J Comp-Aided Mol Design 2012, submitted.
Ballante, F.; Ragno, R., 3-D QSAutogrid/R: an alternative procedure to build 3-D QSAR models. Methodologies and applications. Journal of chemical information and modeling 2012.
Baroni, M.; Costantino, G.; Cruciani, G.; Riganelli, D.; Valigi, R.; Clementi, S. Generating Optimal Linear PLS Estimations (GOLPE): An Advanced Chemometric Tool for Handling 3D-QSAR Problems. Quantitative Structure-Activity Relationships 1993, 12, 9-20.
Beckers, T.; Burkhardt, C.; Wieland, H.; Gimmnich, P.; Ciossek, T.; Maier, T.; Sanders, K., Distinct pharmacological properties of second generation HDAC inhibitors with the benzamide or hydroxamate head group. Int. J. Cancer 2007, 121 (5), 1138-1148.
Bernstein, F. C.; Koetzle, T. F.; Williams, G. J.; Meyer, E. F., Jr.; Brice, M. D.; Rodgers, J. R.; Kennard, O.; Shimanouchi, T.; Tasumi, M., The Protein Data Bank: a computer-based archival file for macromolecular structures. J Mol Biol 1977, 112 (3), 535-42.
Blackwell, L.; Norris, J.; Suto, C. M.; Janzen, W. P., The use of diversity profiling to characterize chemical modulators of the histone deacetylases. Life Sci. 2008, 82 (21-22), 1050-1058.
Botta, C. B.; Cabri, W.; Cini, E.; De Cesare, L.; Fattorusso, C.; Giannini, G.; Persico, M.; Petrella, A.; Rondinelli, F.; Rodriquez, M.; Russo, A.; Taddei, M., Oxime Amides as a Novel Zinc Binding Group in Histone Deacetylase Inhibitors: Synthesis, Biological Activity, and Computational Evaluation. J. Med. Chem. 2011, 54 (7), 2165-2182.
Bottomley, M. J.; Lo Surdo, P.; Di Giovine, P.; Cirillo, A.; Scarpelli, R.; Ferrigno, F.; Jones, P.; Neddermann, P.; De Francesco, R.; Steinkuhler, C.; Gallinari, P.; Carfi, A., Structural and functional analysis of the human HDAC4 catalytic domain reveals a regulatory structural zinc-binding domain. The Journal of biological chemistry 2008, 283 (39), 26694-704.
Bressi, J. C.; Jennings, A. J.; Skene, R.; Wu, Y.; Melkus, R.; De Jong, R.; O'Connell, S.; Grimshaw, C. E.; Navre, M.; Gangloff, A. R., Exploration of the HDAC2 foot pocket: Synthesis and SAR of substituted N-(2-aminophenyl)benzam ides. Bioorg. Med. Chem. Lett. 2010, 20 (10), 3142-3145.
Cancio, R.; Mai, A.; Rotili, D.; Artico, M.; Sbardella, G.; Clotet-Codina, I.; Este, J. A.; Crespan, E.; Zanoli, S.; Hubscher, U.; Spadari, S.; Maga, G. Slow-, tight-binding HIV-1 reverse transcriptase non-nucleoside inhibitors highly active against drug-resistant mutants. ChemMedChem 2007, 2, 445-8.
Case, D. A.; Cheatham, T. E., 3rd; Darden, T.; Gohlke, H.; Luo, R.; Merz, K. M., Jr.; Onufriev, A.; Simmerling, C.; Wang, B.; Woods, R. J., The Amber biomolecular simulation programs. Journal of computational chemistry 2005, 26 (16), 1668-88.
Cheng, B., and Titterington, D. M. Neural Networks: A Review from a Statistical Perspective. Statistical Science, 1994, 9(1), 2-54.
Choudhary, C.; Kumar, C.; Gnad, F.; Nielsen, M. L.; Rehman, M.; Walther, T. C.; Olsen, J. V.; Mann, M., Lysine acetylation targets protein complexes and co-regulates major cellular functions. Science 2009, 325 (5942), 834-40.
Choudhary, S. K.; Margolis, D. M., Curing HIV: Pharmacologic Approaches to Target HIV-1 Latency. Annual Review of Pharmacology and Toxicology 2011, 51 (1), 397-418.
Cole, K. E.; Dowling, D. P.; Boone, M. A.; Phillips, A. J.; Christianson, D. W., Structural basis of the antiproliferative activity of largazole, a depsipeptide inhibitor of the histone deacetylases. J. Am. Chem. Soc. 2011, 133 (32), 12474-12477.
Cramer, R. D.; Patterson, D. E.; Bunce, J. D., Comparative molecular field analysis (CoMFA). 1. Effect of shape on binding of steroids to carrier proteins. J. Am. Chem. Soc. 1988, 110 (18), 5959-5967.
Dowling, D. P.; Gantt, S. L.; Gattis, S. G.; Fierke, C. A.; Christianson, D. W., Structural studies of human histone deacetylase 8 and its site-specific variants complexed with substrate and inhibitors. Biochemistry 2008, 47 (51), 13554-63.
Dyson, H. J., Wright, P. E. Insights Into Protein Folding From NMR. Ann Rev Phys Chem, 1996, 47:369-395.
Eswar, N.; John, B.; Mirkovic, N.; Fiser, A.; Ilyin, V. A.; Pieper, U.; Stuart, A. C.; Marti-Renom, M. A.; Madhusudhan, M. S.; Yerkovich, B.; Sali, A., Tools for comparative protein structure modeling and analysis. Nucleic Acids Res. 2003, 31 (13), 3375-3380.
Fass, D. M.; Shah, R.; Ghosh, B.; Hennig, K.; Norton, S.; Zhao, W. N.; Reis, S. A.; Klein, P. S.; Mazitschek, R.; Maglathlin, R. L.; Lewis, T. A.; Haggarty, S. J., Effect of Inhibiting Histone Deacetylase with Short-Chain Carboxylic Acids and Their Hydroxamic Acid Analogs on Vertebrate Development and Neuronal Chromatin. ACS Med. Chem. Lett. 2011, 2 (1), 39-42.
Fernandez-Fuentes, N.; Madrid-Aliste, C. J.; Rai, B. K.; Fajardo, J. E.; Fiser, A., M4T: a comparative protein structure modeling server. Nucleic Acids Res. 2007, 35 (Web Server issue), W363-368.
Finnin, M. S.; Donigian, J. R.; Cohen, A.; Richon, V. M.; Rifkind, R. A.; Marks, P. A.; Breslow, R.; Pavletich, N. P., Structures of a histone deacetylase homologue bound to the TSA and SAHA inhibitors. Nature 1999, 401 (6749), 188-93.
Fiser, A.; Sali, A., Modeller: generation and refinement of homology-based protein structure models. Methods Enzymol. 2003, 374, 461-491.
Frank, J., Single-particle Imaging of Macromolecules by Cryo-electron Microscopy. Ann Rev Biophys and Biomol Structure, 2002, 31:303-319.
Gil-Redondo, R.; Klett, J.; Gago, F.; Morreale, A., gCOMBINE: A graphical user interface to perform structure-based comparative binding energy (COMBINE) analysis on a set of ligand-receptor complexes. Proteins 2010, 78 (1), 162-72.
Goodford, P. J. A computational procedure for determining energetically favorable binding sites on biologically important macromolecules. J Med Chem 1985, 28, 849-57.
Haenlein, M. and Kaplan, A. M. A Beginner's Guide to Partial Least Squares Analysis. Understanding Statistics, 2004, 3(4), 283-297.
Hanessian, S.; Auzzas, L.; Larsson, A.; Zhang, J.; Giannini, G.; Gallo, G.; Ciacci, A.; Cabri, W., Vorinostat-Like Molecules as Structural, Stereochemical, and Pharmacological Tools. ACS Med. Chem. Lett. 2010, 1 (2), 70-74.
Henrich, S.; Feierberg, I.; Wang, T.; Blomberg, N.; Wade, R. C., Comparative binding energy analysis for binding affinity and target selectivity prediction. Proteins 2010, 78 (1), 135-153.
Hu, E.; Dul, E.; Sung, C. M.; Chen, Z.; Kirkpatrick, R.; Zhang, G. F.; Johanson, K.; Liu, R.; Lago, A.; Hofmann, G.; Macarron, R.; de los Frailes, M.; Perez, P.; Krawiec, J.; Winkler, J.; Jaye, M., Identification of novel isoform-selective inhibitors within class I histone deacetylases. J. Pharmacol. Exp. Ther. 2003, 307, 720-728.
Jones, P.; Bottomley, M. J.; Carfi, A.; Cecchetti, O.; Ferrigno, F.; Lo Surdo, P.; Ontoria, J. M.; Rowley, M.; Scarpelli, R.; Schultz-Fademrecht, C.; Steinkuhler, C., 2-Trifluoroacetylthiophenes, a novel series of potent and selective class II histone deacetylase inhibitors. Bioorg. Med. Chem. Lett. 2008, 18 (11), 3456-3461.
Kastenholz, M. A.; Pastor, M.; Cruciani, G.; Haaksma, E. E.; Fox, T., GRID/CPCA: a new computational tool to design selective ligands. J. Med. Chem. 2000, 43 (16), 3033-3044.
Khosravi, A., Nahavandi, S., Creighton, D., Atiya, A. F. A Comprehensive Review of Neural Network-based Prediction Intervals and New Advances. IEEE Transactions on Neural Networks, p. 1-17.
Kozikowski, A. P.; Chen, Y.; Gaysin, A. M.; Savoy, D. N.; Billadeau, D. D.; Kim, K. H., Chemistry, biology, and QSAR studies of substituted biaryl hydroxamates and mercaptoacetamides as HDAC inhibitors-nanomolar-potency inhibitors of pancreatic cancer cell growth. ChemMedChem 2008, 3 (3), 487-501.
Kozikowski, A. P.; Tapadar, S.; Luchini, D. N.; Kim, K. H.; Billadeau, D. D., Use of the nitrile oxide cycloaddition (NOC) reaction for molecular probe generation: a new class of enzyme selective histone deacetylase inhibitors (HDACIs) showing picomolar activity at HDAC6. J. Med. Chem. 2008, 51 (15), 4370-4373.
Krieger, E., Nabuurs, S. B., Vriend, G. Homology Modeling, Chapter 25, in: Structural Bioinformatics (eds. Bourne, P. E., Weissig, H.), 2003, Wiley Liss, Inc., pp. 507-521.
Lozano, J. J.; Pastor, M.; Cruciani, G.; Gaedt, K.; Centeno, N. B.; Gago, F.; Sanz, F., 3D-QSAR methods on the basis of ligand-receptor complexes. Application of COMBINE and GRID/GOLPE methodologies to a series of CYP1A2 ligands. J. Comput.-Aided Mol. Des. 2000, 14 (4), 341-353.
Lundstrom, K. An Overview on GPCRs and Drug Discovery: Structure-based Drug Design and Structural Biology on GPCRs. Methods Mol Biol., 2009, 552:51-66.
Macarthur, R. D. Clinical Trial Report: TMC278 (Rilpivirine) Versus Efavirenz as Initial Therapy in Treatment-Naive, HIV-1-Infected Patients. Curr Infect Dis Rep 2011, 13, 1-3.
Mai, A.; Massa, S.; Ragno, R.; Cerbara, I.; Jesacher, F.; Loidl, P.; Brosch, G., 3-(4-Aroyl-1-methyl-1H-2-pyrrolyl)-N-hydroxy-2-alkylamides as a new class of synthetic histone deacetylase inhibitors. 1. Design, synthesis, biological evaluation, and binding mode studies performed through three different docking procedures. J Med Chem 2003, 46 (4), 512-24.
Mai, A.; Massa, S.; Ragno, R.; Esposito, M.; Sbardella, G.; Nocca, G.; Scatena, R.; Jesacher, F.; Loidl, P.; Brosch, G., Binding mode analysis of 3-(4-benzoyl-1-methyl-1H-2-pyrrolyl)-N-hydroxy-2-propenamide: a new synthetic histone deacetylase inhibitor inducing histone hyperacetylation, growth inhibition, and terminal cell differentiation. J Med Chem 2002, 45 (9), 1778-84.
Mai, A.; Massa, S.; Rotili, D.; Cerbara, I.; Valente, S.; Pezzi, R.; Simeoni, S.; Ragno, R., Histone Deacetylation in Epigenetics: An Attractive Target for Anticancer Therapy. Med. Res. Rev. 2005, 25 (3), 261-309.
Mai, A.; Sbardella, G.; Artico, M.; Ragno, R.; Massa, S.; Novellino, E.; Greco, G.; Lavecchia, A.; Musiu, C.; La Colla, M.; Murgioni, C.; La Colla, P.; Loddo, R. Structure-based design, synthesis, and biological evaluation of conformationally restricted novel 2-alkylthio-6-[1-(2,6-difluorophenyl)alkyl]-3,4-dihydro-5-alkylpyrimidin-4(3H)-ones as non-nucleoside inhibitors of HIV-1 reverse transcriptase. J Med Chem 2001, 44, 2544-54.
Matalon, S.; Rasmussen, T. A.; Dinarello, C. A., Histone deacetylase inhibitors for purging HIV-1 from the latent reservoir. Mol Med 2011, 17 (5-6), 466-72.
Matthews, B. W., X-Ray Crystallographic Studies of Proteins. Ann. Rev. Phys. Chem. 1976, 27:493-523.
Meng, E. C.; Pettersen, E. F.; Couch, G. S.; Huang, C. C.; Ferrin, T. E. Tools for integrated sequence-structure analysis with UCSF Chimera. BMC Bioinformatics 2006, 7, 339.
Mevik, B.-H.; Wehrens, R., The pls Package: Principal Component and Partial Least Squares Regression in R. J. Statistical Software 2007, 18 (2), 1-24.
Milne, J. L., Borgnia, M. J., Bartesaghi, A., Tran, E. E., Earl, L. A., Schauder, D. M., Lengyel, J., Pierson, J., Patwardhan, A., Subramaniam, S. Cryo-electron microscopy—a primer for the non-microscopist. FEBS J., 2013, 280(1): 28-45.
Morris, G. M.; Huey, R.; Lindstrom, W.; Sanner, M. F.; Belew, R. K.; Goodsell, D. S.; Olson, A. J. AutoDock and AutoDockTools: Automated docking with selective receptor flexibility. Journal of Computational Chemistry 2009, 30, 2785-2791.
Musmuca, I.; Caroli, A.; Mai, A.; Kaushik-Basu, N.; Arora, P.; Ragno, R., Combining 3-D Quantitative Structure-Activity Relationship with Ligand Based and Structure Based Alignment Procedures for in Silico Screening of New Hepatitis C Virus NS5B Polymerase Inhibitors. J. Chem. Inf. Model. 2010, 50, 662-676.
Naul, B., A Review of Support Vector Machines in Computational Biology. pp. 1-17. Retrieved from the Internet <biochem218.stanford.edu/Projects %202009/Naul %202009.pdf>.
Nielsen, M.; Lundegaard, C.; Lund, O.; Petersen, T. N., CPHmodels-3.0—remote homology modeling using structure-guided sequence profiles. Nucleic Acids Res. 2010, 38 (Web Server issue), W576-581.
Nielsen, T. K.; Hildmann, C.; Dickmanns, A.; Schwienhorst, A.; Ficner, R., Crystal structure of a bacterial class 2 histone deacetylase homologue. J. Mol. Biol. 2005, 354 (1), 107-120.
Nielsen, T. K.; Hildmann, C.; Riester, D.; Wegener, D.; Schwienhorst, A.; Ficner, R., Complex structure of a bacterial class 2 histone deacetylase homologue with a trifluoromethylketone inhibitor. Acta crystallographica. Section F, Structural biology and crystallization communications 2007, 63 (Pt 4), 270-3.
Ortiz, A. R.; Pastor, M.; Palomer, A.; Cruciani, G.; Gago, F.; Wade, R. C., Reliability of comparative molecular field analysis models: effects of data scaling and variable selection using a set of human synovial fluid phospholipase A2 inhibitors. J. Med. Chem. 1997, 40 (7), 1136-1148.
Ortiz, A. R.; Pisabarro, M. T.; Gago, F.; Wade, R. C., Prediction of drug binding affinities by comparative binding energy analysis. J. Med. Chem. 1995, 38, 2681-2691.
Ortore, G.; Di Colo, F.; Martinelli, A., Docking of hydroxamic acids into HDAC1 and HDAC8: a rationalization of activity trends and selectivities. J. Chem. Inf. Model. 2009, 49 (12), 2774-85.
Otting, G., Protein NMR Using Paramagnetic Ions. Ann Rev Biophys, 2010, 39:387-405.
Perez, C.; Pastor, M.; Ortiz, A. R.; Gago, F., Comparative Binding Energy Analysis of HIV-1 Protease Inhibitors: Incorporation of Solvent Effects and Validation as a Powerful Tool in Receptor-Based Drug Design. J. Med. Chem. 1998, 41 (6), 836-852.
Pettersen, E. F.; Goddard, T. D.; Huang, C. C.; Couch, G. S.; Greenblatt, D. M.; Meng, E. C.; Ferrin, T. E. UCSF Chimera—a visualization system for exploratory research and analysis. J Comput Chem 2004, 25, 1605-12.
Quaglia, M.; Mai, A.; Sbardella, G.; Artico, M.; Ragno, R.; Massa, S.; del Piano, D.; Setzu, G.; Doratiotto, S.; Cotichini, V. Chiral resolution and molecular modeling investigation of rac-2-cyclopentylthio-6-[1-(2,6-difluorophenyl)ethyl]-3,4-dihydro-5-methyl pyrimidin-4(3H)-one (MC-1047), a potent anti-HIV-1 reverse transcriptase agent of the DABO class. Chirality 2001, 13, 75-80.
Ragno, R.; Mai, A.; Sbardella, G.; Artico, M.; Massa, S.; Musiu, C.; Mura, M.; Marturana, F.; Cadeddu, A.; La Colla, P. Computer-aided design, synthesis, and anti-HIV-1 activity in vitro of 2-alkylamino-6-[1-(2,6-difluorophenyl)alkyl]-3,4-dihydro-5-alkylpyrimidin-4(3H)-ones as novel potent non-nucleoside reverse transcriptase inhibitors, also active against the Y181C variant. J Med Chem 2004, 47, 928-34.
Ragno, R.; Simeoni, S.; Rotili, D.; Caroli, A.; Botta, G.; Brosch, G.; Massa, S.; Mai, A., Class II-selective histone deacetylase inhibitors. Part 2: alignment-independent GRIND 3-D QSAR, homology and docking studies. Eur J Med Chem 2008, 43 (3), 621-32.
Ragno, R.; Simeoni, S.; Valente, S.; Massa, S.; Mai, A., 3-D QSAR studies on histone deacetylase inhibitors. A GOLPE/GRID approach on different series of compounds. J Chem Inf Model 2006, 46 (3), 1420-30.
R-Development-Core-Team. R: a language and environment for statistical computing. http://www.r-project.org/.
Ren, J.; Esnouf, R.; Garman, E.; Somers, D.; Ross, C.; Kirby, I.; Keeling, J.; Darby, G.; Jones, Y.; Stuart, D.; et al. High resolution structures of HIV-1 RT from four RT-inhibitor complexes. Nat Struct Biol 1995, 2, 293-302.
Ren, J.; Milton, J.; Weaver, K. L.; Short, S. A.; Stuart, D. I.; Stammers, D. K. Structural basis for the resilience of efavirenz (DMP-266) to drug resistance mutations in HIV-1 reverse transcriptase. Structure 2000, 8, 1089-94.
Ren, J.; Nichols, C. E.; Chamberlain, P. P.; Weaver, K. L.; Short, S. A.; Stammers, D. K. Crystal structures of HIV-1 reverse transcriptases mutated at codons 100, 106 and 108 and mechanisms of resistance to non-nucleoside inhibitors. J Mol Biol 2004, 336, 569-78.
Rodriguez-Barrios, F.; Gago, F. Chemometrical identification of mutations in HIV-1 reverse transcriptase conferring resistance or enhanced sensitivity to arylsulfonylbenzonitriles. J Am Chem Soc 2004, 126, 2718-9.
Rotili, D.; Samuele, A.; Tarantino, D.; Ragno, R.; Musmuca, I.; Ballante, F.; Botta, G.; Morera, L.; Pierini, M.; Cirilli, R.; Nawrozkij, M. B.; Gonzalez, E.; Clotet, B.; Artico, M.; Este, J. A.; Maga, G.; Mai, A. 2-(Alkyl/aryl)amino-6-benzylpyrimidin-4(3H)-ones as inhibitors of wild-type and mutant HIV-1: enantioselectivity studies. Journal of Medicinal Chemistry 2012, 55, 3558-62.
Russo Krauss, I., Merlino, A., Vergara, A., Sica, F. An Overview of Biological Macromolecule Crystallization. Int J Mol Sci., 2013, 14(6), 11643-91.
Samuele, A.; Facchini, M.; Rotili, D.; Mai, A.; Artico, M.; Armand-Ugon, M.; Este, J. A.; Maga, G. Substrate-induced stable enzyme-inhibitor complex formation allows tight binding of novel 2-aminopyrimidin-4(3H)-ones to drug-resistant HIV-1 reverse transcriptase mutants. ChemMedChem 2008, 3, 1412-8.
Savarino, A.; Mai, A.; Norelli, S.; El Daker, S.; Valente, S.; Rotili, D.; Altucci, L.; Palamara, A. T.; Garaci, E., “Shock and kill” effects of class I-selective histone deacetylase inhibitors in combination with the glutathione synthesis inhibitor buthionine sulfoximine in cell line models for HIV-1 quiescence. Retrovirology 2009, 6, 52.
Schuetz, A.; Min, J.; Allali-Hassani, A.; Schapira, M.; Shuen, M.; Loppnau, P.; Mazitschek, R.; Kwiatkowski, N. P.; Lewis, T. A.; Maglathin, R. L.; McLean, T. H.; Bochkarev, A.; Plotnikov, A. N.; Vedadi, M.; Arrowsmith, C. H., Human HDAC7 harbors a class IIa histone deacetylase-specific zinc binding motif and cryptic deacetylase activity. The Journal of biological chemistry 2008, 283 (17), 11355-63.
Somoza, J. R.; Skene, R. J.; Katz, B. A.; Mol, C.; Ho, J. D.; Jennings, A. J.; Luong, C.; Arvai, A.; Buggy, J. J.; Chi, E.; Tang, J.; Sang, B. C.; Verner, E.; Wynands, R.; Leahy, E. M.; Dougan, D. R.; Snell, G.; Navre, M.; Knuth, M. W.; Swanson, R. V.; McRee, D. E.; Tari, L. W., Structural snapshots of human HDAC8 provide insights into the class I histone deacetylases. Structure 2004, 12 (7), 1325-34.
Stryer, L., Implications of X-Ray Crystallographic Studies of Protein Structure. Ann Rev Biochem., 1968, 37, 25-50.
Trott, O.; Olson, A. J., AutoDock Vina: improving the speed and accuracy of docking with a new scoring function, efficient optimization, and multithreading. J. Comput. Chem. 2010, 31 (2), 455-461.
Van Heel, M., Gowen, B., Matadeen, R., Orlova, E. V., Finn, R., Pape, T., Cohen, D., Stark, H., Schmidt, R., Schatz, M., Patwardhan, A. Single-particle electron cryo-microscopy: towards atomic resolution. Quarterly Reviews of Biophysics, 2000, 33(4):307-369.
Vannini, A.; Volpari, C.; Filocamo, G.; Casavola, E. C.; Brunetti, M.; Renzoni, D.; Chakravarty, P.; Paolini, C.; De Francesco, R.; Gallinari, P.; Steinkuhler, C.; Di Marco, S., Crystal structure of a eukaryotic zinc-dependent histone deacetylase, human HDAC8, complexed with a hydroxamic acid inhibitor. Proc Natl Acad Sci USA 2004, 101 (42), 15064-9.
Wesson, L.; Eisenberg, D. Atomic solvation parameters applied to molecular dynamics of proteins in solution. Protein Sci 1992, 1, 227-35.
Whitehead, L.; Dobler, M. R.; Radetich, B.; Zhu, Y.; Atadja, P. W.; Claiborne, T.; Grob, J. E.; McRiner, A.; Pancost, M. R.; Patnaik, A.; Shao, W.; Shultz, M.; Tichkule, R.; Tommasi, R. A.; Vash, B.; Wang, P.; Stams, T., Human HDAC isoform selectivity achieved via exploitation of the acetate release channel with structurally unique small molecule inhibitors. Bioorg. Med. Chem. 2011, 19 (15), 4626-4634.
Xu, J., Jiao, F., Yu, L., Protein Structure Prediction Using Threading. Methods Mol Biol., 2008, 413:91-121.
Zain, J.; Kaminetzky, D.; O'Connor, O. A., Emerging role of epigenetic therapies in cutaneous T-cell lymphomas. Expert. Rev. Hematol. 2010, 3 (2), 187-203.
Zhou, N.; Moradei, O.; Raeppel, S.; Leit, S.; Frechette, S.; Gaudette, F.; Paquin, I.; Bernstein, N.; Bouchain, G.; Vaisburg, A.; Jin, Z.; Gillespie, J.; Wang, J.; Fournel, M.; Yan, P. T.; Trachy-Bourget, M. C.; Kalita, A.; Lu, A.; Rahil, J.; MacLeod, A. R.; Li, Z.; Besterman, J. M.; Delorme, D., Discovery of N-(2-aminophenyl)-4-[(4-pyridin-3-ylpyrimidin-2-ylamino)methyl]benzamide (MGCD0103), an orally active histone deacetylase inhibitor. J. Med. Chem. 2008, 51 (14), 4072-4075.

All documents cited in this application are hereby incorporated by reference as if recited in full herein.

Although illustrative embodiments of the present invention have been described herein, it should be understood that the invention is not limited to those described, and that various other changes or modifications may be made by one skilled in the art without departing from the scope or spirit of the invention.

What is claimed is:

1. A computational method for selecting an effector having specificity for a target molecule, the method comprising:
a) compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set;
b) establishing structure-based equivalence of the sequence elements and labeling the sequence elements of different molecule library members to reflect said equivalence;
c) determining likely spatial orientations of the ligand population members in the ligand-molecule pairs for which the database comprises activity data;
d) calculating, for the ligand-molecule pairs for which the database comprises activity data, interaction energies of the ligand population member with proximal sequence elements of the molecule library member of the respective ligand-molecule pairs when the ligand population member is in a determined likely spatial orientation;
e) generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data;
f) selecting an effector that is likely, based upon the generated statistical model(s), to have specificity for the target molecule that exceeds the specificity of the effector for other molecule library member(s); g) experimentally determining activity data quantifying an effect of the selected effector upon the activity of one or more molecule library members; and, h) at least once, repeating steps (a) and (c) through (g) wherein in a later iteration of steps (a) and (c) through (g) the effector selected in step (f) of an earlier iteration of steps (c) through (g) is a member of the population of ligands.

2. The method of claim 1, wherein the effector is an inhibitor of the target molecule.

3. The method of claim 1, wherein the effector is an activator of the target molecule.

4.-42. (canceled)

43. A system for selecting an effector having specificity for a target molecule, comprising: means for compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set; means for establishing structure-based equivalence of the sequence elements and labeling the sequence elements of different molecule library members to reflect said equivalence; means for determining likely spatial orientations of the ligand population members in the ligand-molecule pairs for which the database comprises activity data; means for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; means for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data; means for selecting an effector that is likely, based upon the generated statistical model(s), to have specificity for the target molecule that exceeds the specificity of the effector for other molecule library member(s); means for experimentally determining activity data quantifying an effect of the selected effector upon the activity of one or more molecule library members; and, means for at least once, repeating steps (a) and (c) through (g) wherein in a later iteration of steps (a) and (c) through (g) the effector selected in step (f) of an earlier iteration of steps (c) through (g) is a member of the population of ligands.

44. The system of claim 43, wherein the effector is an inhibitor of the target molecule.

45. The system of claim 43, wherein the effector is an activator of the target molecule.

46.-84. (canceled)

85. A system for selecting an effector having specificity for a target molecule, comprising: a processor for compiling a database containing (i) three-dimensional structural data for members of a library of molecules each having a known chemical sequence comprising sequence elements, the library comprising the target molecule and other member molecules structurally related to the target molecule, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set, establishing structure-based equivalence of the sequence elements and labeling the sequence elements of different molecule library members to reflect said equivalence, and determining likely spatial orientations of the ligand population members in the ligand-molecule pairs for which the database comprises activity data; a calculator for calculating, for the ligand-molecule pairs for which the database comprises activity data, interaction energies of the ligand population member with proximal sequence elements of the molecule library member of the respective ligand-molecule pairs when the ligand population member is in a determined likely spatial orientation; and, a classifier for generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data.

86. The system of claim 85, wherein the effector is an inhibitor of the target molecule.

87. The system of claim 85, wherein the effector is an activator of the target molecule.

88.-126. (canceled)

127. A computational method for selecting an effector having specificity for a target molecule, the method comprising:
a. compiling a database containing (i) three-dimensional structural data for members of a library of molecules each having a known chemical sequence comprising sequence elements, the library comprising the target molecule and other member molecules, (ii) structural data for members of a population of ligands each having a known chemical structure, and (iii) activity data quantifying an effect of ligand population members upon the activity of molecule library members wherein the ligands of the ligand-molecule pairs are selected from the ligand population members, the molecules of the ligand-molecule pairs are selected from the molecule library members and different ligand-molecule pairs in the set comprise a different ligand, a different molecule, or both a different ligand and a different molecule relative to other ligand-molecule pairs in the set, and wherein the activity data differs for different ligand-molecule pairs in the set;
b. determining likely spatial orientations of the ligand population members in the ligand-molecule pairs for which the database comprises activity data;
c. establishing equivalence of the sequence elements based on determined likely spatial orientations of the ligand population members in the ligand-molecule pairs for which the data comprises activity data and labeling the sequence elements of different molecule library members to reflect said equivalence;
d. calculating, for the ligand-molecule pairs for which the database comprises activity data, interaction energies of the ligand population member with proximal sequence elements of the molecule library member of the respective ligand-molecule pairs when the ligand population member is in a determined likely spatial orientation;
e. generating at least one statistical model that is predictive of those sequence elements of the molecule library members that are likely to contribute to a differential effect of ligand population members on molecule library members using the calculated interaction energies and the activity data corresponding to the ligand-molecule pairs for which the database contains activity data;
f. selecting an effector that is likely, based upon the generated statistical model(s), to have specificity for the target molecule that exceeds the specificity of the effector for other molecule library member(s);
g. experimentally determining activity data quantifying an effect of the selected effector upon the activity of one or more molecule library members; and,
h. at least once, repeating steps (a) through (g) wherein in a later iteration of steps (a) through (g) the effector selected in step (f) of an earlier iteration of steps (a) through (g) is a member of the population of ligands.

128. The method of claim 127, wherein the effector is an inhibitor of the target molecule.

129. The method of claim 127, wherein the effector is an activator of the target molecule.

130.-252. (canceled)
